(19) United States
(12) Patent Application Publication
(10) Pub. No.: US 2026/0073340 A1
(43) Pub. Date: Mar. 12, 2026

(54) Systems and Methods for Managing Facility Modifications

(71) Applicant: BATTELLE ENERGY ALLIANCE, LLC, Idaho Falls, ID (US)

(72) Inventors: Vivek Agarwal, Idaho Falls, ID (US); Ryan M. Spangler, Idaho Falls, ID (US); Craig A. Primer, Fort Worth, TX (US)

(73) Assignee: BATTELLE ENERGY ALLIANCE, LLC, Idaho Falls, ID (US)

(21) Appl. No.: 19/325,305

(22) Filed: Sep. 10, 2025

Related U.S. Application Data
(60) Provisional application No. 63/693,601, filed on Sep. 11, 2024.

(51) Int. Cl. G06Q 10/067

(52) U.S. Cl. CPC G06Q 10/067

(57) ABSTRACT

The present disclosure describes aspects of systems and methods for managing modifications to processes of a facility such as a power plant or the like. An assessment module determines a baseline assessment of the facility, which may comprise determining technical, economic, and risk metrics for existing facility processes. Candidate processes are formulated to address identified improvement targets. Candidates may be selected for implementation based on technical, economic, risk, and/or adoption characteristics of the candidates relative to one another and/or corresponding facility baselines.

### CROSS REFERENCE TO RELATED APPLICATIONS

This application claims priority to U.S. Provisional Patent Application No. 63/693,601, entitled “Systems and Methods for Managing Facility Modifications,” filed Sep. 11, 2024, which is incorporated by reference herein.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### BACKGROUND

Unless otherwise indicated herein, the approaches described in this section are not prior art to the claims in this disclosure and are not admitted to be prior art by inclusion in this section.

Modernizing facilities such as nuclear power plants can ensure long-term economic sustainability while maintaining or improving safety and reliability. There may be many different opportunities to modernize operations at a particular facility, each of which may offer potential benefits such as streamlined data flow, information sharing, and decision-making processes, cost savings, improved resilience, and so on. Modernizing selected processes can reduce inefficiencies, ultimately achieving the goal of reduced operating costs, increased operational efficiency, and long-term cost-effectiveness and safety.

The intricate and interconnected nature of some facilities can make it difficult, and often impossible, to accurately predict the technical, economic, risk, and adoption implications of modifications. Challenges inherent in these facilities such as conflicting schedules, regulatory compliance issues, and safety concerns can complicate screening and evaluation. Objective evaluation becomes increasingly difficult when multiple personnel groups are involved, which can introduce subjective perspectives, varying priorities, and resistance to change. What is needed, therefore, is a systematic framework for managing process improvements based on objective, quantitative assessments of potential modifications that accurately model the technical, economic, risk, and/or adoption characteristics of such modifications.

### SUMMARY

This overview is provided to introduce a selection of concepts in a simplified form that are further described in greater detail below. This overview is not intended to identify key or essential inventive concepts of the claimed subject matter, nor is it intended for limiting the scope of the claimed subject matter. Some example embodiments, alternative embodiments, and selectively cumulative embodiments are set forth herein.

Disclosed herein are systems and methods for systematically and objectively managing modifications to a facility and/or one or more processes thereof in accordance with a technical, economic, risk, and adoption (TERA) assessment framework.

Disclosed herein are examples of a method for managing modifications to a facility, the method comprising developing a candidate pool comprising a plurality of candidate processes suitable for implementation at the facility, and determining quantitative assessment metrics for each candidate process of the candidate pool. Generating quantitative assessment metrics for a candidate processes may comprise constructing a map of the candidate process within a computer-readable memory, the map configured to represent a plurality of interconnected states comprising the candidate process, each state of the candidate process represented by a respective map node, transforming the map into a stochastic model of the candidate process, the stochastic model comprising probabilistic links configured to model a probability of transitions between respective states of the candidate process, and deriving the quantitative assessment metrics for the candidate process from the stochastic model of the candidate process. The disclosed method may further include selecting a candidate process for implementation at the facility based, at least in part, on the quantitative assessment metrics determined for the candidate processes.

Determining the quantitative assessment metrics for the candidate process may further comprise formulating an assessment schema for the candidate process, the assessment schema defining a plurality of state parameters and assigning values corresponding to the state parameters to respective states of the candidate process. The assessment schema may further comprise assessment logic configured to determine quantitative state metrics for respective states of the candidate process based, at least in part, on the state parameter values assigned to the respective states and the quantitative assessment metrics for the candidate process may be based, at least in part, on the quantitative state metrics determined for the respective states of the candidate process.

In some implementations, determining the quantitative assessment metrics for the candidate process may further include determining time estimates for respective states of the candidate process based, at least in part, on the stochastic model of the candidate process, and aggregating the quantitative state metrics determined for the respective states of the candidate process based, at least in part, on the time estimates determined for the respective states. Deriving the quantitative assessment metrics from the stochastic model of the candidate process may comprise performing one or more of a closed-form analysis of the stochastic model, a steady-state analysis of the stochastic model, and Monte Carlo analysis of the stochastic model.

The assessment logic determined for the candidate process may comprise technical assessment logic configured to derive technical state metrics for respective states of the candidate process from state parameter values assigned to the respective states of the candidate process, economic assessment logic configured to derive economic state metrics for respective states of the candidate process from state parameter values assigned to the respective states of the candidate process, and risk assessment logic configured to derive risk state metrics for respective states of the candidate process from state parameter values assigned to the respective states of the candidate process. Determining the quantitative assessment metrics for the candidate process may comprise aggregating the technical state metrics determined for respective states of the candidate process based, at least in part, on the time estimates determined for the respective states, aggregating the economic state metrics determined for the respective states of the candidate process based, at least in part, on the time estimates determined for the respective states, and/or aggregating the risk state metrics determined for the respective states of the candidate process based, at least in part, on the time estimates determined for the respective states.

Determining the quantitative assessment metrics may further comprise determining sensitivity metrics for the candidate process, the sensitivity metrics configured to quantify a sensitivity of the quantitative assessment metrics to changes to respective state parameters of the assessment schema determined for the candidate process. Alternatively, or in addition, determining the quantitative assessment metrics for the candidate process may further comprise determining adoption metrics configured to quantify risks associated with adoption of the candidate process at the facility.

In some implementations, the method for managing facility modifications disclosed herein may further include identifying an improvement target for the facility, wherein one or more candidate processes of the candidate pool are configured to address the identified facility improvement target. Identifying the improvement target may comprise determining quantitative assessment metrics for one or more baseline processes of the facility and identifying the improvement target for the facility based, at least in part, on the quantitative assessment metrics determined for the one or more baseline processes. Alternatively, or in addition, the improvement target for the facility may be based, at least in part, on a facility objective, e.g., guidelines, regulations, modernization pathway, and/or the like.

Examples of the disclosed method may further include generating an adoption scheme for implementation of the selected candidate process at the facility, reassessing the selected candidate process at a designated time during adoption of the selected candidate process at the facility, wherein reassessing the selected candidate process comprises determining quantitative assessment metrics for an alternative candidate process different to the selected candidate process, and transitioning to adoption of the alternative candidate process at the facility based, at least in part, on the quantitative assessment metrics determined for the alternative candidate process.

Disclosed herein are examples of an apparatus for managing modifications to a facility, the apparatus comprising a processor coupled to a memory and non-transitory data store and an assessment module configured for operation on the processor the assessment module configured to determine a baseline assessment of the facility, wherein determining the baseline assessment comprises determining quantitative assessment metrics for one or more baseline processes of the facility, identify a facility improvement target based, at least in part, on the baseline assessment of the facility, develop a candidate pool comprising a plurality of candidate processes configured to address the identified facility improvement target, and determine quantitative assessment metrics for each candidate process of the candidate pool. Generating quantitative assessment metrics for a candidate process may comprise formulating an assessment schema for the candidate process, the assessment schema defining a plurality of state parameters and assessment logic configured to derive quantitative assessment metrics from the defined state parameters, constructing a map of the candidate process, the map comprising a plurality of states, assigning values to state parameters of each of the plurality of states of the candidate process within the map, transforming the map into a stochastic model configured to model transitions between the states of the candidate process, and deriving the quantitative assessment metrics for the candidate process from the stochastic model of the candidate process. The apparatus may further comprise an evaluation module configured to select a candidate process for implementation at the facility based, at least in part, on the quantitative assessment metrics determined for the candidate processes.

Determining the quantitative assessment metrics for the candidate process may comprise performing one or more of a closed-form analysis of the stochastic model, a steady-state analysis of the stochastic model, and a Markov chain Monte Carlo analysis of the stochastic model.

The assessment logic determined by the assessment module may comprise technical assessment logic configured to derive technical state metrics for respective states of the candidate process from state parameter values assigned to the respective states of the candidate process, economic assessment logic configured to derive economic state metrics for respective states of the candidate process from state parameter values assigned to the respective states of the candidate process, and/or risk assessment logic configured to derive risk state metrics for respective states of the candidate process from state parameter values assigned to the respective states of the candidate process. Determining the quantitative assessment metrics for the candidate process may further comprise determining time estimates for respective states of the candidate process based, at least in part, on the stochastic model of the candidate process, aggregating the technical state metrics determined for respective states of the candidate process based, at least in part, on time estimates determined for the respective states, aggregating the economic state metrics determined for respective states of the candidate process based, at least in part, on time estimates determined for the respective states, and/or aggregating the risk state metrics determined for respective states of the candidate process based, at least in part, on time estimates determined for the respective states.

In some implementations, determining the quantitative assessment metrics for the candidate process further comprises one or more of determining adoption metrics configured to quantify risks associated with adoption of the candidate process at the facility, and determining sensitivity metrics for the candidate process, the sensitivity metrics configured to quantify a sensitivity of the quantitative assessment metrics to changes to respective parameters of the assessment schema determined for the candidate process.

The apparatus may further include an implementation module configured to generate an adoption scheme for the selected candidate process, the adoption scheme configured to manage implementation of the selected candidate process at the facility, reassess the selected candidate process at a designated time during adoption of the selected candidate process at the facility, wherein reassessing the selected candidate process comprises determining quantitative assessment metrics for an alternative candidate process different to the selected candidate process, and transition to adoption of the alternative candidate process at the facility based, at least in part, on the quantitative assessment metrics determined for the alternative candidate process.

Disclosed herein are examples of non-transitory computer-readable storage media storing instructions that, when executed by a processor, cause the processor to perform operations for managing modifications to a facility, the operations comprising determining a baseline assessment of the facility, wherein determining the baseline assessment comprises determining quantitative assessment metrics for one or more baseline processes of the facility, identifying a facility improvement target based, at least in part, on one or more of the baseline assessment of the facility, developing a candidate pool comprising a plurality of candidate processes configured to address the identified facility improvement target, ad determining quantitative assessment metrics for each candidate process of the candidate pool. Generating the quantitative assessment metrics for a candidate processes may comprise constructing an assessment schema for the candidate process, the assessment schema defining a plurality of state parameters and assessment logic configured to derive quantitative assessment metrics from the defined state parameters, generating a map of the candidate process, the map comprising a plurality of states, assigning values to state parameters of each of the plurality of states of the candidate process within the map, transforming the map into a stochastic model configured to model transitions between the states of the candidate process, and determining the quantitative assessment metrics for the candidate process by performing one or more of a closed-form analysis of the stochastic model, a steady-state analysis of the stochastic model, and a Markov chain Monte Carlo analysis of the stochastic model.

The operations may further comprise selecting a candidate process for implementation at the facility based, at least in part, on the quantitative assessment metrics determined for the candidate processes, and generating an adoption scheme for implementation of the selected candidate process at the facility.

The assessment logic may comprise technical assessment logic configured to derive technical state metrics for respective states of the candidate process from state parameter values assigned to the respective states of the candidate process, economic assessment logic configured to derive economic state metrics for respective states of the candidate process from state parameter values assigned to the respective states of the candidate process, and risk assessment logic configured to derive risk state metrics for respective states of the candidate process from state parameter values assigned to the respective states of the candidate process. Determining the quantitative assessment metrics for the candidate process may further include determining time estimates for respective states of the candidate process based, at least in part, on the stochastic model of the candidate process, aggregating the technical state metrics determined for respective states of the candidate process based, at least in part, on time estimates determined for the respective states, aggregating the economic state metrics determined for respective states of the candidate process based, at least in part, on time estimates determined for the respective states, aggregating the risk state metrics determined for respective states of the candidate process based, at least in part, on time estimates determined for the respective states, determining adoption metrics configured to quantify risks associated with adoption of the candidate process at the facility, and determining sensitivity metrics for the candidate process, the sensitivity metrics configured to quantify a sensitivity of the quantitative assessment metrics to changes to respective parameters of the assessment schema determined for the candidate process.

In some examples, the operations implemented by the instructions stored on the non-transitory storage medium may further include reassessing the selected candidate process at a designated time during adoption of the selected candidate process at the facility, wherein reassessing the selected candidate process comprises determining quantitative assessment metrics for an alternative candidate process different to the selected candidate process, and transitioning to adoption of the alternative candidate process at the facility based, at least in part, on the quantitative assessment metrics determined for the alternative candidate process.

### BRIEF DESCRIPTION OF THE DRAWINGS

Examples of systems, methods, devices, and computer-readable storage media comprising instructions configured to implement aspects of facility modernization are set forth in the accompanying figures and detailed description:

FIG. 1A is a schematic block diagram illustrating an example operating environment in which aspects of the systems and methods for facility modernization disclosed herein may be practiced.

FIG. 1B illustrates an example of an assessment of a candidate process.

FIG. 2A is a schematic block diagram illustrating an example of a system for managing facility modifications.

FIG. 2B is a schematic block diagram illustrating an example of an assessment schema.

FIG. 2C is a schematic block diagram illustrating another example of an assessment schema.

FIG. 2D is a schematic block diagram illustrating an example of a baseline record comprising an assessment of a baseline process.

FIG. 2E is a schematic block diagram illustrating an example of a candidate record comprising an assessment of a candidate process.

FIG. 3A is a flow diagram illustrating an example of a method for managing facility modifications.

FIG. 3B is a flow diagram illustrating another example of a method for managing facility modifications.

FIG. 4 is a schematic block diagram illustrating an example of an apparatus configured to generate assessments of baseline processes.

FIGS. 5A and 5B illustrate further examples of process maps.

FIG. 6 illustrates an example of process assessment logic.

FIG. 7 is a schematic block diagram illustrating an example of a stochastic modeling module.

FIG. 8 is a flow diagram illustrating an example of a method for managing facility modifications.

FIG. 9 is a schematic block diagram illustrating another example of a candidate record comprising information pertaining to a candidate facility modification.

FIG. 10 is a schematic block diagram illustrating an example of process map comprising a node configured to represent a candidate facility modification.

FIG. 11 is a schematic block diagram illustrating an example of an apparatus configured to generate a technical, economic, risk, and/or adoption assessments of candidate processes.

FIG. 12 is a schematic block diagram illustrating an example of an implementation assessment module.

FIG. 13 is a schematic block diagram illustrating another example of an implementation assessment module.

FIG. 14 is a schematic block diagram illustrating an example of an assessment module configured to generate delta metrics for a candidate process.

FIG. 15 is a schematic block diagram illustrating another example of a system for managing facility modifications.

FIG. 16 is a schematic block diagram illustrating an example of an adoption scheme for a candidate process.

FIG. 17 is a flow diagram illustrating another example of a method for managing facility modifications.

FIG. 18A is a schematic block diagram illustrating an example of a process map.

FIG. 18B is a schematic block diagram illustrating an example of a process map comprising one or more improvement targets.

FIGS. 19A-19C are schematic block diagrams illustrating examples of candidate processes comprising respective candidate facility modifications.

### DETAILED DESCRIPTION

Disclosed herein are systems and methods for systematically and objectively managing modifications to a facility. Modifications may be managed in accordance with a technical, economic, and risk assessment (TERA) framework. As disclosed in further detail herein, the TERA framework is a comprehensive, holistic framework designed to objectively assess the technical, economic, risk, and/or adoption implications of facility modifications. The disclosed TERA framework may provide a systematic and objective approach for evaluating candidate facility modifications considering risks, investment costs and potential mitigation strategies. In other words, the TERA framework may comprise an objective, quantitative decision-supporting framework for the identification, evaluation, and implementation of facility modernization strategies that maximize economic benefits and other benefits while complying with facility constraints and minimizing associated costs, risks and uncertainties. The objective, holistic approach of the TERA framework may enable the identification of high-priority facility modifications that yield technical and economic benefits without compromising safety.

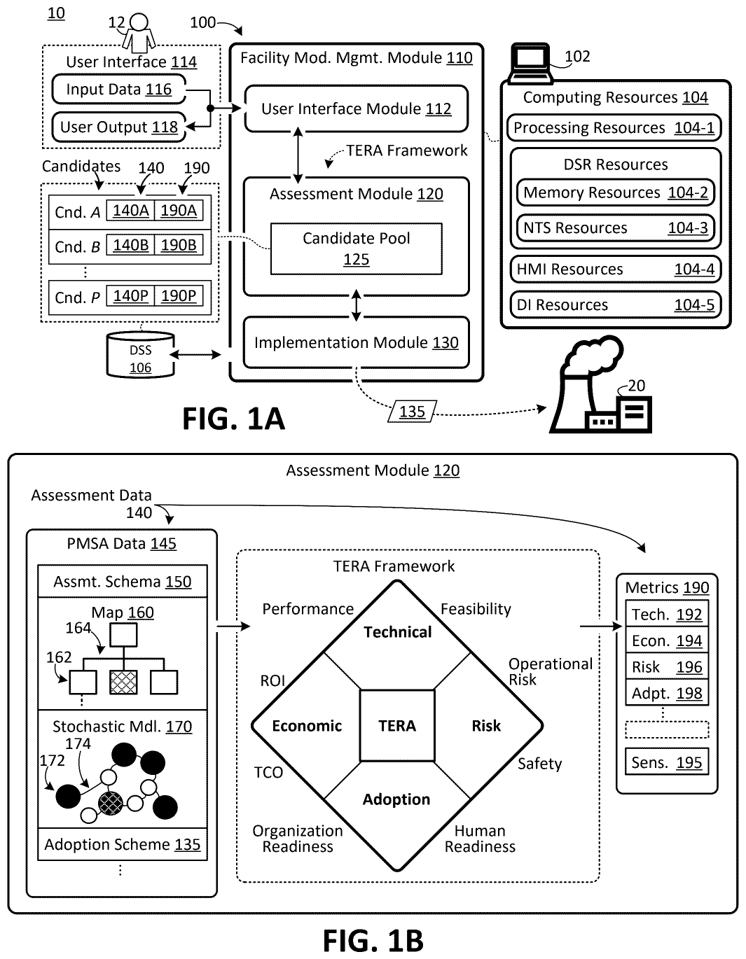

FIG. 1A illustrates an example of an operating environment 10 in which aspects of the systems and methods for managing facility modifications disclosed herein may be practiced. The operating environment 10 may comprise a system 100 for managing facility modifications pertaining to a facility 20. The facility 20 may comprise any suitable organizational unit, including, but not limited to: an industrial system, a control system, an industrial control system, a cyber-physical system, a cyber-physical control system, a factory, a plant, a utility, an electrical power utility, a power distribution system, an electrical grid, a power grid, a power generator, a power plant, a nuclear power plant, or the like. In the FIG. 1A example, the facility 20 may comprise a nuclear power plant (NPP).

The system 100 may comprise a facility modification management (FMM) module 110, which may be configured to manage facility modifications in accordance with the TERA framework, as disclosed in further detail herein. In other words, the FMM module 110 may implement and/or embody aspects of the TERA framework.

In some implementations, aspects of the FMM module 110 may be implemented and/or embodied by an apparatus 102. For example, aspects of the FMM module 110 may be implemented and/or embodied by computing resources 104 of the apparatus 102. The apparatus 102 may comprise one or more components or devices, which may include, but are not limited to: an electronic device, a computing device, a general-purpose computing device, an application-specific computing device, a mobile computing device, a smart phone, a tablet, a laptop, a server device, a distributed computing system, a cloud-based computing system, an embedded computing system, and/or the like. The computing resources 104 may comprise any suitable computing means including, but not limited to, processing resources 104-1, data storage and/or retrieval (DSR) resources (e.g., memory resources 104-2, non-transitory storage (NTS) resources 104-3, and/or the like), human-machine interface (HMI) resources 104-4, data interface (DI) resources 104-5, and/or the like.

The processing resources 104-1 may comprise any suitable processing means including, but not limited to: processing circuitry, logic circuitry, an integrated circuit (IC), a processor, a processing unit, a physical processor, a virtual processor (e.g., a virtual machine), an arithmetic-logic unit (ALU), a central processing unit (CPU), a general-purpose processor, a programmable logic device (PLD), a field programmable gate array (FPGA), an application-specific integrated circuit (ASIC), a System on Chip (SoC), virtual processing resources, and/or the like.

The DSR resources may comprise any suitable means for storing, retrieving, maintaining, and/or otherwise managing data which may include, but are not limited to: memory resources 104-2, NTS resources 104-3, and/or the like. The memory resources 104-2 may comprise any suitable memory means including, but not limited to: volatile memory, non-volatile memory, random access memory (RAM), dynamic RAM (DRAM), synchronous DRAM (SDRAM), cache memory, or the like. The NTS resources 104-3 may comprise any suitable non-transitory, persistent, and/or non-volatile storage means including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like.

The HMI resources 104-4 may comprise any suitable means for human-machine interaction including, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like.

The DI resources 104-5 may comprise any suitable data communication and/or interface means including, but not limited to: a communication interface, an I/O interface, a device interface, a network interface, an interconnect, and/or the like. In some implementations, the data interface 104-5 may be configured to communicatively couple the apparatus 101 to a network, which may include, but is not limited to: an electronic communication network, a computer network, a wired network, a wireless network, a local area network (LAN), a wide area network (WAN), a virtual private network (VPN), Internet Protocol (IP) networks, Transmission Control Protocol/Internet Protocol (TCP/IP) networks, the Internet, or the like.

In some implementations, the apparatus 101 may further comprise and/or be coupled to a data storage system (DSS) 106. The DSS 106 may comprise and/or be embodied by DSR resources of the computing device 102, e.g., memory resources 104-2, NTS resources 104-3, and/or the like. Alternatively, or in addition, aspects of the DSS 106 may be implemented and/or embodied by one or more external devices or systems, e.g., may comprise and/or be embodied by a remote data storage system, external data storage system, network-attached storage, network-accessible storage system, or the like. In some implementations, the FMM module 110 may comprise and/or be coupled to an artificial intelligence and/or machine-learning (AI/ML) platform, an AI/ML processing environment, an AI/ML processing toolkit, an AI/ML processing library, and/or the like, e.g., the computing resources 104 of the apparatus 102 may comprise AI/ML resources (not shown in FIG. 1A to avoid obscuring details of the illustrated example).

As illustrated in FIG. 1A, aspects of the FMM module 110 may be implemented and/or embodied by computing resources 104 of the apparatus 102. In some implementations, aspects of the FMM module 110 may be implemented and/or realized by software components, such as computer-executable instructions stored on non-transitory storage media. For example, aspects of the FMM module 110 may be configured for operation on processing resources 104-1 of the apparatus 101, utilize data storage and/or retrieval resources of the apparatus 101 (e.g., memory resources 104-2, NTS resources 104-3, and/or the like), may be embodied by computer-readable instructions stored within NTS resources 104-3 of the apparatus 101, interface with user(s) 12 through HMI resources 104-4, interface with other systems, such as the DSS 106, using the DI resources 104-5, and so on. Alternatively, or in addition, in some implementations, aspects of the FMM module 110 may be implemented and/or realized by hardware components, such as application-specific processing hardware, an ASIC, FPGA, an AI/ML processor, dedicated memory resources, and/or the like.

The FMM module 110 may comprise one or more components or modules including, inter alia, a user interface module 112, and an assessment module 120. The user interface (UI) module 112 may be configured to facilitate user interaction with the FMM module 110, e.g., facilitate interaction between the apparatus 102 and a user 12. The UI module 112 may comprise and/or implement a user interface (UI) 114 configured to receive data from a user 12 (e.g., receive user input data 116), provide data to the user 12 (e.g., display and/or otherwise present user output data 118 to the user 12), and so on. The UI 114 may be implemented, embodied and/or realized by computing resources 104 of the apparatus 101, such as HMI resources 104-4 or the like. For example, the UI 114 may be configured to present information to the user 12 on a monitor and/or other display device, receive data from the user 12 through one or more input devices (e.g., keyboard, mouse, touchscreen, or the like), and so on.

The FMM module 110 may be configured to manage modifications to the facility 20 in accordance with the TERA framework, which may comprise, inter alia: a) developing a candidate pool 125 for the facility, the candidate pool 125 comprising candidate processes suitable for implementation at the facility 20, b) determining quantitative assessment metrics 190 for the candidate processes, the quantitative assessment metrics 190 comprising an objective assessment of the technical, economic, risk, and/or adoption characteristics of respective candidate processes, and c) selecting one or more candidate process(es) for implementation at the facility 20 based, at least in part, on the quantitative assessment metrics 190.

As used herein, a “candidate process” may comprise and/or refer to any process suitable for implementation at a facility 20. A candidate process may be configured to modify aspects of the facility 20. For example, a candidate process may be configured to supplement and/or extend the functionality of existing facility processes. Alternatively, or in addition, a candidate process may be configured to alter, improve, modernize, update, secure, harden, replace, obviate and/or otherwise modify a baseline process of the facility 20. As used herein, a baseline (BL) process of the facility 20 may comprise and/or refer to a process associated with the facility 20, such as a process that is currently implemented at the facility 20, a process that was previously implemented at the facility 20, and/or the like. Candidate processes may involve one or more facility modifications. As used herein, a facility modification (FMD) or a candidate FMD may comprise and/or refer to any modification(s) configured to, inter alia, alter, improve, modernize, update, secure, harden, replace, obviate and/or otherwise modify the facility 20, a BL process of the facility 20, and/or one or more aspects of a BL process of the facility 20. Candidate FMD may comprise technical solutions suitable for implementation at the facility 20, which may include, but are not limited to: technical components, software components, computing systems, hardware components, machinery, equipment, and/or the like.

A candidate process may comprise candidate FMD configured to modify one or more steps, decisions, branches, phases, tasks, operations, subprocesses, and/or other aspect(s) of a “parent” BL process. As used herein, the “parent” of a candidate process (and/or candidate FMD) may comprise and/or refer to a BL process to be altered, improved, updated, replaced, obviated, and/or otherwise modified thereby.

The FMM module 110 may be configured to determine objective, quantitative assessments of candidate processes. In the FIG. 1A example, the FMM module 110 may determine assessment data 140 for each of P candidate processes within a candidate pool 125, e.g., determine assessment data 140A-P for candidate process A through P. The assessment data 140 may comprise quantitative assessment metrics 190 determined for each candidate process. The quantitative assessment metrics 190 determined for the candidate processes may comprise, inter alia, an objective, quantitative assessment of the technical, economic, and/or risk implications associated with adoption of respective candidate processes at the facility 20. In other words, the assessment metrics 190 may comprise a technical, economic, risk, and/or adoption (TERA) assessment of the candidate processes. The assessment metrics 190 may integrate technical, economic, risk, and adoption perspectives, thereby enabling an objective, comprehensive evaluation of the candidate pool. 125.

As illustrated in FIG. 1B, the quantitative assessment metrics 190 of a process may be generated and/or derived from, inter alia, process modeling and assessment data 145 associated with the process. As used herein, process modeling and assessment (PMA) data 145 may comprise and/or refer to any information used to determine an objective, quantitative assessment of a process, e.g., may comprise and/or refer to data used to generate and/or derive quantitative assessment metrics 190 for the process. PMA data 145 may comprise information pertaining to the technical, economic, risk, and/or adoption characteristics of a process and/or respective process states.

Referring back to FIG. 1A, in some implementations, the FMM module 110 may be configured to maintain information pertaining to the TERA framework in non-transitory storage, such as the DSS 106, NTS resources 104-3 of the apparatus 102, and/or the like. For example, aspects of the candidate pool 125 (e.g., candidate processes A through P) may comprise and/or be embodied by non-transitory data maintained within the DSS 106. As used herein, non-transitory data (NTD) may comprise and/or refer to any machine and/or computer-readable information retrievable from non-transitory storage; NTD may comprise and/or refer to data maintained in any suitable data storage system in any suitable format, including, but not limited to: a data structure, a record, a database record, an entry, a table, a row, a column, an array, an object, a data object, human-readable data, text, binary data, structured data, unstructured data, and/or the like. For example, information pertaining to the candidate pool 125, such as the assessment data 140 and corresponding quantitative metrics 190 determined for respective candidate processes A through P, may be maintained as NTD records within the DSS 106.

The assessment module 120 may be further configured to select candidate processes for implementation at the facility 20 based, at least in part, on the quantitative assessment metrics 190 determined for the candidate processes. As disclosed in further detail herein, the assessment module 120 may be configured to identify processes that satisfy specified criteria (e.g., constraints, objectives, and so on) while improving technical, economic, and/or risk characteristics of the facility 20. For example, the assessment module 120 may be configured to select a candidate process for implementation that offer maximum economic benefits while minimizing associated risks and uncertainties, e.g., as compared to other candidate processes within the candidate pool 125, corresponding BL processes of the facility 20, and/or the like.

In some embodiments, the FMM module 110 may further comprise and/or be coupled to an implementation module 130. As disclosed in further detail herein, the implementation module 130 may be configured to manage the adoption of candidate processes (and/or candidate FMD) within the facility 20. The implementation module 130 may be configured to generate adoption schemes 135 for selected candidate processes. As disclosed in further detail herein, the adoption scheme 135 determined for a candidate process may comprise information pertaining to the adoption of the candidate process at the facility 20, e.g., may comprise information pertaining to the design, development, deployment, implementation, and/or operation of the candidate process and/or FMD of the candidate process within the facility 20.

In some implementations, the FMM module 110 may be configured to populate the candidate pool 125 with candidate processes configured to address “modification targets” of the facility 20. As used herein, a “target,” “improvement target,” or “facility improvement target” (FMT) may comprise and/or refer any suitable aspect of the facility 20 and/or process thereof, including, but not limited to, a process step, decision, operation, subprocess, decision, data utilization, personnel utilization, and/or the like. For example, an FMT may be configured to expand the technical capabilities of the facility, improve economic efficiency, modernize one or more facility process(es), improve safety, mitigate security risks, increase resilience, and/or the like. In some implementations, the FMM module 110 may identify FMT corresponding to “pain points” identified within facility 20. As used herein, a “pain point” may comprise and/or refer to any deficiency of the facility 20 including, but not limited to: a technical deficiency (e.g., performance bottleneck, technical capability shortfall, or the like), economic inefficiency (e.g., source of high economic costs), safety risk (e.g., personnel risk, equipment risk, environmental risk, or the like), security risk (e.g., security vulnerability, attack vector, or the like), and/or the like.

In some implementations, the FMM module 110 may be configured to identify FMT and/or facility pain points based on, inter alia, a baseline of the facility 20. As used herein, a “baseline” (BL) of a facility 20 may comprise and/or refer to a technical, economic, and/or risk assessment of the facility 20. The BL of the facility 20 may be based on and/or derived from assessments determined for BL processes of the facility 20. As disclosed herein, a BL process of a facility 20 may comprise and/or refer to a process associated with the facility 20, e.g., a process that is currently, or was previously, implemented at the facility 20. The FMM module 110 may be configured to determine a BL of the facility, analyze the BL to identify facility pain points, and develop a candidate pool 125 comprising candidate processes configured to address the identified pain points.

Alternatively, or in addition, the FMM module 110 may determine FMT for the facility 20 (and develop corresponding candidate processes) in accordance with facility objectives. As used herein, facility objectives may comprise and/or refer to any suitable information pertaining to improvement objectives for a facility 20; facility objectives may include, but are not limited to: objectives, goals, guidelines, specifications, regulations, regulatory schemes, statutes, rulings, roadmaps, conventions, directives, modernization pathways, restructuring plans, sustainability programs, and/or the like. For example, the FMM module 110 may determine FMT (and corresponding candidate processes) for a NPP in accordance with, inter alia, the Plant Modernization Pathway (PMP) for Light Water Reactor Sustainability (LWRS) program, Integrated Operation for Nuclear (ION), Plant Optimization Pathway (POP), and/or the like.

The FMM module 110 may be further configured to design candidate processes corresponding to the FMT determined for the facility 20. For example, the FMM module 110 may be configured to develop candidate processes that are configured to address facility pain points, satisfy facility objectives, and/or the like. As used herein, a “candidate process” of a facility 20 may comprise and/or refer to a process suitable for implementation at the facility 20. A candidate process may be configured to expand the technical functionality of the facility 20, improve the economic sustainability of the facility 20, heighten security at the facility 20, and/or the like.

The assessment module 120 may be configured to perform TERA assessment operations pertaining to facility processes. As used herein, a TERA assessment operation may comprise and/or refer to an operation to determine objective, quantitative assessment metrics 190 for the process. The assessment metrics 190 of a process may quantify the impact of the process on the technical, economic, safety, and resilience characteristics of the facility 20. The assessment metrics 190 of candidate processes may be further configured to quantify risks associated with adoption of the candidate processes at the facility 20, as disclosed in further detail herein.

FIG. 1B illustrates an example of a TERA assessment of a facility process. As illustrated in FIG. 1B, assessing a process according to the TERA framework may comprise configuring the assessment module 120 to, inter alia: a) construct PMA data 145 for the process and b) generate assessment metrics 190 for the candidate process based on, inter alia, the PMA data 145, the metrics 190 comprising an objective, quantitative TERA assessment of the process based, at least in part, on the PMA data 145.

FIG. 1B further illustrates an example of PMA data 145. As disclosed herein, the PMA data 145 of a candidate process may comprise any suitable information from which metrics 190 pertaining to the technical, economic, risk, and/or adoption characteristics of the candidate process may be derived. In the FIG. 1B example, the PMA data 145 determined for the candidate process comprises an assessment schema 150, a map 160 of the process (or process map 160), and a stochastic model 170 of the process. In some implementations, the PMA data 145 may further comprise information pertaining adoption of the candidate process at the facility 20, e.g., may comprise and/or reference an adoption scheme 135 determined by the implementation module 130, as disclosed in further detail herein.

The assessment schema 150 of a process may define criteria for objectively quantifying process performance. The assessment schema 150 may define a parameter set 250 from which TERA characteristics of the process may be measured, quantified, evaluated, and/or otherwise assessed. In other words, the assessment schema 150 may define parameters describing the technical, economic, risk, and/or adoption characteristics of the process and/or respective process states. The assessment schema 150 may define parameters pertaining to any suitable aspect of process performance including, but not limited to: technical characteristics of the process (e.g., process performance, feasibility, and so on), economic characteristics (e.g., process cost, return on investment, total cost of ownership, breakeven point, and so on), risk characteristics (e.g., safety risk, operational risk, and so on), adoption characteristics of the process at the facility 20 (e.g., organization readiness, human readiness, and so on), and/or the like.

The map 160 of a process may comprise a collection of interconnected map nodes 162 representing respective states of the process. As used herein, a “state” of a process (or “process state”) may comprise and/or refer to any suitable aspect of a process including, but not limited to: a phase, step, task, decision, branch, resource utilization, data utilization, information utilization, and/or the like. The nodes 162 may be further configured to model the TERA characteristics of respective process states. As disclosed in further detail herein, nodes 162 may be assigned parameter values corresponding to the assessment schema 150. Relationships between process states may be represented by edges or links 164 within the map 160. The links 164 may represent state transitions or the like, e.g., outbound links 164 of respective map nodes 162 may represent possible next state(s) from the states represented by the respective map nodes 162. In some implementations, the map 160 may comprise and/or be embodied by NTD maintained within non-transitory storage, e.g., may be maintained as a graph or other suitable data structure within the DSS 106, NTS resources 104-3, and/or the like.

The stochastic model 170 of a process may be configured to represent the process as a sequence of possible events (process states), wherein the probability of each process state depends on the state attained in the previous event. The stochastic model 170 may comprise stochastic model (SM) nodes 172 representing respective process states. Relationships between SM nodes 172 may be represented by stochastic model (SM) links 174. The SM links 174 may be configured to model the probability of respective state transitions, e.g., may describe the probability of transitioning to respective states of the process from given process states. In other words, the stochastic model 170 may comprise a probability distribution describing the total spent in respective process state, e.g., model the time spent in respective states (tₙ) of a process comprising N states such that T=Σ₁^{N}tₙ, where T represents the total time spent in the process.

The assessment module 120 be configured to derive quantitative assessment metrics 190 from PMA data 140 determined for candidate processes. The assessment metrics 190 may be configured to objectively quantify any suitable aspect of a process. As illustrated in the FIG. 1B example, the assessment metrics 190 may comprise technical metrics 162, economic metrics 164, and risk metrics 166; the technical metrics 192 may comprise quantitative assessments of technical characteristics of the process such as efficiency, accuracy, time, labor reductions, and so on; the economic metrics 194 may comprise quantitative assessments of economic characteristics of the process such as cost metrics, cost savings metrics, and/or other financial metrics (e.g., yearly cost savings, breakeven point, net present value, return on investment, and internal rate of return, and so on); the risk metrics 196 may comprise quantitative assessments of operational, financial, regulatory, safety, security, and/or strategic risks associated with the process, which may be quantified based on changes in frequency, severity, or other relevant measures; and so on. The assessment metrics 190 determined for a candidate processes may further comprise adoption metrics 198, which may be configured to quantify risks associated with implementation of the candidate processes at the facility 20.

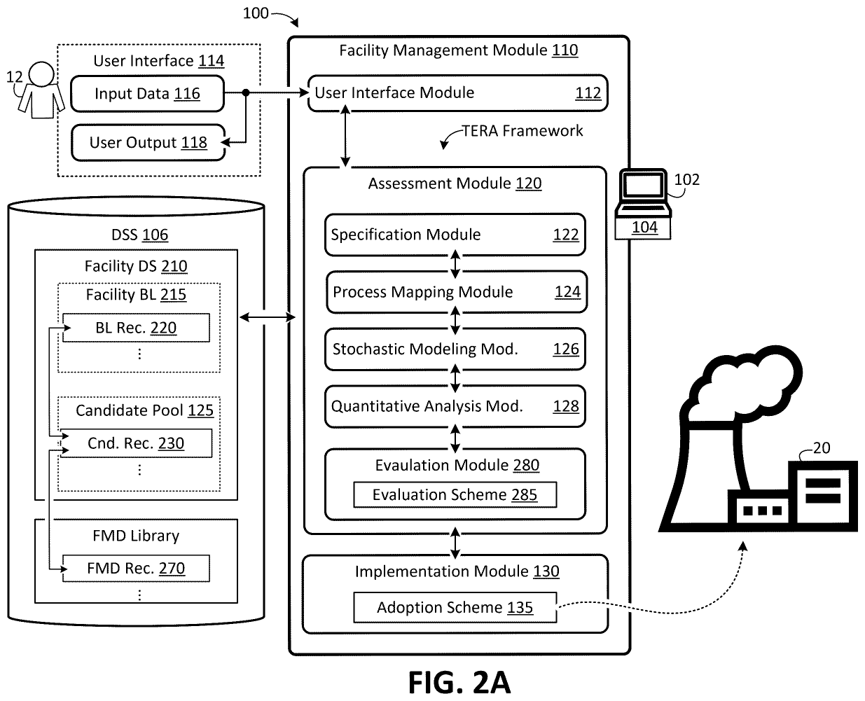

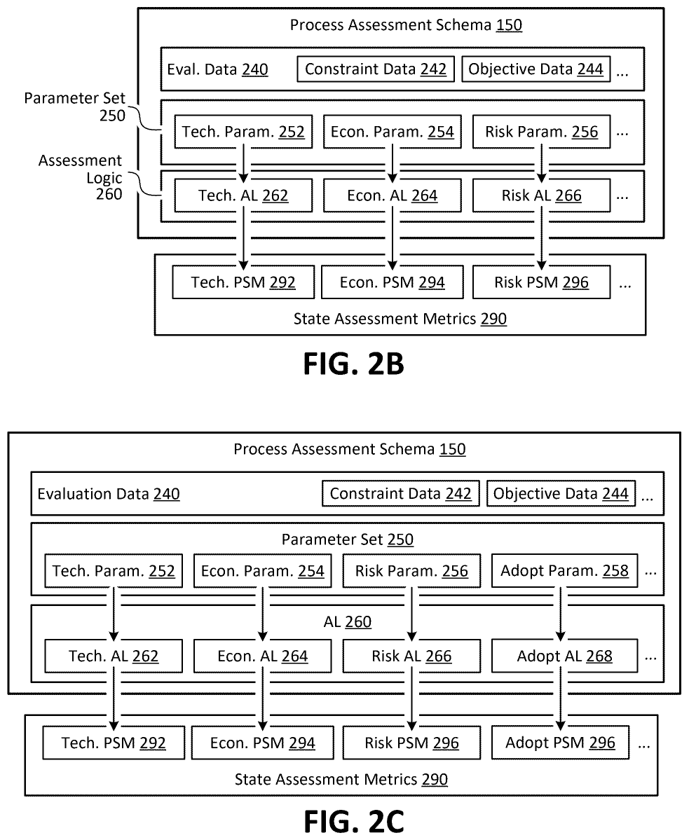

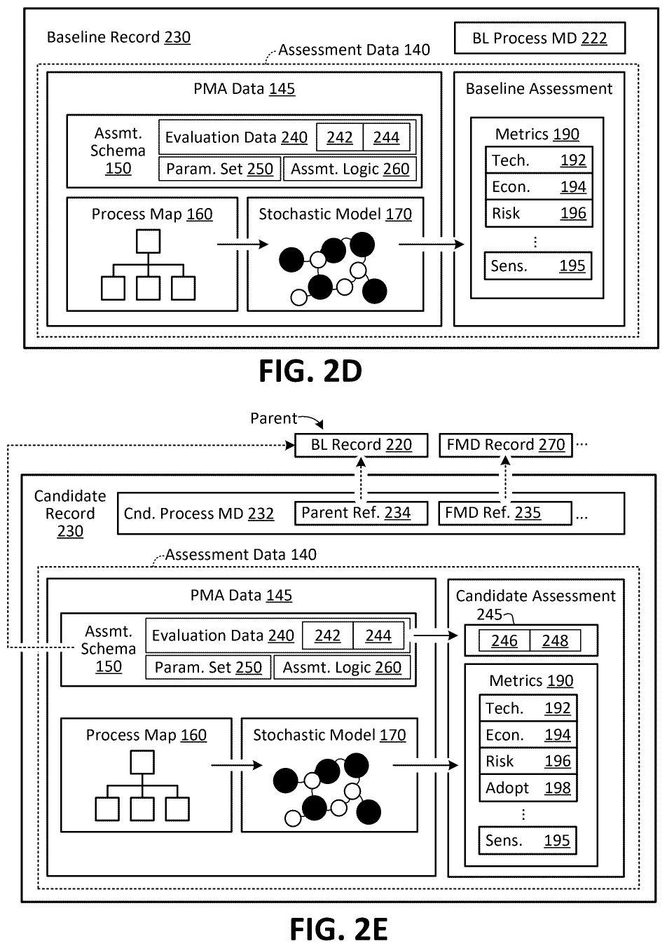

FIG. 2A is a schematic block diagram illustrating an example of a system 100 for managing facility modifications. The system 100 may comprise an FMM module 110 configured for operation on computing resources 104 of an apparatus 102. The FMM module 110 may comprise an assessment module 120, which may be configured to, inter alia, assess facility processes in accordance with the TERA framework. The system 100 may further comprise a facility datastore (DS) 210, which may be configured to maintain information pertaining to the facility 20 and/or candidate facility modifications. The facility DS 210 may comprise a facility baseline (BL) 215, which may comprise information pertaining to the technical, economic, and/or risk characteristics of the facility 20. The facility BL 215 may comprise and/or be based on assessments of BL processes of the facility 20Information pertaining to BL processes of the facility may be maintained in BL records 220 within the facility DS 210.

The assessment module 120 may assess processes by use of one or more modules and/or components, which may include, but are not limited to: a specification module 122, a process modeling (PM) module 124, a stochastic modeling (SM) module 126, and a quantitative analysis (QA) module 128. Assessing a facility process may comprise, a) constructing and/or retrieving an assessment schema 150 for the process by use of the specification module 122, b) constructing a map 160 of the process by use of the PM module 124, c) transforming the map 160 into a stochastic model 170 by use of the SM module 126, and d) deriving quantitative assessment metrics 190 for the process based, at least in part, on the stochastic model 170 of the process.

The specification module 122 may be configured to construct assessment schema 150 for facility processes. FIG. 2B is a schematic block diagram illustrating an example of an assessment schema 150. As disclosed herein, the assessment schema 150 may define means for quantifying process performance. For example, the assessment schema 150 may define a parameter set 250 comprising parameters configured to describe technical, economic, and/or risk characteristics of respective process states. As illustrated in FIG. 2B, the parameter set 250 may comprise technical parameter 252, economic parameters 254, risk parameters, and so on.

The assessment schema 150 may further comprise assessment logic 260, which may comprise means for deriving quantitative state metrics 290 for respective states of the process from, inter alia, the parameter set 260 of the process. The assessment logic 260 may be configured to derive quantitative state metrics 290 pertaining to any suitable aspect of a process state including, but not limited to technical, economic, risk, and/or adoption characteristics of the process state. For example, the assessment logic 260 may comprise technical assessment logic 262 configured to derive technical process state metrics (PSM) 292, economic assessment logic 264 configured to derive economic PSM 294, risk assessment logic 266 configured to derive risk PSM 296, and so on. The quantitative state metrics 290 may comprise an objective, quantitative assessment of respective states of the process. The assessment module 120 may be configured to derive metrics 190 for a process by, inter alia, aggregating the state assessment metrics 290 determined for respective states of the process.

As further illustrated in FIG. 2B, the assessment schema 150 may further comprise evaluation data 240. As used herein, evaluation data 240 may comprise any suitable information pertaining to the evaluation of a process. As illustrated in FIG. 2B, the evaluation data 240 may include, but is not limited to constraint data 242 and objective data 244. As disclosed in further detail herein, constraint data 242 may define, inter alia, constraints and/or requirements pertaining to the process and objective data 244 may comprise information pertaining to objectives of the facility 20 and/or process (e.g., information pertaining to potential improvement targets related to the facility 20, such as safety improvements, efficiency targets, modernization goals, and/or the like).

FIG. 2C is a schematic block diagram illustrating another example of an assessment schema 150. In the FIG. 2C example, the assessment schema may further define adoption parameters 258 and adoption assessment logic 268. The adoption parameters 258 may be configured to describe risks associated with adoption of the process (and/or respective process states) at the facility 20 and the adoption assessment logic 296 may comprise means for deriving adoption PSM 296 from the parameter set 250.

Referring back to FIG. 2A, the PM module 124 may be configured to construct maps 160 of facility processes. Generating a map 160 for a process may comprise breaking down the process into a collection of interrelated states, each state representing a respective phase of the process (e.g., a phase, step, task, decision, branch, resource utilization, data utilization, information utilization, and/or the like). Process states may be represented by nodes 162 of the map 160. Transitional relationships between process states may be represented by links 164. In some implementations, the PM module 124 may be configured to disassemble processes into categories of a process analysis framework, such as categories of the Lean Six Sigma SIPOC framework (e.g., suppliers, inputs, processes (tasks), outputs, consumers), people, technology, processes, and governance (PTPG) categories of the ION initiative, and/or the like.

The QA module 128 may be configured to derive assessment metrics 190 for respective processes from PMA data 145 of the processes. More specifically, the QA module 128 may be configured to derive assessment metrics 190 for facility processes from stochastic models 170 of the processes. As disclosed in further detail herein, the QA module 128 may be configured to derive assessment metrics 190 using any suitable technique including but not limited to: closed-form analysis of the stochastic model 170, steady-state analysis of the stochastic model, Monte Carlo analysis of the stochastic model 170, and/or the like.

In some implementations, the impact of candidate processes on the facility 20 may be determined by, inter alia, comparing assessments of the candidate processes to the facility BL 215. As disclosed herein, aspects of the facility BL 215 may be maintained in non-transitory storage, e.g., as NTD within the facility DS 210. The facility BL 215 may comprise and/or be derived from assessments of BL processes of the facility 20. Information pertaining to BL processes of the facility 20 may be maintained in respective BL records 220.

Determining a facility BL 115 may comprise determining objective, quantitative assessments of BL processes of the facility 20. In some implementations, a BL process may be assessed based on testing and/or experience. For example, a user 12 may assign quantitative assessment metrics 190 to a BL process based on monitoring real-world operation of the BL process at the facility 20. Alternatively, the FMM module 110 may be configured to determine TERA assessments of BL processes; assessing a BL process may comprise generating PMA data 145 for the BL process (e.g., formulating an assessment schema 150, generating a map 160 of the BL process, and transforming the map 160 into a stochastic model 170) and deriving quantitative assessment metrics 190 therefrom, as disclosed herein.

The FMM module 110 may be configured to store information pertaining to the facility 20 within a facility DS 210. The facility DS 210 may be implemented and/or embodied by non-transitory storage resources, such as the DSS 106 or the like. The facility DS 210 may comprise any suitable information pertaining to the facility 20 including, but not limited to a facility BL 215. The facility BL 215 may comprise one or more BL assessments, each comprising information pertaining to a respective BL process of the facility 20. The BL assessments may be maintained in any suitable format, e.g., as records, entries, tables, objects, and/or the like. In the FIG. 2A example, the FMM module 110 may be configured to record assessments determined for BL processes of the facility 20 within respective BL records 220.

FIG. 2D is a schematic block diagram illustrating an example of a BL record 220. A BL record 220 may comprise any suitable information pertaining to a BL process including, but not limited to: BL process metadata 222, PMA data 145 (e.g., assessment schema 150, a map 160 of the BL process, and a corresponding stochastic model 170), quantitative assessment metrics 190 determined for the BL process, and so on.

As used herein, BL process metadata 222 may comprise and/or refer to any suitable information pertaining to a BL process including, but not limited to: identification data (e.g., a name of the process, an identifier, a unique identifier, a globally unique identifier, and/or the like); descriptive information; information pertaining to resources utilized by the process (e.g., identify personnel responsible for implementation of the process, identify structures, systems, components, and data resources involved in the process, designate process stakeholders, and so on); information pertaining to dependencies of the process; information pertaining to inputs utilized within the process and/or sources of such inputs; information pertaining to outputs of the process and/or endpoints or consumers of such outputs, and/or the like.

As illustrated in FIG. 2D, the BL record 220 may comprise PMA data 145 determined for the BL process, including the assessment schema 150 (e.g., evaluation data 240 comprising constraint data 242, objective data 244, and so on), a parameter set 250, and assessment logic 260. The BL record 220 may further comprise a BL assessment of the BL process, which may comprise quantitative assessment metrics 190 derived from the PMA data 145, as disclosed herein.

Referring back to FIG. 2A, in some implementations, the FMM module 110 may utilize the facility BL 215 to, inter alia, identify FMT for the facility 20. For example, the FMM module 110 may analyze BL records 220 of existing BL processes of the facility 20 to identify “pain points” such as sources of technical deficiencies, economic costs, safety risks, security vulnerabilities (e.g., attack vectors), and/or the like. FMT may be identified based on the quantitative assessment metrics 190 determined for respective BL processes, e.g., BL processes determined to exhibit poor technical metrics 192, economic metrics 194, and/or risk metrics 196 may be selected as potential FMT. For example, FMT may be identified based on a statistical analysis of the BL assessments; the FMM module 110 may be configured to analyze the facility BL 215 to identify outliers within the BL records 220, e.g., identify BL processes having metrics 190 that deviate from the metrics 190 of other BL processes. Alternatively, or in addition, FMT may be configured to expand functional capabilities of the facility 20 (and/or one or more facility processes). For example, an improvement target may be configured to modernize process(es) of the facility 20 in accordance with facility objectives, e.g., modernization guidelines of the ION initiative or the like.

The FMM module 110 may be further configured to formulate candidate processes to address the FMT determined for the facility 20. As illustrated in the FIG. 2A example, in some implementations, the FMM module 110 may be configured to develop a candidate pool 125. The candidate pool 125 may comprise a plurality of candidate processes. One or more of the candidate processes may be configured to modify and/or replace specified BL process(es) of the facility 20. The FMM module 110 may be further configured to maintain information pertaining to the candidate pool 125 within non-transitory storage, such as the DSS 106.

Information pertaining to candidate processes (and/or candidate FMD) may be maintained in non-transitory storage. In the FIG. 2A example, information pertaining to candidate processes may be maintained as candidate records 230. Candidate records 230 may comprise NTD maintained within the facility DS 210. A candidate record 230 may comprise any suitable information pertaining to a candidate process including, but not limited to: PMA data 145 determined for the candidate process, assessment metrics 190, information pertaining to parent(s) of the candidate process (e.g., BL process(es) to be modified by the candidate process and/or candidate FMD thereof); and/or the like.

In some implementations, the FMM module 110 may be configured to formulate candidate processes of the candidate pool 125 by use of, inter alia, a facility modification (FMD) library. The FMD library may be maintained within a non-transitory storage, such as NTS resources 104-3 of the system 100, the DSS 106, and/or the like. In the FIG. 2A example, aspects of the FMD library may be implemented and/or embodied by the facility DS 106 The FMD library may comprise one or more FMD records 175, each comprising information pertaining to a respective candidate FMD, such as a technology, technical solution, or other FMD suitable for implementation within the facility 20. For example, the FMD records 270 may comprise information pertaining to technical solutions suitable for implementation within the facility 20, e.g., technical solutions suitable for deployment within a particular type or class of facility 20, such as NPP or the like. The FMD library may comprise information pertaining to technological solutions corresponding to a specified facility objectives, such as the ION initiative, LWRS, or the like. As disclosed in further detail herein, an FMD record 270 may comprise any suitable information pertaining to a technical solution including, but not limited to technical, economic, risk, and/or adoption characteristics.

In some implementations, the FMM module 110 may be configured to populate the candidate pool 125 by, inter alia, modifying and/or replacing BL processes of the facility 20. In other words, the FMM module 110 may be configured to construct candidate records 230 of the candidate pool 125 by, inter alia, modifying and/or replacing BL processes of one or more BL records 220 to incorporate FMD of one or more FMD records 270. In some implementations, the candidate records 230 may reference FMD records 270 corresponding to candidate FMD utilized therein (if any), e.g., may reference FMD records 270 corresponding to technologies and/or technical solutions utilized by the candidate processes.

As disclosed herein, the FMM module 110 may be configured to formulate candidate processes configured to, inter alia, address improvement targets of the facility 20. For example, the FMM module 110 may construct candidate processes configured to address “pain points” identified within the facility 20 such as sources of technological deficiencies, economic inefficiency, risk, and so on. Alternatively, or in addition, the FMM module 110 may design candidate processes configured to modernize the facility 20 in accordance with facility objectives, e.g., industry guidelines or regulations such as the ION initiative or the like.

The FMM module 110 may be further configured to assess candidate processes in accordance with the TERA framework. The FMM module 110 may be configured to determine quantitative assessment metrics 190 for candidate processes; assessing a candidate process may comprise a) formulating (and/or retrieving) an assessment schema 150 for the process, b) constructing a map 160 of the candidate process, c) transforming the map 160 into a stochastic model 170, and d) deriving quantitative assessment metrics 190 from the stochastic model 170. Information pertaining to candidate processes may be maintained within candidate records 230 within the facility DS 106.

FIG. 2E is a schematic block diagram illustrating an example of a candidate record 230 configured to represent a candidate process. A candidate record 230 may comprise any suitable information pertaining to a BL process including, but not limited to: BL process metadata 222, PMA data 145 (e.g., assessment schema 150, a map 160 of the BL process, and a corresponding stochastic model 170), quantitative assessment metrics 190 determined for the BL process, and so on.

As used herein, candidate process metadata 232 may comprise and/or refer to any suitable information pertaining to a BL process including, but not limited to: identification data (e.g., a name of the process, an identifier, a unique identifier, a globally unique identifier, and/or the like); descriptive information; information pertaining to resources utilized by the process (e.g., identify personnel responsible for implementation of the process, identify structures, systems, components, and data resources involved in the process, designate process stakeholders, and so on); information pertaining to dependencies of the process; information pertaining to inputs utilized within the process and/or sources of such inputs; information pertaining to outputs of the process and/or endpoints or consumers of such outputs, and/or the like.

The candidate process metadata 232 may further comprise information pertaining to the “parent” of the candidate process. As used herein, the “parent” of a candidate process may comprise and/or refer to the BL process modified and/or replaced by the candidate process (if any). In the FIG. 2E example, the candidate record 230 may comprise a parent reference 234, which may comprise any suitable means associating the candidate record 230 with a parent (e.g., BL record 220) including, but not limited to: a name, a distinguished name (DN), an address, an identifier, unique identifier, globally unique identifier (GUID), uniform resource identifier (URI), uniform resource locator (URL), database reference, key, primary key, foreign key, pointer, and/or the like. Aspects of the candidate record 230 may comprise, incorporate, and/or be derived from the BL record 220. For example, the candidate record 230 of a candidate process configured to modify a specified BL process of the facility 20 may incorporate aspects of the assessment schema 150 of the parent BL record 220 such as the evaluation data 240 (e.g., constraint data 242 and objective data 244), parameter set 250, assessment logic 260, and so on.

In some implementations, the candidate process metadata 232 may further comprise information pertaining to FMD utilized by the candidate process. The candidate process metadata 232 may reference candidate FMD utilized by the candidate process (if any). For example, the candidate process metadata 232 may comprise an FMD reference 235, which may comprise suitable means for associating the candidate record 230 with FMD record(s) 270 corresponding to candidate FMD utilized by the candidate process, e.g., may comprise a name, DN, address, identifier, unique identifier, GUID, URI, URL, database reference, key, primary key, foreign key, pointer, and/or the like.

As illustrated in FIG. 2E, candidate records 230 may further comprise PMA data 145, which may include an assessment schema 150, a map 160 of the candidate process, and a corresponding stochastic model 170. Aspects of the assessment schema 150 may be imported from the BL record 220 of the parent of the candidate process (e.g., the process to be altered, improved, updated, replaced, and/or otherwise modified by the candidate process).

Candidate records 230 may further comprise candidate assessments, which ma09y include, but are not limited to quantitative assessment metrics 190 derived from the PMA data 145 of the candidate processes. A candidate assessment may further comprise candidate evaluation data 245. The candidate evaluation data 245 may correspond to the evaluation data 240 of the assessment schema 150. For example, the candidate evaluation data 245 may comprise candidate constraint data 246, which may be configured to indicate a degree to which the candidate process satisfies the constraints and/or requirements of the process as defined by the constraint data 244 of the assessment schema 150. The candidate evaluation data 245 may further comprise candidate objective data 246, which may indicate a degree to which the candidate process satisfies the objectives of the process as defined by the objective data 246 of the assessment schema 150.

Referring back to FIG. 2A, the evaluation module 280 may be configured to select candidate processes (and/or candidate FMD) for implementation at the facility 20. The evaluation module 280 may select candidate processes from the candidate pool 125 based, at least in part, on the TERA assessments determined for the candidate processes. For example, the evaluation module 280 may be configured to select candidate processes based on the quantitative assessment metrics 190 determined for the candidate processes. Selecting a candidate process for implementation may comprise comparing quantitative assessment metrics 190 determined for respective candidate processes of the candidate pool 125 to one another and/or the facility BL 215. In some implementations, the evaluation module 280 may be configured to select candidates based, at least in part, on the impact of respective candidate processes on the technical, economic, and/or risk characteristics of the facility 20 (and/or BL processes of the facility 20). The evaluation module 280 may be configured to objectively quantify the impact of respective candidate processes by, inter alia, comparing the assessment metrics 190 determined for respective candidate processes to the assessment metrics 190 determined for corresponding BL processes of the facility 20. As disclosed herein, in some implementations, the assessment metrics 190 determined for candidate processes may comprise delta metrics; the delta metrics of a candidate process may be configured to quantify differences between the assessment metrics 190 determined for the candidate process and the assessment metrics 190 of corresponding BL processes. In other words, the delta metrics may objectively quantify the impact of candidate processes (and/or respective candidate FMD) on the technical, economic, and/or risk assessment of the BL process to be modified by the candidate FMD.

In some implementations, the evaluation module 280 may be further configured to select candidate processes based on candidate evaluation data 245 determined for the candidate processes. For example, the evaluation module 280 may select candidate processes that satisfy constraints defined for the candidate process (e.g., as indicated by candidate constraint data 246 determined for the candidate process) and/or satisfy objectives for the candidate process (e.g., as indicated by candidate objective data 248 determined for the candidate process). The evaluation module 280 may be configured to filter the candidate pool based on the candidate evaluation data 245, e.g., may be configured to exclude candidate processes that fail to satisfy the constraint data 244 and/or objective data 246.

In some embodiments, the evaluation module 280 may be configured to select candidate processes in accordance with an evaluation scheme 285. As used herein, an evaluation scheme 285 may comprise and/or refer to any suitable information pertaining to the assessment, evaluation, and/or selection of candidate processes. The evaluation scheme 285 may comprise evaluation criteria, such as user-defined weights for quantitative assessment metrics 190. For example, the evaluation scheme 285 may weight economic characteristics more heavily than other TERA attributes, such as technical performance and/or the like. Alternatively, or in addition, the evaluation scheme 285 may be configured to select candidate processes in accordance with an optimization model. The optimization model defined by the evaluation scheme 285 may comprise an evaluation function and optimization constraints; the evaluation module 280 may be configured to identify candidate processes that maximize (or minimize) the evaluation function while satisfying the constraints of the optimization model. The evaluation module 280 may be configured to select optimal candidate processes from the candidate pool 125 in accordance with any suitable optimization technique or algorithm.

The evaluation function may be configured to incorporate the quantitative assessment metrics 190 determined for candidate processes, e.g., technical metrics 192, economic metrics 194, risk metrics 196, adoption metrics 198, sensitivity metrics 195, and so on. The evaluation function may be further configured to incorporate candidate objective data 248 determined for respective candidate processes, which may indicate the degree to which the respective candidate processes satisfy facility objectives (e.g., objective data 244), as disclosed in further detail herein. The evaluation function may comprise one or more of an objective function, criterion function, loss function, cost function, utility function, fitness function, or the like.

The evaluation scheme 285 may further define constraints of the optimization model, which may be based on, inter alia, constraint data 242 defined for respective candidate processes and/or candidate constraint data 246, which may indicate a degree to which the candidate process satisfies the constraints defined for the process, as disclosed in further detail herein. For example, the constraint data 242 may specify a budget for modifications to the facility 20, which may be used to filter candidate processes, e.g., may exclude candidate processes with favorable assessment metrics 190 if initial economic costs of such candidates exceed specified budget limits. Similarly, the constraint data 242 may define other thresholds related to the technical, economic, risk, and/or adoption characteristics of candidate processes. In some implementations, the optimization model may define constraints related to the implementation of candidate processes at the facility 20, e.g., may specify that adoption must be completed within a specified timeframe and the degree to which candidate processes satisfy such constraints may be based, at least in part, on the adoption schemes 135 determined for the candidate processes.

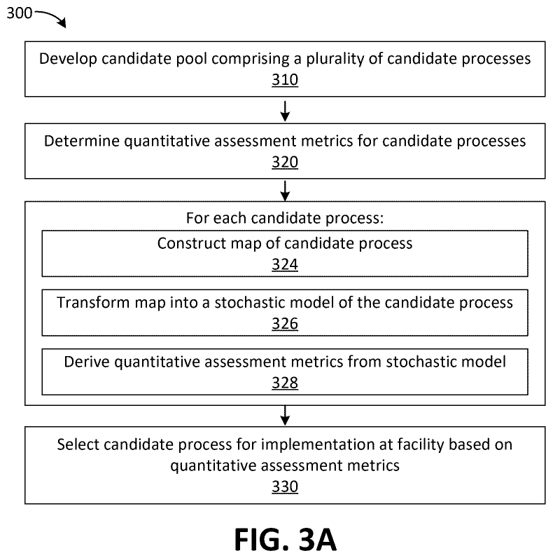

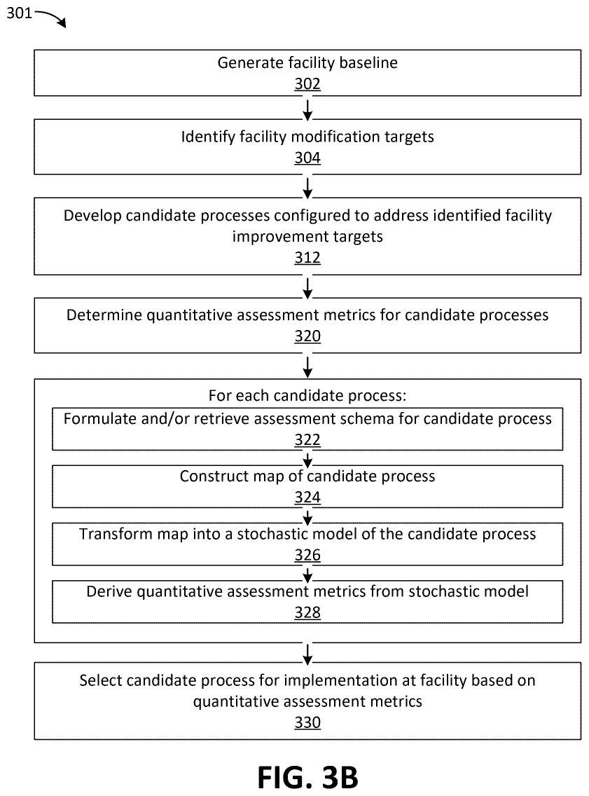

FIG. 3A is a flow diagram illustrating an example of a method 300 for managing modifications at a facility 20 in accordance with the TERA framework disclosed herein. At 310, the FMM module 110 may develop a candidate pool 125 comprising a plurality of candidate processes. The candidate processes may be configured to address FMT identified for the facility 20. The FMT may be identified based on analysis of a BL assessment of the facility 20, BL assessments of one or more BL processes of the facility, facility objectives, and/or the like. Information pertaining to the candidate processes may be maintained as candidate records 230 within non-transitory storage, e.g., a DSS 106.

At 320, the FMM module 110 may determine quantitative assessment metrics 190 for each candidate process of the candidate pool 125. Determining quantitative assessment metrics 190 for a candidate process may comprise a) constructing a map 160 of the candidate process within a computer-readable memory at 324, the map 160 configured to represent a plurality of interconnected states comprising the candidate process, each state of the candidate process represented by a respective map node 162, b) transforming the map 160 into a stochastic model 170 of the candidate process at 326, the stochastic model 170 comprising probabilistic SM links 174 configured to model a probability of transitions between respective states of the candidate process, and c) deriving the quantitative assessment metrics 190 for the candidate process from the stochastic model 170 of the candidate process at 328. Determining the quantitative assessment metrics 190 for the candidate process may further compromise, formulating and/or retrieving an assessment schema 150 for the candidate process, the assessment schema 150 defining a plurality of state parameters (e.g., a parameter set 250) and assigning values corresponding to the state parameters to respective states of the candidate process. In some implementations, the assessment schema 150 may further comprise assessment logic 260 configured to determine quantitative state metrics 290 for respective states of the candidate process based, at least in part, on the state parameter values assigned to the respective states and the quantitative assessment metrics for the candidate process may be are based, at least in part, on the quantitative state metrics 290 determined for the respective states of the candidate process. The FMM module 110 may be further configured to record information pertaining to the candidate processes within the DSS 106 (and/or other NTS resources 104-3 of the system 100). For example, the FMM module 110 may be configured to store information pertaining to respective candidate processes, including the PMA data 145 and/or quantitative assessment metrics 190 determined for the respective candidate processes, within respective candidate records 230.

At 330, the FMM module 110 may be further configured to select a candidate process for implementation at the facility 20 based, at least in part, on the quantitative assessment metrics 190 determined for the candidate processes. In some implementations, the FMM module 110 may select the candidate process in accordance with an evaluation scheme 135. The evaluation scheme 135 may comprise user-defined criteria such as weights for specified quantitative assessment metrics 190, constraint data 242, objective data 244, and so on. Alternatively, or in addition, the FMM module 110 may be configured to select the candidate process by constructing an optimization model comprising an evaluation function and constraints and utilizing the optimization model to identify a candidate process that maximizes (or minimizes) the evaluation function while satisfying the constraints.

As disclosed herein, manual and/or human-driven approaches to managing facility modifications can suffer from numerous drawbacks. For example, the intricate and interconnected nature of many facilities 20 may make it difficult, or even impossible, to accurately predict the technical, economic, risk, and adoption implications of candidate modifications. Challenges such as conflicting schedules, regulatory compliance issues, and safety concerns can complicate screening and evaluation, rendering manual and/or human-driven approaches unwieldy and inaccurate. Moreover, the involvement of multiple personnel groups can result in subjective perspectives, varying priorities, and resistance to change. Evaluating candidate processes using the wholistic, objective quantitative assessment metrics 190 determined in accordance with the TERA framework may address these and other shortcomings. As illustrated above, the metrics 190 determined for respective candidate processes comprise an objective, quantitative assessment of the technical, economic, risk, and adoption characteristics of the respective candidate processes. The technical, economic, risk, and adoption characteristics of each process state are objectively represented within a map 160, which is transformed into a probabilistic stochastic model 170. The disclosed metrics 190 are derived through stochastic modeling of respective process states and, as such, avoid the subjectivity and limited scope of manual, human-driven approaches. Therefore, the systems and methods for managing facility modifications in accordance with the TERA framework disclosed herein constitute an improvement to the technical field of facility modification management.

FIG. 3B is a flow diagram illustrating another example of a method 301 for managing modifications at a facility 20. At 302, the FMM module 110 may be configured to determine a baseline of the facility 20, e.g., may generate, determine, update, modify and/or otherwise develop a facility BL 215. Generating facility BL 20 may comprise determining TERA assessments of one or more BL processes of the facility 20. Determining a TERA assessment of a BL process of the facility 20 may comprise configuring the assessment module 120 to perform TERA operations to objectively and quantitatively assess technical, economic, and/or risk characteristics of the BL process, as disclosed herein. Assessing a BL process may comprise a) formulating an assessment schema 150 for the BL process, the assessment schema 150 defining a parameter set 250 and assessment logic 260, b) constructing a map 160 of the BL process within a computer-readable memory, the map 160 configured to represent a plurality of interconnected states comprising the BL process, each state of the BL process represented by a respective map node 162, c) transforming the map 160 into a stochastic model 170 of the BL process, the stochastic model 170 comprising probabilistic SM links 174 configured to model a probability of transitions between respective states of the BL process, and d) deriving the quantitative assessment metrics 190 for the BL process from the stochastic model 170 of the BL process. Alternatively, or in addition, the FMM module 110 may determine quantitative assessment metrics 190 for the BL process based on testing and/or experience, as disclosed herein. The FMM module 110 may be further configured to record information pertaining to BL processes of the facility 20 within the DSS 106 (and/or other NTS resources 104-3 of the system 100) at 302. For example, assessments of BL processes, such as the PMA data 145 determined for the BL processes and corresponding quantitative assessment metrics 190 may be maintained within BL records 220 of a facility BL 215, as disclosed herein.

At 304, the FMM module 110 may be configured to identify one or more FMT for the facility 20. The FMT may be identified based, at least in part, on the facility BL 215 determined at 302. At 304, the FMT may be identified by, inter alia, analyzing the PMA data 145 and/or corresponding quantitative assessment metrics 190 determined for respective BL processes of the facility 20. In some implementations, one or more of the FMT identified at 304 may correspond to “pain points” identified within the facility 20 (and/or one or more BL processes thereof), such as sources of technical deficiencies, economic costs, safety risks, security vulnerabilities (e.g., attack vectors), and/or the like. Alternatively, or in addition, one or more of the improvement targets identified at 304 may correspond to a facility objective, such as an industry initiative, guidelines or regulations, as disclosed herein. For example, at 304, the FMM module 110 may identify FMT configured to modernize BL processes of the facility 20 in accordance with modernization guiding principles of the ION initiative or the like.

At 312, the FMM module 110 may be configured to develop candidate processes configured to address the FMT identified at 304. The candidate processes may comprise and/or incorporate one or more candidate FMD such as technological solutions suitable for implementation at the facility 20. In some implementations, the FMM module 110 may be configured to generate, determine, refine, expand, modify, and/or otherwise develop a candidate pool 125 for the facility 20 at 312. The candidate pool 125 may comprise candidate records 230, each candidate record 230 comprising information pertaining to a respective candidate process. One or more candidate processes of the candidate pool 215 may be configured to modify and/or replace specified parent BL process(es) of the facility 20. The FMM module 110 may be configured to record information pertaining to the candidate processes within respective candidate records 230. The candidate records 230 may be maintained in non-transitory storage, such as a DSS 106, NTS resources 104-3 of the apparatus 101, and/or the like.

At 312, the FMM module 110 may generate aspects of one or more candidate processes by use of the UI module 112. The FMM module 110 may utilize the UI module 112 to generate UI 114 configured to enable users 12 to create, author, refine, modify, edit, program, test, debug, and/or otherwise candidate processes (and/or candidate FMD). The FMM module 110 may enable users 12 to author candidate processes, import candidate processes (and/or candidate FMD), modify imported candidate processes, and so on.

In some implementations, the FMM module 110 may be configured to develop candidate processes that comprise and/or incorporate candidate FMD of an FMD library. As disclosed herein, the FMD library may comprise FMD records 270, each FMD record 270 comprising information pertaining to a respective candidate FMD, e.g., a technology, technological solution, and/or other FMD suitable for implementation at the facility 20. The FMD records 270 may comprise information pertaining to FMD configured to address improvement targets identified within the facility 20, e.g., improvement targets identified at 204. For example, the FMD records 270 may comprise information pertaining to FMD configured to address “pain points” of the facility 20 (e.g., address deficiencies in the technical, economic, and/or risk assessment of the facility 20 and/or BL processes thereof), achieve modernization goals determined for the facility 20, and/or the like. In some implementations, the FMD records 270 may comprise information pertaining to FMD suitable for specified industries and/or facility types, e.g., may comprise information pertaining to technological solutions suitable for deployment within NPP, LWRS or the like. Alternatively, or in addition, the FMD library may comprise information pertaining to FMD developed in accordance with industry guidelines, such as the ION initiative, the PMP for LWRS program, or the like.

At 320, the FMM module 110 may be configured to determine quantitative assessment metrics 190 for the candidate processes, e.g., for each candidate process of the candidate pool 125. Determining quantitative assessment metrics 190 for a candidate process may comprise a) formulating and/or retrieving an assessment schema for the candidate process at 322, the assessment schema 150 comprising a parameter set 250 and assessment logic 160, b) constructing a map 160 of the candidate process within a computer-readable memory at 324, the map 160 configured to represent a plurality of interconnected states comprising the candidate process, each state of the candidate process represented by a respective map node 162, c) transforming the map 160 into a stochastic model 170 of the candidate process at 326, the stochastic model 170 comprising probabilistic SM links 174 configured to model a probability of transitions between respective states of the candidate process, and d) deriving the quantitative assessment metrics 190 for the candidate process from the stochastic model 170 of the candidate process at 328.

In some implementations, the FMM module 160 may import aspects of the assessment schema 150 from a parent of the candidate process at 322. As disclosed herein, candidate processes may be configured to modify and/or replace BL processes of the facility 20. The BL process to be modified and/or replaced by a candidate process may comprise and/or be referred to as a “parent” of the candidate process. Similarly, the candidate process(es) configured to modify and/or replace a BL process may be referred to as “children” of the BL process. The children of a BL process may share an assessment schema 150 with the BL process. Accordingly, the BL process and corresponding candidate processes may be assessed using the same (or similar) quantitative assessment metrics 190 derived from the same (or similar) parameter set 250, assessment logic 260, and so on.

At 330, the FMM module 110 may select one or more candidate processes for implementation at the facility 20. The candidate processes may be selected by an evaluation module 280, as disclosed herein. Candidate processes may be selected based on any suitable criteria. In some implementations, candidate processes may be selected based, in least in part, on the quantitative assessment metrics 190 determined for the candidate processes at 320. Alternatively, or in addition, candidate processes may be selected based on A metrics configured to objectively quantify differences between candidate processes and corresponding parent BL processes (e.g., differences between the quantitative assessment metrics 190 determined for respective candidate processes and the quantitative assessment metrics 190 of the corresponding parent BL processes). Alternatively, or in addition, the evaluation module 280 may be configured to select candidate processes that satisfy specified constraints (e.g., per constraint data 242), satisfy specified objectives (e.g., per objective data 244), and so on.

In some implementations, candidate processes may be selected in accordance with optimization criteria and/or an optimization model. As disclosed in further detail herein, the optimization model may be configured to identify candidate processes (and/or candidate FMD) that are predicted to optimally improve the technical, economic, and/or risk characteristics of the facility 20 while satisfying specified constraints.

In some implementations, the FMM module 110 may be further configured to manage the implementation of the candidate FMD selected at 210. The FMM module 110 may configure the implementation module 130 to produce an adoption scheme 135 configured to manage the design, development, deployment, and/or operation of selected candidate processes (and/or candidate FMD) within the facility 20.

Referring back to FIG. 2A, the FMM module 110 may be configured to determine, update, and/or otherwise maintain information pertaining to the facility 20, such as a facility BL 215. As disclosed herein, the facility BL 215 may comprise a technical, economic, and/or risk assessment of the facility 20 and/or one or more BL process(es) thereof. Developing a facility BL 215 may comprise performing TERA operations to assess the technical, economic, and/or risk characteristics of one or more BL processes of the facility 20.

The FMM module 110 may utilize the facility BL 215 (and/or the BL records 220 thereof) to, inter alia, identify improvement targets. The FMM module 110 may be further configured to develop a candidate pool 125 comprising candidate FMD designed to address the identified improvement targets. The candidate FMD may be configured to modify respective BL processes. Accordingly, the BL records 220 may be used to, inter alia, evaluate the feasibility, effectiveness, and benefits of respective candidate FMD. For example, the impact of a candidate FMD configured to modify a specified BL process may be objectively quantified by comparing the technical, economic, and/or risk assessment of the BL process (e.g., as stored within a corresponding BL record 210) to the technical, economic, and/or risk assessment of the candidate process.

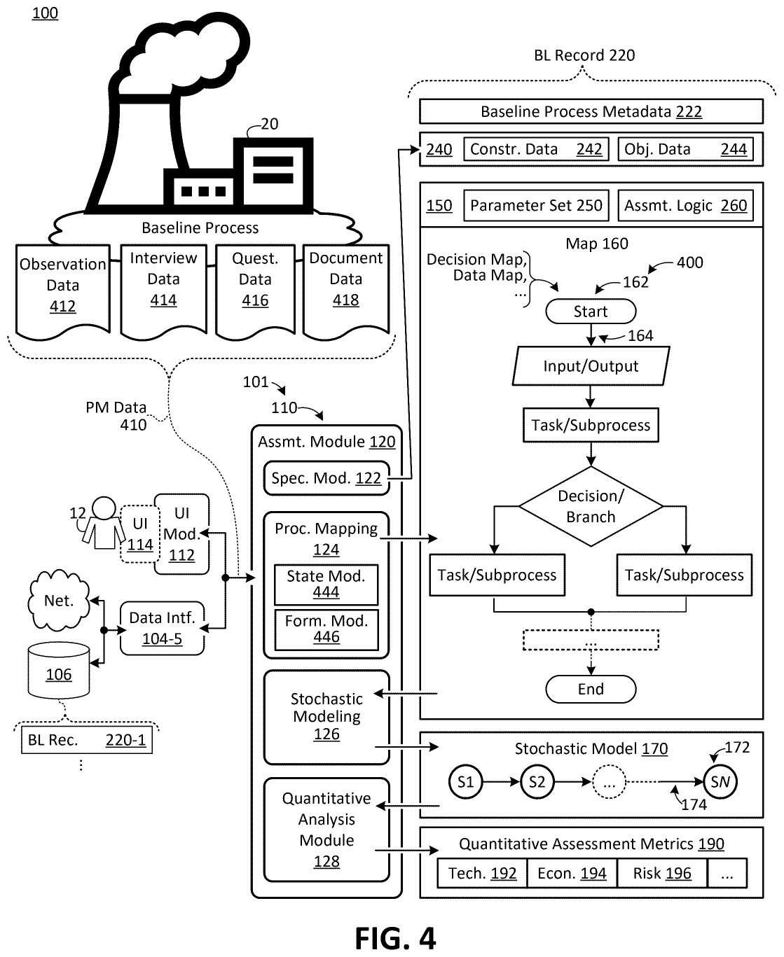

FIG. 4 is a schematic block diagram illustrating an example of an assessment module 120 configured to generate technical, economic, and/or risk assessments of BL process(es) of a facility 20 in accordance with the TERA framework disclosed herein. As illustrated in FIG. 4, assessing a BL process may comprise acquiring process assessment data 410. As used herein, process assessment (PA) data 410 may comprise and/or refer to any suitable information pertaining the design, implementation, and/or operation of a facility process.

The assessment module 120 may be configured to acquire any suitable information pertaining to the technical, economic, and/or risk characteristics of a process including, but not limited to: observation data 412, interview data 414, questionnaire data 416, document data 418, and so on. Observation data 412 may comprise information acquired through observation of the process. Observation data 412 may comprise data acquired during operation and/or implementation of the process, e.g., may comprise measurements, reports, observations and/or other data acquired during real-time operation of the BL process within the facility 20. Interview data 414 may comprise and/or refer to data acquired through discussion with personnel associated with the process, such as stakeholders, experts, participants, and so on. Questionnaire data 416 may comprise and/or refer to data acquired through responses to predetermined questions posed to a designated audience, such as facility personnel or the like. In some implementations, questionnaire data 416 may be acquired anonymously to minimize potential bias. Document data 418 may comprise and/or refer to data acquired from documents pertaining to the BL process, such as process documentation, certification documents, compliance documents, reports, incident records, and/or the like. Document data 418 may comprise any suitable type of data, including human-readable documents, machine-readable data (e.g., database records, tables, or the like), and so on.

The assessment module 120 may be configured to acquire PA data 410 by any suitable means and/or from any suitable source. For example, the assessment module 120 may be configured to acquire PA data 410 through a UI 114 of the FMM module 110, e.g., by UI 114 generated by the UI module 112 and presented to user(s) 12 by use of HMI resources 104-4 of the apparatus 101. The assessment module 120 may utilize the UI module 112 to generate UI 114 configured to guide users 12 through the acquisition of PA data 410. For example, the UI 14 may be configured to prompt users 12 to acquire observation data 412 pertaining to the BL process (e.g., instruct users 12 to monitor specified aspects of the BL process), gather interview data 414 (e.g., guide users 12 through interviews with designated personnel), collect questionnaire data 416 (e.g., generate questionnaires, distribute questionnaires to designated personnel, or the like), import document data 418 (e.g., prompt users 12 to upload relevant documents), and so on. Alternatively, or in addition, the PM module 124 may acquire PA data 410 through DI resources 104-5 of the apparatus 101. The DI resources 104-5 may be configured to retrieve PA data 410 from a data storage system (e.g., DSS 106 or other, external DSS), a data store (e.g., facility DS 210f), network, and/or the like. For example, the PM module 124 may be configuref42d to retrieve observation data 412 pertaining to the BL process from a monitoring system of the facility 20, retrieve document data 418 from a repository, and/or the like.

In some implementations, the assessment module 120 may comprise and/or be coupled to a specification module 122. The specification module 122 may be configured to define aspects of assessment schema 150 and/or BL process metadata 222, as disclosed herein. For example, the specification module 122 may be configured to generate constraint data 242 for facility processes. As used herein, constraint data 242 may comprise and/or refer to data configured to define requirements and/or constraints of a process, which may include, but are not limited to: functional requirements (e.g., functional capabilities), performance standards, governance requirements, process constraints, boundary conditions, limits, and/or the like. Requirement data 332 may define the requirements and/or constraints that the BL process currently adheres to and, as such, candidate processes modifying the BL process may also be required to satisfy. For example, the constraint data 242 of a process may specify that outputs generated by the process are required to satisfy specified accuracy and/or quality thresholds. The FMM module 110 may utilize process constraint data 242 to, inter alia, ensure that candidate FMD satisfy requirements and/or constraints of the BL processes modified thereby.

As disclosed herein, effective problem-solving within the technical domain relies heavily on well-defined requirements and a thorough understanding of the existing challenges. In this context, technical requirements (as defined in the constraint data 242 of respective BL processes) play a pivotal role in shaping proposed solutions and identifying technologies that align seamlessly with the specified criteria. The first facet of the technical assessment is a detailed development and analysis of the functional requirements of respective facility processes. This facet involves analysis of current, BL processes to ensure that proposed solutions meet the functional capabilities, performance standards, requirements, governance, and constraints to which current facility processes adhere. For example, a BL process may require outputs exceeding a certain measure for accuracy or quality. Candidate processes that modify and/or replace the BL process may also be required to satisfy these accuracy and/or quality requirements. It is imperative throughout this assessment that functional requirements are recorded, and the performance of candidates are accurately assessed. As such, in some implementations, the constraint data 242 for respective BL processes may be developed by stakeholders and subject matter experts familiar with the BL processes, e.g., may be derived from suitable observation data 412, interview data 414, questionnaire data 416, document data 418, and/or the like.

As disclosed in further detail herein, the specification module 122 may be further configured to evaluate candidate processes comprising various technologies (at different technology readiness levels) that can meet the functional requirements defined for respective BL processes. In other words, he candidate prosses may be evaluated for their ability to meet the requirements and/or constraints of the parent BL processes to be modified and/or replaced thereby as well as their readiness to integrate into the facility 20 (e.g., the nuclear industry). Furthermore, candidate processes may be assessed for their compatibility with existing systems of the facility 20, case of integration, and the potential for customization to meet specific needs.

The specification module 122 may be further configured to generate objective data 244 for BL processes. As used herein, objective data 244 may comprise and/or refer to any suitable information pertaining to improvement target(s) determined for the facility 20 and/or facility process(es). For example, the objective data 244 of a BL process may identify technical, economic, and/or risk deficiencies identified within the BL process. Alternatively, or in addition, objective data 244 may comprise information pertaining to high-level objectives of the facility 20 such as goals related to improving safety, efficiency, reliability, downtime, or other predefined goals. For example, the FMM module 110 may be configured to manage FMD in accordance with an overall facility improvement strategy, e.g., an overall strategy for facility modernization, safety improvement, economic streamlining, resilience, security hardening, and/or the like. The objective data 244 may define technical, economic, and/or risk improvement targets in accordance with regulatory requirements of the facility and/or industry guidelines such as the Plant Modernization Pathway for LWRS program, the ION initiative, and/or the like. The FMM module 110 may utilize objective data 244 to evaluate the degree to which candidate processes (and/or candidate FMD) align with objectives of the facility 20.

The specification module 122 may be configured to derive aspects of the evaluation data 240 from PA data 410 pertaining to the BL process (and/or facility 20 as a whole) such as observation data 412, interview data 414, questionnaire data 416, document data 418, and/or the like. In some implementations, the specification module 122 may be configured to acquire relevant PA data 410 by use of the UI module 112. For example, the specification module 122 may configure the UI module 112 to generate UI 114 configured to: prompt users 12 to specify requirements and/or constraints of the process; guide users 12 through the acquisition of suitable observation data 412 (e.g., identify the types of observation data 412 suitable for determining requirements and/or constraints of the process); facilitate the acquisition of suitable interview data 414 (e.g., guide interviews with designated personnel); present questionnaires to user(s) 12 configured to elicit information pertaining to requirements and/or constraints of the process; facility retrieval of document data 418 pertaining to requirements and/or constraints of the process (e.g., prompt users 12 to upload relevant documents); and so on.

As disclosed herein, assessing a process under the TERA framework may comprise generating an assessment schema 150, constructing PMA data 145 for the process in accordance with the assessment schema 150, and deriving quantitative assessment metrics 190 based, at least in part, on the PMA data 145. Accordingly, assessing a process under the TERA framework may comprise determining an assessment schema 150 for the process.

The PM module 124 may be configured to generate aspects of the assessment schema 150. As illustrated in the FIG. 4 example, the PM module 124 may comprise a state module 444 configured to determine a parameter set 250 of the BL process and a formulation module 446, which may be configured to formulate means for deriving quantitative assessment metrics 190 for the process from the parameter set 250. The parameter set 250 may define parameters configured to describe the technical, economic, and/or risk characteristics of the process and/or respective process states. As used herein, a “state” of a process (or “process state”) may comprise and/or refer to any suitable aspect of a process, including, but not limited to: an initial or start state of the process; a phase or step of the process (e.g., a task, subprocess, operation, input operation, output operation, or the like); a decision (e.g., process decision point, branch, loop, control loop, iteration, or the like); an end state of the process; and/or the like.

The parameter set 250 determined by the PM module 124 may enumerate parameters that impact the technical, economic, and/or risk characteristics of the process (and/or respective process states). In other words, the parameter set 250 may define parameters pertaining to, inter alia economic characteristics of the process and/or respective process states (e.g., resource utilization, personnel utilization, data utilization, and/or the like); technical characteristics of the process and/or respective process states (e.g., performance factors, functional capabilities, technical capabilities, and/or the like); risk characteristics of the process and/or respective process states (e.g., personnel safety risk factors, risks to structures, systems, and components (SSC), plant safety risk, and so on); and/or the like.

In some implementations, the state module 444 may be configured to break down processes according to an analytical framework. For example, the state module 444 may be configured to analyze processes according to the Lean Six Sigma SIPOC framework and parameters of the parameter set 250 may correspond to SIPOC categories such as: Suppliers (e.g., people or organizations that contribute to or are involved in the process or process task), Inputs (e.g., tools, data, information, or other resources contributed by the suppliers), Processes (e.g., operations, tasks, and/or subprocesses by which inputs are processed), Outputs (e.g., results of the process or item(s) created in the process), and Consumers (e.g., receiver(s) of output(s) generated by the process).

Although examples of specific mapping techniques are described herein, the disclosure is not limited in this regard and could be adapted to utilize any suitable process mapping and/or modeling approach (or combination thereof). For example, in some implementations, aspects of the parameter set 250 determined by the state module 444 may correspond to People, Technology, Process, and Governance (PTPG) categories of the ION initiative. Under the PTPG framework, processes may be viewed as comprising four interdependent resources: people, technology, process, and governance, which may determine how and why the process functions. The state module 444 may configure the parameter set 250 to quantify utilization of PTPG categories within respective process states.

The process maps 160 generated by the PM module 124 may further comprise process decision maps. As used herein, a decision map may comprise and/or refer to information configured to represent and/or model decision points within a process and/or identify information and actions leading to such decisions. Decision maps may aid in evaluating critical decision-making points, potential bottlenecks, and areas of risk. Generating a decision map may comprise identifying decision points (e.g., identifying decisions and/or branches within the process), determining decision criteria for respective decision points (e.g., identifying information utilized at respective decision points), analyzing dependencies (e.g., that depend on other decision points, specific data points, or the like), and so on. Decision maps may be helpful when integrating decisions and processes together into one cohesive process. These are also helpful when creating and understanding process flow, input-output relationships, and functional requirements for a given process.

In some implementations, the state module 444 may be further configured to determine a data map of the process. Aspects of the data map may be recorded within the process map 160, e.g., the process map 160 may comprise a data map. The data map may comprise any suitable information pertaining to data utilization within the process and/or respective process states. For example, the data map may comprise a visual chart depicting data flow within the process. Generating the data map may comprise: identifying data sources of the process (e.g., identifying sources of data utilized within the process, such as DSS, DS, databases, files, manual inputs, or the like); identifying data endpoints of the process (e.g., identifying destinations for data utilized, processed and/or otherwise produced by the process, which may include destinations within the facility 20, external endpoints, or the like); analyzing data relationships (e.g., analyzing connections between source data fields and endpoint counterparts); determining data conversions (e.g., determining operations for transforming, formatting, and/or otherwise converting data, if needed); and so on. The PM module 124 may be further configured to apply and/or test the data map determined for the process to detect potential data loss or discrepancies. The data map may aid in ensuring consistent data quality and security, while facilitating process improvements. Data maps may be particularly effective for digital modernization and transformations due to the increasing use of data to support analysis and decision making.

As disclosed herein, the PM module 124 may further comprise a formulation module 446, which may be configured to define assessment logic 260 for the process. The assessment logic 260 may comprise means for deriving quantitative assessment metrics 190 from the parameter set 250. The formulation module 446 may be configured to generate assessment logic 260 comprising any suitable means for deriving quantitative assessments from a parameter set 250, including, but not limited to: rules, instructions, one or more function(s), one or more formula, machine-readable instructions, human-readable instructions, executable instructions, code, machine-readable code, executable code, human-readable code, file data (e.g., spreadsheet file or code), and/or the like.

Constructing a stochastic model 170 for a process, such as a BL process as illustrated in the FIG. 4 example, may comprise: a) determining an assessment schema 150 for the process, b) disassembling the process into a set of interrelated process states in accordance with the determined assessment schema 150, and c) recording information pertaining to respective process states (and/or relationships between such states) within a process map 160. The process map 160 may comprise and/or be embodied by machine-readable data in any suitable format or structure. For example, the process map 160 illustrated in FIG. 4 may comprise a graph data structure 400 comprising nodes 162 connected by edges or links 164. Nodes 162 of the process map 160 may be configured to represent respective process states and the links 164 may represent relationships between such states (e.g., may represent state transitions).

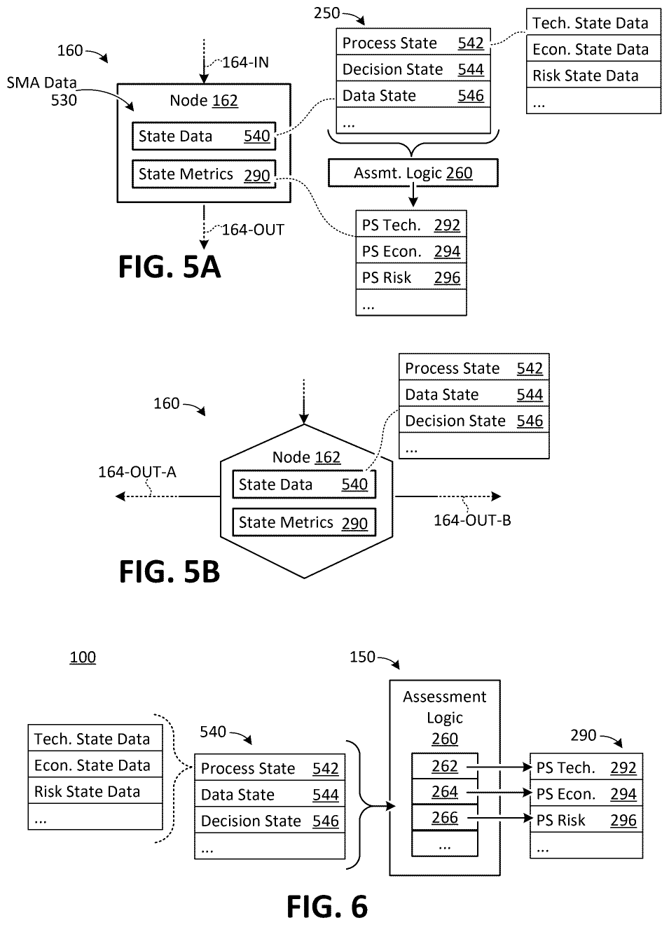

FIG. 5A is a schematic block diagram illustrating an example of a node 162 of a process map 160 (e.g., a map node 162). As disclosed herein, nodes 162 of a process map 160 may be configured to represent respective states of the process; a node 162 may be configured to represent a process step, phase, task, operation, input operation, output operation, subprocess, decision point, branch, or the like. Nodes 162 may comprise and/or be associated with state modeling and assessment data 530. As used herein, the state modeling and assessment (SMA) data 530 of a process state may comprise and/or refer to data pertaining to the technical, economic, and/or risk characteristics of the process state. The SMA data 530 of a node 162 may include state data 540 and state metrics 290. As used herein, state data 540 may comprise and/or refer to any suitable information pertaining the process state represented by a node 162. State data 540 may comprise quantitative state data corresponding to the parameter set 250 determined for the process. The state metrics 290 may comprise an objective, quantitative technical, economic, and/or risk assessment of the process state which may derived from, inter alia, state data 540 of the process state in accordance with the assessment logic 260 determined for the process. The state metrics 290 may, therefore, comprise and/or be referred to as quantitative state metrics 290, quantitative state assessment metrics 290, or the like.

The state data 540 illustrated in the FIG. 5A example may comprise and/or define a process state 542. The process state 542 may comprise values corresponding to the parameter set 250 determined for the process. In other words, the process state 542 may comprise information pertaining to technical, economic, and/or risk characteristics of the process state represented by the node 162 (e.g., values corresponding to technical parameters 252, economic parameters 254, risk parameters 256, adoption parameters 258, and so on). As disclosed in further detail herein, the process state 542 of a node 162 may comprise technical state data pertaining to technical characteristics of the process state, economic state data pertaining to economic characteristics of the process state, risk state data pertaining to risk characteristics of the process state, and so on.

As used herein, technical state data may comprise and/or refer to data configured to describe the technical characteristics of a process state. Technical state data may comprise information configured to represent and/or model technical characteristics of the process state, such as technical functionality implemented and/or utilized in the process state, performance characteristics, accuracy, precision, reliability, and so on. Technical state data may comprise quantities corresponding to technical parameters 252 of the parameter set 250 determined for the process.

As used herein, economic state data may comprise and/or refer to data configured to describe the economic characteristics of a process state. Economic state data may comprise information pertaining to the economic costs associated with the process state, e.g., identify resources utilized by and/or within the process state such as personnel, equipment, and/or other resources utilized within the phase of the process represented by the node 162 and so on. In some implementations, the process state 542 (e.g., economic state data) may comprise information pertaining to the utilization of respective resource categories, such as SIPOC categories, PTPG categories, or the like. In some implementations, the economic costs associated with a process state may be expressed as a function of time, e.g., may specify that the process state results in a specified cost per hour or the like. Economic state data may comprise quantities corresponding to economic parameters 254 of the parameter set 250 determined for the process.

As used herein, risk state data may comprise and/or refer to data configured to describe the risk characteristics of a process state. Risk state data may comprise information pertaining to one or more risk categories including, but not limited to: personnel safety risk, risks to structures, systems, and components (SSC), plant safety risk, and so on. Risk state data may comprise quantities corresponding to risk parameters 256 of the parameter set 250 determined for the process.

In some implementations, the process maps 160 generated by the assessment module 120 may comprise information pertaining to decision points of the process, e.g., may comprise aspects of a decision map determined for the process. As illustrated in the FIG. 5A example, the state data 540 may comprise and/or define decision states 544 or respective process states. The decision state 544 of a process state may comprise information pertaining to transitions to and/or from the process state. For example, the decision state 544 may comprise information pertaining to incoming state transitions (e.g., transitions into the process state represented by the node 162), e.g., the decision state 544 may comprise information pertaining to the incoming link 164-IN of the process map 160 and/or other conditions invoking the process state. The decision state 544 may further comprise information pertaining to outgoing state transitions, e.g., transitions into a next state of the process represented by the process map 160. In a first non-limiting example, the node 162 may be configured to represent a process task and the decision state 544 may define criteria for transitioning to a next process state via link 164-OUT, e.g., the decision state 544 may comprise criteria for determining whether the task has been completed or the like. In a second non-limiting example, the node 162 may be configured to represent a decision point or branch, as illustrated in FIG. 5B. The decision state 544 may define criteria for selecting one or more of a plurality of outgoing links. In the FIG. 5B example, the decision state 544 may define criteria for transitioning to the next state via either link 164-OUT-A or link 164-OUT-B.

As disclosed herein, in some implementations, the process maps 160 generated by the assessment module 120 may comprise information pertaining to data utilization such as a data map. As illustrated in the FIG. 5A example, the state data 540 determined for respective nodes 162 of a process map 160 may comprise and/or define a data state 546 of the process state represented by the node 162. The data state 546 may comprise information pertaining to data utilization by and/or within the process state represented by the node 162; the data state 546 may identify sources of data inputs utilized in the process state, identify endpoints for data output by the process in the process state, specify data mapping information (e.g., define connections between source data fields and corresponding destinations), define data conversions utilized in the process state (if any), and so on.

As further illustrated in FIG. 5A, nodes 162 of the process map 160 may comprise state metrics 290. The state metrics 290 of a node 162 may comprise an objective, quantitative assessment of the process state represented by the node 162. The state metrics 290 of a process state may be derived from and/or based, at least in part, on state data 540 of the node 162. The disclosed state metrics 290 may be configured to assess any suitable aspect of a process and/or process state. As illustrated in the FIG. 5A example, the state metrics 290 determined for respective nodes 162 of the process map 160 may comprise technical, economic, and/or risk assessments of the process states represented by the nodes 162.

The state metrics 290 of respective nodes 162 may be generated in accordance with the assessment schema 150 determined for the process. The assessment logic 260 may be configured derive state metrics 290 for respective process states from state data 540 assigned to the process states. The state metrics 290 may comprise process state (PS) technological metrics 292, PS economic metrics 294, PS risk metrics 296, and so on.

FIG. 6 is a schematic block diagram illustrating an example of assessment logic 260 configured to determine state metrics 290 for respective states of a process. As disclosed herein, the state metrics 290 of a process state represented by a node 162 of the process map 160 may be based, at least in part, on state data 540 of the node 162. The assessment logic 260 may comprise any suitable means for deriving state metrics 290 from state data 540 including, but not limited to: rules, instructions, one or more function(s), one or more formula, machine-readable instructions, human-readable instructions, executable instructions, code, machine-readable code, executable code, human-readable code, file data (e.g., spreadsheet file or code), and/or the like.

In some implementations, the assessment logic 260 may be configured to derive quantitative assessment metrics 190 comprising one or more KPIs. The KPIs may be configured to define objective, measurable success criteria pertaining to technical, economic, and/or risk characteristics of the process (and/or respective process states).

As illustrated in the FIG. 6 example, the assessment schema 150 may comprise technical assessment logic 262 be configured to objectively and quantitatively assess the technical characteristics of respective process state. For example, the PS technical metrics 292 may comprise KPI configured to assess technical functionality, efficiency, accuracy, failure rate, reliability, completion time, labor reduction, and/or the like. The PS technical metrics 292 of a process state may be based, at least in part, on state data 540 associated with the process state. For example, the PS technical metrics 292 of a process state may be based on state data 540 configured to describe technical characteristics of the process state, e.g., technical state data. The disclosure is not limited in this regard; in some implementations, the disclosed PS technical metrics 292 may incorporate other aspects of the state data 540, e.g., economic state data, risk state data, decision state 544, data state 546, and/or the like.

In some implementations, the assessment schema 150 may further comprise economic assessment logic 264 configured to determine PS economic metrics 294 for respective process states. The PS economic metrics 294 may be configured to objectively and quantitatively assess any suitable economic characteristic of a process state. For example, the PS economic metrics 294 may comprise economic KPI or the like. The PS economic metrics 294 may correspond to economic success criteria defined for the process, such as cost, investment return, and so on. The PS economic metrics 294 of a process state may be based, at least in part, on state data 540 associated with the process state. For example, the economic assessment logic 264 may derive PS economic metrics 294 for respective process states based on economic state data quantifying, inter alia, resources utilized within the process states, e.g., suppliers, personnel, and so on. The disclosure is not limited in this regard, however; in some implementations, the disclosed PS economic metrics 294 may incorporate other aspects of the state data 540, e.g., technical state data, risk state data, decision state 544, data state 546, and/or the like.

As further illustrated in the FIG. 6 example, the assessment schema 150 may comprise risk assessment logic 266 configured to determine PS risk metrics 296 for respective process states. The PS risk metrics 296 may be configured to objectively and quantitatively assess any suitable risk characteristic of a process state. For example, PS risk metrics 296 may be configured to assess operational, financial, regulatory, safety, and/or strategic risk associated with the process state represented by the node 162. The PS risk metrics 296 may be based, at least in part, on state data 540 associated with the process state. For example, the risk assessment logic 266 may derive PS risk metrics 296 for respective process states based on, inter alia, resources utilized within the process states, e.g., suppliers, personnel, and so on. Aspects of the PS economic metrics 294 may be based on state data 540 configured to describe risk characteristics of the process state, e.g., risk state data. The disclosure is not limited in this regard; in some implementations, the disclosed PS risk metrics 296 may incorporate other aspects of the state data 540, e.g., technical state data, economic state data, decision state 544, data state 546, and/or the like.

Referring back to FIG. 4, aspects of the assessment logic 260 may be generated by a formulation module 446 of the system 100. As disclosed herein, the assessment logic 260 may be configured to determine state metrics 290 for respective process states based, at least in part, on state data 540 of the respective process states. The formulation module 446 may be configured to generate assessment logic 260 comprising any suitable means for deriving state metrics 290 from state data 540, as disclosed herein, e.g., rules, instructions, one or more function(s), one or more formula, machine-readable instructions, human-readable instructions, executable instructions, code, machine-readable code, executable code, human-readable code, file data (e.g., spreadsheet file or code), and/or the like.

In some implementations, the formulation module 446 may generate aspects of the assessment logic 260 by use of the UI module 112. The formulation module 446 may utilize the UI module 112 to generate UI 114 configured to enable users 12 to create, author, refine, modify, edit, program, test, debug, and/or otherwise develop assessment logic 260. The formulation module 446 may utilize the UI module 112 to provide users 12 with an editor, integrated development environment (IDE), or the like.

Alternatively, or in addition, formulation module 446 may derive aspects of the assessment logic 260 from PA data 410 pertaining to the process (and/or respective process states), e.g., observation data 412, interview data 414, questionnaire data 416, document data 418, and so on. For example, technical assessment logic 262 (and/or PS technical metrics 292 for one or more process states) may be extracted from observation data 412 such as measurements of the accuracy and/or completion time of one or more process states. By way of further example, economic assessment logic 264 (and/or PS economic metrics 294 for one or more process states) may be retrieved from interview and/or questionnaire data 414/416 identifying personnel involved in implementation of the one or more process states. In another example, risk assessment logic 266 (and/or PS risk metrics 296 for one or more process states) may be extracted from document data 418, such as incident reports pertaining to the one or more process states.

As disclosed herein, the process maps 160 generated by the PM module 124 may comprise assessments of the technical, economic, and/or risk characteristics of respective process states. The process map 160, however, may not accurately model the technical, economic, risk, and/or adoption characteristics of the overall process. For example, the disclosed process maps 160 may not model the probability of respective process states (and/or the time spent in such states) and, as such, may not accurately model the contribution of each process state to the technical, economic, and/or risk characteristics of the processes as implemented within the facility 20. The SM module 126 may be configured to transform high-level process maps 160 generated by the PM module 124 into quantitative stochastic models 170. The stochastic models 170 may be configured for quantitative analysis of process dynamics, as disclosed in further detail herein.

In some implementations, the SM module 126 may be configured to transform process maps 160 into stochastic models 170 comprising a sequence of possible events (e.g., sequence of process states) wherein the probability of each event depends on the state attained in the previous event; the probability of respective process states may be based on state data 540 of the proceeding state. In other words, the next state following a particular state of the process may depend only on the current state of the process, e.g., the state data 540 of the particular process state. The overall technical, economic, and/or risk assessment of a process may be calculated by combining assessments of respective process states per their respective probabilities. By way of non-limiting example, the overall quantitative assessment metrics 190 of a process may be calculated per Eq. 1 below:

$$M = {\sum }_{n = 1}^{N} \frac{{p}_{n} {M}_{n}}{N} \qquad Eq . 1$$

In Eq. 1, M represents metrics 190 of a process comprising N possible events (e.g., N process states), Mn represents the state metrics 290 for respective process states n, and pₙ represents the probability of the respective process states n. By way of further example, the overall technical, economic, and/or risk assessment of a process may be expressed as:

$$Tech = {\sum }_{n = 1}^{N} \frac{{p}_{n} {Tech}_{n}}{N} \qquad Eq . 2$$

$$Econ = {\sum }_{n = 1}^{N} \frac{{p}_{n} {Econ}_{n}}{N}$$

$$Risk = {\sum }_{n = 1}^{N} \frac{{p}_{n} {Risk}_{n}}{N}$$

In Eq. 2, Tech represents the technical metrics 192 of the process and Techₙ represents the PS technical metrics 292 for respective process states n; Econ represents the economic metrics 194 of the process and Econₙ represents the PS economic metrics 294 for respective process states n; Risk represents the risk metrics 196 of the process and Risky represents the PS risk metrics 296 for respective process states n; and so on.

The SM module 126 may be configured to transform process maps 160 into any suitable type of stochastic model 170. In the FIG. 4 example, the SM module 126 may be configured to transform process maps 160 into Markov models, e.g., a Markov chain, Markov process, or the like. The disclosure is not limited in this regard, however, and could be adapted to utilize any suitable type of stochastic model 170 configured to model state transitions using any suitable probability distribution. For example, Markov models may model the time spent in respective process states using an exponential distribution, e.g., per Eq. 4 below. This distribution may not accurately reflect the actual time spent in such states (based on testing, experience, literature, and/or the like). In some implementations, the MC model 126 may be configured to generate stochastic models 170 comprising semi-Markov models using other types of probability distributions and/or probability density functions, including, but not limited to: an absolutely continuous probability distribution, gaussian, normal, chi-squared, uniform, triangular, and/or the like.

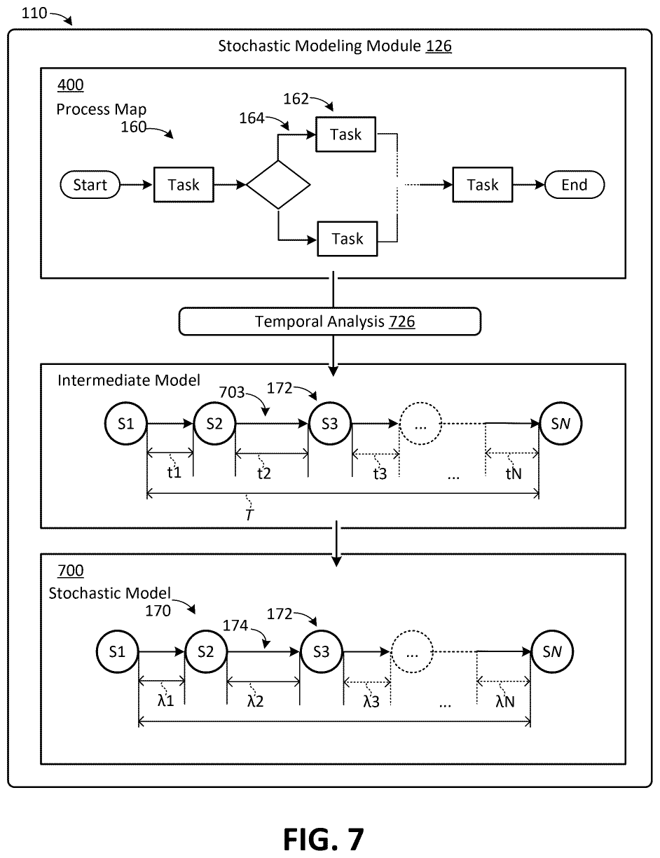

FIG. 7 is a schematic block diagram illustrating an example of an SM module 126 configured to transform process maps 160 into stochastic models 170 comprising Markov chains. The SM module 126 may be configured to transform a process map 160 into a stochastic model 170, e.g., Markov model. As disclosed herein, the process map 160 may comprise and/or be embodied by a graph data structure 400 comprising nodes 162 interconnected by links 164. The nodes 162 may represent respective process states (e.g., tasks) and the links 164 may represent relationships between process states, e.g., state transitions.

The SM module 126 may be configured to convert the process map 160 into an intermediate model comprising quantitative, time-dependent states. In the FIG. 7 example, the process map 160 may be converted into an intermediate model comprising N states (e.g., N process states), each representing a respective stage or condition within the process. The intermedia model may comprise a sequence of SM nodes 702 interconnected by respective temporal links 703. The SM nodes 172 may correspond to nodes 162 of the process map 160. In other words, the SM nodes 172 may be configured to model respective process states. The QS nodes 502 may incorporate information determined for respective states of the process, such as state data 540 and state metrics 290 as illustrated in, inter alia, FIG. 5A. The state data 540 of respective QS nodes 502 may comprise and/or define a process state 542 (e.g., technical state data, economic state data, and risk state data), a decision state 544, a data state 546, and so on. The state metrics 290 may comprise PS technical metrics 292, PS economic metrics 294, PS risk metrics 296, and so on.

The temporal links 703 may be configured to be configured to model the time spent in respective states of the process. In some implementations, the temporal links 703 may model the time spent in respective states using a probability density distribution. In the intermediate model, the total time spent in a process (T) comprising N states may be defined as a sum of time (t) per Eq. 3 below:

$$T = {\sum }_{n = 1}^{N} {t}_{n} \qquad Eq . 3$$

As illustrated in the FIG. 7 example, the SM module 126 may be configured to transform the process map 160 into an intermediate model comprising a time-dependent process by use of, inter alia, a temporal analysis module 726. The temporal analysis module 726 may be configured to estimate the time spent in respective states (SM nodes 172) based, at least in part, on PA data 410 pertaining to the process. For example, the time spent in respective process states may be determined from observation data 412 (e.g., may be based on time measurements acquired during real-time operation of the process in the facility 20), interview data 414 (e.g., may be based on information provided by qualified personnel), questionnaire data 416 (e.g., may be extracted from responses to questionnaires provided to designated personnel), document data 418 (e.g., may be extracted from monitoring data), and/or the like. Alternatively, or in addition, information pertaining to temporal characteristics of the process may be provided and/or revised by users 12 through UI 114 generated by the UI module 112 of the system 100, as disclosed herein.

The SM module 126 may be further configured to convert the intermediate model into a stochastic model 170. In the FIG. 7 example, the SM module 126 may be configured to transform the process map 160 into a stochastic model 170 comprising a Markov chain, Markov process, or the like. The stochastic model 170 may comprise and/or be embodied by a data structure 700. The data structure 700 may comprise SM nodes 172 connected by transition rate (TR) links 704. The TR links 704 may be configured to model transition rates between process states. The SM module 126 may be configured to convert time quantities of the time-dependent intermediate model into TR links 704 (λₙ) per Eq. 4 below:

$${λ}_{n} = \frac{1}{{t}_{n}} \qquad Eq . 4$$

$$\frac{1}{{λ}_{T}} = {\sum }_{n = 1}^{N} \frac{1}{{λ}_{n}}$$

As illustrated above, transition rates of the stochastic model 170 may be inversely proportional to the average time values determined for respective process states.

The probability distribution of Eq. 4 may correspond to a Markov model, e.g., an exponential distribution. The disclosure is not limited in this regard, however, and could be adapted to utilize semi-Markov models comprising any suitable type of probability distribution and/or probability density function, e.g., an absolutely continuous probability distribution, gaussian, normal, chi-squared, uniform, triangular, and/or the like. For example, in some implementations, the SM module 126 may construct stochastic models 170 utilizing an arbitrary, absolutely continuous probability distribution as illustrated in Eq. 5 below:

$$P ( a \leq X \leq b ) = {\int }_{a}^{b} f ( x ) d x \qquad Eq . 5$$

In Eq. 5, X has an absolutely continuous probability distribution per the function ƒ: [symbol] →[0, ∞] such that for each interval I=[a, b]⊂ [symbol] the probability of X belonging to I is given by the integra of ƒ over I. A probability density function may be define such that the probability for X to take any single value a (a≤X≤a) is zero because an integral with coinciding upper and lower limits is always equal to zero. If the interval [a, b] is replaced by any measurable set A, the equality of Eq. 6 holds:

$$P ( X ∈ A ) = {\int }_{A} f ( x ) d x \qquad Eq . 6$$

Referring back to FIG. 4, the QA module 128 may utilize the stochastic model 170 to, inter alia, derive quantitative assessment metrics 190 based, at least in part, on state metrics 290 determined for respective states of the process. As disclosed herein, the quantitative assessment metrics 190 of a process may comprise an objective, quantitative assessment of technical, economic, and/or risk characteristics of a process, e.g., may comprise technical metrics 192, economic metrics 194, risk metrics 196, and so on.

The QA module 128 may generate quantitative assessment metrics 190 by any suitable technique. In the FIG. 4 example, the QA module 128 may be configured to generate quantitative assessment metrics 190 of the BL assessment through steady-state analysis of the stochastic model 170, e.g., Markov model quantification. The steady-state analysis may be configured to model the long-term average behavior of the process when it reaches an equilibrium of transitions between different states. Accordingly, the steady-state analysis may describe the average behavior of the process and, as such, may be used for predicting dynamics and process behavior.

The QA module 128 may be configured to derive quantitative assessment metrics 190 from the stochastic model 170 using any suitable technique including, but not limited to: closed-form analysis, steady-state analysis, Monte Carlo analysis, Markov chain Monte Carlo (MCMC) analysis, and/or the like.

The steady-state analysis may utilize the stochastic model 170 (Markov process) in mathematical computations configured to determine probabilities of the process over an extended period (e.g., may determine probabilities of respective process states, as disclosed herein). The steady-state analysis may further comprise identifying an equilibrium state of the process and the resulting probabilities of residing in each specific process state. The QA module 128 may generate quantitative assessment metrics 190 by combining state metrics 290 determined for respective process states, the state metrics 290 weighted based on the probabilities determined for the respective process states, e.g., the state metrics 290 may be weighted according to the average time predicted for respective states per the steady-state analysis of the stochastic model 170. For example, economic metrics 194, such as the cost associated with the process may be evaluated by multiple costs determined for each process state (e.g., per respective PS economic metrics 294) by the steady-state probabilities determined for each process state (e.g., average percentage of time spent in each process state). The QA module 128 may perform steady-state analysis according to any suitable method or approach, including, but not limited to an iterative method-based steady-state analysis, a sequence iterative method-based steady-state analysis, sinusoidal steady-state analysis, and/or the like. Through the steady-state analysis, an understanding can be developed of equilibrium states and the respective probabilities of the process, which may lead to more informed decisions regarding system design, operational strategies, and performance metrics.

As disclosed herein, once the steady state probabilities are identified, the QA module 128 may determine quantitative assessment metrics 190 based on state metrics 290 of respective process states. For example, the QA module 128 may calculate the cost of the process based on costs determined for respective process states, e.g., may assess the average cost for the process. As disclosed above, in some implementations, the steady-state probabilities may be assumed to be the average time spent in each process state over a long period of time. For example, a process with two states, A and B, and the probability of being in the states at any given time is 0.25 and 0.75, respectively, e.g., per the transition rates determined for states A and B. The QA module 128 may determine the time spent in each state during a given period (e.g., T=1000), per Eq. 7 below:

$${T}_{A} = P ( A ) \times T = 0.25 \times 1000 hrs = 198 hrs \qquad Eq . 7$$

$${T}_{B} = P ( B ) \times T = 0.75 \times 1000 hrs = 750 hrs$$

The economic cost of the process may be calculated based on hourly costs assigned to each state (e.g., per PS economic metrics 294 of states A and B, respectively). For example, of the cost of states A and B are $10/hour and $5/hour, the total cost of the process may be calculated per Eq. 8 below:

$${C}_{total} = \$10 / hr \times 198 hr + \$5 / hr \times 750 = \$ 6198 \qquad Eq . 8$$

Although a specific example of economic metrics 194 are described herein (e.g., process cost), the disclosure is not limited in this regard and could be adapted to calculate any suitable metrics 190 pertaining to any suitable aspect and/or characteristics of a process, e.g., technical metrics 192, risk metrics 196, and so on.

In some implementations, the QA module 128 may be further configured to perform sensitivity analysis operations. As used herein, sensitivity analysis may comprise and/or refer to methods for quantifying how changes in specified parameters affect output variables. In other words, sensitivity analysis may quantify the degree to which respective parameters of the parameter set 250 determined for the process impact the technical, economic, and/or risk assessment of the process, e.g., the degree to which respective parameters impact the quantitative assessment metrics 190 of the process. The sensitivity analysis operations may be further configured to quantify the impact on parameter uncertainty on the quantitative assessment metrics 190. The QA module 128 may utilize the stochastic model 170 to perform sensitivity analysis operations including, but not limited to: perturbation of parameters (e.g., change various target parameters that have been identified as candidates of uncertainty and/or modification by candidate FMD), steady-state analysis (e.g., steady-state probabilities are recalculated with the new parameter combination and updated quantitative assessment metrics 190 such as costs are recorded), and sensitivity calculation (e.g., the updated metrics 190 are compared to the metrics 190 originally determined for the process and normalized by the percentage change in the parameter). Performing sensitivity analysis may enhances decision-makers' ability to quantify uncertainties, optimize parameter configurations, and gain an understanding of the model's behavior under diverse conditions.

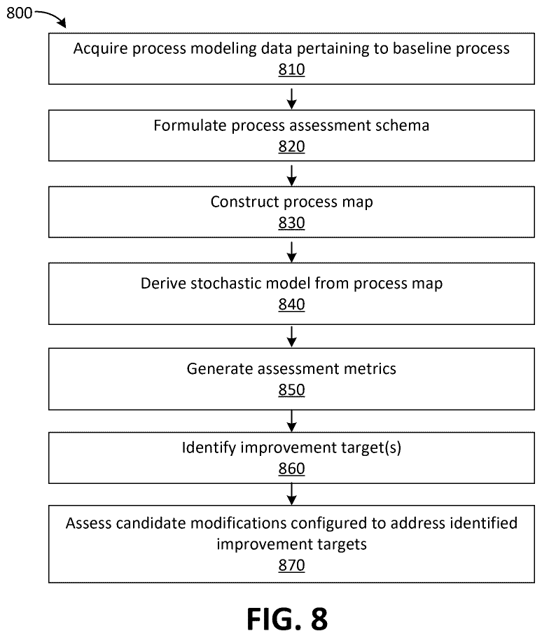

FIG. 8 if a flow diagram illustrating an example of a method 800 for generating an assessment of an existing, BL process of a facility 20. In other words, the method 800 may comprise generating a BL record 220 for a facility BL 215, as disclosed herein.

At 810, the assessment module 120 may be configured to acquire PA data 410 pertaining to the BL process. The PA data 410 may include, but is not limited to, observation data 412, interview data 414, questionnaire data 416, document data 418, and so on. The PA data 410 may be acquired by any suitable means and/or from any suitable source, as disclosed herein.

At 820, the assessment module 120 may be configured to determine an assessment schema 150 for the BL process. As disclosed herein, the assessment schema 150 may comprise a parameter set 250 and assessment logic 260. The parameter set 250 may define parameters configured to describe the technical, economic, and/or risk characteristics of respective process states. For example, the parameter set 250 may define parameters of a process state 542, decision state 544, and/or data state 546 of respective states of the process. The assessment logic 260 may comprise means for deriving state metrics 290 from state data 540 determined for respective states of the process, as disclosed herein.

As disclosed herein, the parameter set 250 determined for the process at 820 may be configured to describe technical, economic, and/or risk characteristics of respective states of the process. In other words, the parameter set 250 may define parameters configured to describe technical characteristics of respective process states, economic costs associated with respective process states (e.g., resources utilized by the process and/or respective process states), risks associated with respective process states, and so on. In some implementations, the PM module 124 may be configured to define the parameter set 250 of the process in accordance with an analysis framework, such as SIPOC, PTPG, or the like. For example, the PM module 124 may define the parameter set 250 to include variables corresponding to SIPOC categories, e.g., suppliers, inputs, processes (tasks), outputs, consumers, and so on. Alternatively, or in addition, the PM module 124 may configure the parameter set 250 to include variables corresponding to one or more other process analysis frameworks, such as PTPG categories of the ION initiative or the like.

Aspects of the assessment schema 150 may be derived from the PA data 410 acquired at 810. For example, the PA data 410 may identify resources utilized by the process, specify costs associated with the identified resources, enumerate risks associated with respective process states, and so on. Alternatively, or in addition, aspects of the assessment schema 150 may be specified by a user 12 through UI 114 generated by the apparatus 101, as disclosed herein.

In some implementations, the assessment module 120 may be further configured to generate BL process metadata 222 and/or evaluation data 240 for the BL process at 820. As disclosed herein, BL process metadata 222 may comprise any suitable information pertaining to a BL process, including but not limited to: identification data, descriptive information, information pertaining to resources utilized by the process, information pertaining to dependencies of the process, information pertaining to inputs utilized within the process and/or sources of such inputs, information pertaining to outputs of the process and/or endpoints or consumers of such outputs, and/or the like. The evaluation data 240 may comprise information pertaining to evaluation of the BL process and/or corresponding candidate processes, which may include, but is not limited to: constraint data 242, objective data 244, and so on. Aspects of the BL process metadata 222 and/or evaluation data 240 may be derived from the PA data 410 acquired at 810. For example, the specification module 122 may be configured to extract constraint data 242 and/or objective data 244 from one or more of the observation data 412, interview data 414, questionnaire data 416, and/or document data 418 acquired at 810. Alternatively, or in addition, aspects of the constraint data 242 may be specified by a user 12 through UI 114 generated by the apparatus 101, as disclosed herein.

Step 830 may comprise constructing a process map 160 for the BL process in accordance with the assessment schema 150 determined at 820. At 830, the PM module 124 may be configured to disassemble the process into a plurality of process states, each configured to represent a respective aspect of the process, e.g., a respective phase, step, task, decision, resource utilization, data/information utilization, and/or the like. Step 830 may comprise disassembling the process in accordance with one or more process analysis frameworks, such as SIPOC, PTPG, or the like. The PM module 124 may be further configured to assign state data 540 to respective process states. As disclosed herein, the state data 540 may comprise a dataset (e.g., parameter values) corresponding to the parameter set 250 determined for the process at 820. The state data 540 assigned to respective process states may be configured to describe the technical, economic, and/or risk characteristics of the respective process states, e.g., may comprise and/or define technical state data, economic state data, risk state data, and so on.

The PM module 124 may be further configured to define relationships between process states. For example, the PM module 124 may be configured to determine decision states 544 for respective process states, the decision states 544 configured to define conditions for entering respective process states (e.g., define links 164-IN), conditions for existing respective process states and/or transitioning to a next state (e.g., define one or more links 164-OUT), and so on. The PM module 124 may be further configured to define decision points of the process, e.g., generate nodes 162 configured to represent decisions, branches, loops, iterations, and/or the like. Accordingly, constructing the stochastic model 170 at 830 may comprise constructing aspects of a decision model, as disclosed herein.

In some implementations, constructing the process map 160 at 830 may further comprise generating a data map of the process, as disclosed herein. The data map may comprise information pertaining to data utilization within the process. For example, the state data 540 of respective nodes 162 of the process map 160 may comprise and/or define a data state 546 of the process states represented thereby. The data states 546 may comprise information pertaining to data utilized in respective process states (e.g., define data inputs of respective process states), sources of such data inputs, data outputs produced in respective states (e.g., define data outputs of respective process states), endpoints of such data outputs, and so on.

The PM module 124 may be configured to record information pertaining to respective process states in a data structure 400 comprising nodes 162 and links 164, the nodes 162 may be configured to represent respective process states 162 and the links 164 may be configured to represent state transitions. Nodes 162 of the process map 160 may comprise state data 540, which may include, inter alia, a process state 542 (e.g., technical state data, economic state data, and risk state data). The nodes 162 may further comprise state metrics 290, which may be derived from the state data 540 in accordance with the assessment logic 260 determined for the process at 820. The state metrics 290 may be configured to objectively quantify technical, economic, and/or risk characteristics of the process, e.g., may comprise PS technical metrics 292, PS economic metrics 294, PS risk metrics 296, and so on.

Step 840 may comprise deriving a quantitative stochastic model 170 for the BL process based, at least in part, on the process map 160 constructed at 830. At 840, the SM module 126 may be configured to transform the process map 160 into a quantitative, stochastic model 170, such as a Markov chain or process, as disclosed in conjunction with FIG. 7. Generating the stochastic model 170 at 840 may comprise a) converting the process map 160 constructed at 830 into an intermediate model comprising a series of SM nodes 172 connected by temporal links 703 and b) transforming the intermediate model into a Markov chain. Generating the stochastic model 170 may comprise assigning transition rate probabilities to respective process states (e.g., SM nodes 172), which may be used to, inter alia, define TR links 704 between the SM nodes 172.

At 850, the QA module 1287 may be configured to generate quantitative assessment metrics 190 for the BL process. The metrics 190 may comprise an objective, quantitative technical, economic, and/or risk assessment of the BL process as a whole, e.g., across all process states. Step 850 may comprise determining technical metrics 192, economic metrics 194, risk metrics 196, and so on. The QA module 128 may be configured to generate quantitative assessment metrics 190 through closed-form analysis of the stochastic model 170, as disclosed herein (e.g., steady state analysis).

At 860, the FMM module 110 may be configured to identify one or more improvement targets within the BL process. The FMM module 110 may be configured to identify improvement targets based on the quantitative assessment metrics 190 determined for the BL process at 850. Alternatively, or in addition, one or more improvement targets may be identified based on state metrics 290 assigned to respective process states at 830. In some implementations, step 860 may comprise identifying improvement targets configured to address one or more technical deficiencies of the BL process and/or facility 20, e.g., may be configured to comply with modernization guidelines, as disclosed herein.

In some implementations, the FMM module 110 may be configured to identify improvement during one or more of steps 810-850. By way of non-limiting example, improvement targets may be identified during the acquisition of PA data 410 at 810; improvement targets within the BL process may be identified during the acquisition of observation data 412 (e.g., while observing real-time operation of the BL process), during the acquisition of interview data 414 (e.g., improvement targets may be identified during interviews with qualified personnel), during the acquisition of questionnaire data 416 (e.g., improvement targets may be specified in responses to questionnaires directed to designated personnel), during the acquisition of document data 418 (e.g., improvement targets may be identified in incident report documents, performance review documents, and/or the like), and so on.

Alternatively, or in addition, improvement targets may be identified during construction of the assessment schema 150 and/or process map 160 at steps 820-830. For example, improvement targets may be identified while determining state metrics 290 for respective process states, e.g., states exhibiting unfavorable state metrics 290 may be identified as potential improvement targets.

In some implementations, improvement targets may be identified during derivation of the stochastic model 170 and/or while generating quantitative assessment metrics 190 for the BL process at steps 840-850. For example, process states having high probabilities and/or having a significant impact on the overall metrics 190 of the BL process may be identified as potential improvement targets.

Step 870 may comprise assessing candidate FMD configured to address the improvement targets identified at 860, as disclosed in further detail herein.

In some implementations, step 870 may comprise developing a candidate pool 125 comprising candidate processes configured to address the improvement targets identified at 860. The candidate processes may be configured to modify respective BL processes, such as the BL process assessed at steps 810 through 860. Information pertaining to each candidate process of the candidate pool 125 may be maintained within a respective candidate record 230.

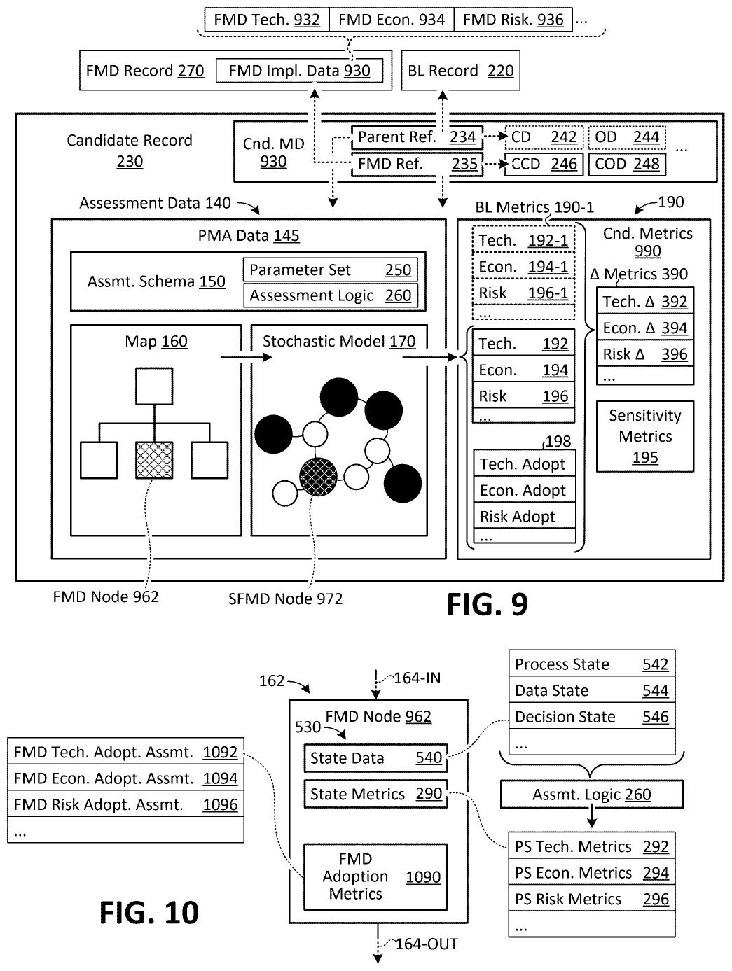

FIG. 9 is a schematic block diagram illustrating an example of a candidate record 230. As disclosed herein, the candidate record 230 may comprise information pertaining to a candidate process configured to modify an existing, BL process of the facility 20. In other words, each candidate record 230 may comprise and/or incorporate a respective set of one or more candidate FMD.

The candidate record 230 illustrated in the FIG. 9 example may comprise candidate metadata 232. Candidate metadata 232 may comprise any suitable information pertaining to a candidate process (and/or corresponding candidate FMD), e.g., naming information, descriptive information, and so on. As illustrated in FIG. 9, candidate metadata 232 may comprise a parent reference 234 which may be configured to associate the candidate process represented by the candidate record 230 with a parent BL. As disclosed herein, the parent of a candidate process may comprise and/or refer to the BL process to be altered, improved, updated, replaced, obviated, and/or otherwise modified by the candidate process (if any). In the FIG. 9 example, the parent reference 234 may be configured to associate the candidate record 230 with a parent BL record 210 of the candidate process, e.g., may comprise a name, DN, address, identifier, unique identifier, GUID, URI, URL, database reference, key, primary key, foreign key, pointer, and/or the like.

As disclosed herein, candidate processes may comprise and/or incorporate one or more FMD (e.g., candidate FMD). In some implementations, candidate records 230 may further comprise a FMD reference 235, which may comprise suitable means for associating the candidate record 230 with FMD record(s) 270 corresponding to candidate FMD utilized by the candidate process, e.g., may comprise a name, DN, address, identifier, unique identifier, GUID, URI, URL, database reference, key, primary key, foreign key, pointer, and/or the like.

FMD records 270 may comprise information pertaining to technological solutions available for implementation at the facility 20. FMD 270 records may, for example, comprise information pertaining to the technical, economic, risk, and/or adoption characteristics of respective candidate FMD.

FMD records 270 may further comprise FMD implementation data 930. As used herein, FMD implementation data 990 may comprise and/or refer to any suitable information pertaining to the implementation, deployment, and/or adoption of an FMD at a facility 20 and may include but are not limited to: FMD technical data 932, FMD economic data 934, FMD risk data 936, and so on. FMD technical data 932 may comprise information pertaining to risks associated with technological aspects of the candidate FMD such as technology readiness, technology feasibility, technology performance and maintenance, scalability, security, cyber security, and so on. FMD economic data 932 may comprise information pertaining to costs associated with implementation of the candidate FMD such as capital costs (e.g., costs for hardware acquisition, infrastructure modifications, installation costs, software licensing, and so on), costs associated with the design, development, and deployment of the candidate FMD (e.g., training, labor, and so on), regulatory costs, and/or the like. FMD risk data 936 may comprise information pertaining to risks associated with implementation of the candidate FMD, such as risks to personnel, SSC consequences, facility safety, and so on. In some implementations, the FMD implementation data 930 may comprise high-level, generalized information that may be refined for use in specific scenarios and/or within specific facilities 20.

The candidate metadata 232 may further comprise information pertaining to requirements and/or objectives of the candidate process. As illustrated in FIG. 9, the candidate metadata 232 may comprise constraint data (CD) 242 and objective data (OD) 244. As disclosed herein, constraint data 242 may specify requirements and/or constraints of the candidate process and the objective data 244 may define potential improvement targets pertaining to the candidate process and/or facility 20. In some implementations, the constraint data 242 and/or objective data 244 of a candidate process may comprise and/or be based on constraint data 242 and/or objective data 244 of the parent thereof, e.g., may reference and/or incorporate constraint data 242 and/or objective data 244 of the BL record 210 linked to the candidate record 230, which may ensure that the candidate process satisfies the requirements and/or constraints of the parent BL process (and aligns with high-level objectives of the facility 20).

As disclosed herein, constraint data 242 may define the requirements and/or constraints that the candidate process may be required to satisfy and objective data 244 may specify improvement targets related to the technical, economic, and/or risk characteristics of the BL process and/or facility 20.

In some implementations, candidate records 230 may further comprise candidate evaluation data 245, which may comprise candidate constraint data (CCD) 246 and/or candidate objective data (COD) 248. The candidate constraint data 246 of a candidate process may be configured to indicate the degree to which the candidate process satisfies the requirements and/or constraints of the corresponding BL process (e.g., as defined by constraint data 244 associated with the process). The candidate constraint data 246 of a candidate process may be determined by, inter alia, comparing the technical functionality, performance, and/or other characteristics of the candidate process (and/or candidate FMD thereof) to technical requirements and/or constraints of the parent process (e.g., constraint data 242 of the BL process). Information pertaining to the technical characteristics of the FMD utilized within a candidate process may be retrieved from FMD records 270 of an FMD DS 190, as disclosed in further detail herein.

The candidate objective data 248 of a candidate process may be configured to indicate the degree to which the candidate process aligns with objectives of the parent BL process and/or facility 20. As disclosed herein, objectives pertaining to the BL process (and/or facility 20 as a whole) may be recorded within objective data 244. The objective data 244 may define high-level modernization objectives for the facility 20 (and/or specified BL processes). The objective data 244 may be based on and/or derived from industry guidelines, regulations, or roadmaps (e.g., ION initiative, PMP for LWRS program, and/or the like). For example, the objective data 244 may define goals for the facility 20 related to, inter alia, safety, efficiency, reliability, reduced downtime, or the like. The objective data 244 may correspond to high-level organizational objectives, low-level individual performance objectives (e.g., objectives related to specific BL processes), or the like. Determining candidate objective data 248 for a candidate process may comprise evaluating a degree to which the candidate process (and/or candidate FMD thereof) aligns with improvement goals of the facility 20, e.g., as defined in the objective data 244.

The assessment data determined for a candidate process may comprise, inter alia, PMA data 145 and quantitative assessment metrics 190. The PMA data 145 determined for a candidate process may comprise an assessment schema 150, process map 160, and quantitative stochastic model 170. Aspects of the assessment schema 150 may be imported from the parent of the candidate process, e.g., from the BL record 210 accessed through the parent reference 234. In some implementations, the assessment schema 150 may be further configured to incorporate the parameter set 250 and/or assessment logic 260 determined for the BL process such that candidate process may be assessed based on the same variables and/or quantitative assessment metrics 190 as the parent thereof.

The PMA data 145 may further comprise a process map 160 and stochastic model 170. The process map 160 may comprise nodes 162 configured to represent respective process states and links 164 configured to represent relationships between such states, e.g., state transitions. As illustrated in the FIG. 9 example, the process map 160 of a candidate process may comprise one or more FMD nodes 962. As used herein, an FMD node 962 may comprise and/or refer to a node 162 of a process map 160 configured to represent a candidate FMD (e.g., an FMD of a candidate process). In other words, FMD nodes 962 may be configured to represent process states corresponding to candidate FMD, e.g., may represent states of a BL process to be modified and/or replaced by respective candidate FMD.

The PMA data 145 may further comprise a stochastic model 170, which may be derived from the process map 160. Stochastic models 170 of candidate processes may be generated by, inter alia, transforming process maps 160 into stochastic models such as Markov models, Markov chains or the like, as disclosed herein. As illustrated in the FIG. 9 example, the stochastic model 170 of a candidate process may comprise one or more stochastic FMD nodes 972. As used herein, a stochastic FMD (SFMD) node 972 may comprise and/or refer to an SM node 172 that is configured to represent and/or model a candidate FMD; SFMD nodes 972 of the stochastic model 170 may correspond to FMD nodes 962 of the process map 160.

The assessment data 140 may further comprise quantitative assessment metrics 190. The quantitative assessment metrics 190 determined for a candidate process may comprise and/or be referred to as candidate metrics 990. Aspects of the candidate metrics 990 may be based on and/or derived from the PMA data 145 determined for the candidate process, as disclosed herein, e.g., may be determined through, inter alia, analysis of the stochastic model 170 of the candidate process. The candidate metrics 990 may comprise technical metrics 192, economic metrics 194, and risk metrics 196 comprising quantitative assessments of technical, economic, and/or risk characteristics of the candidate process. Candidate metrics 990 may further comprise adoption metrics 198 and/or delta metrics 390, as disclosed in further detail herein.

FIG. 10 illustrates an example of an FMD node 962. As disclosed herein, the FMD node 962 may comprise a node 162 configured to represent and/or model a candidate FMD within a process map 160 of a candidate process. In other words, FMD nodes 962 may be configured to represent candidate FMD and/or process states corresponding to respective candidate FMD; an FMD node 962 may be configured to represent a replacement for and/or modification to a specified aspect of a BL process, e.g., may represent modification and/or replacement of one or more process phases, steps, tasks, operations, subprocesses, and/or the like. For example, an FMD node 962 may be configured to represent a new technological solution configured to implement one or more steps of a BL process, e.g., a technological solution to automate a manual process or the like.

As illustrated in the FIG. 10 example, FMD nodes 962 may comprise state data 540 and state metrics 290. The state data 540 and state metrics 290 may be configured to assess the technical, economic, and/or risk characteristics of the candidate process. The assessment module 120 may be configured to generate state data 540 and state metrics 290 for FMD nodes 962, as disclosed herein. The state data 540 and corresponding state metrics 290 of an FMD node 920 be configured to model the impact of successful implementation of the candidate process (and/or candidate FMD thereof) within the facility 20. In other words, the state data 540 and corresponding state metrics 290 of the FMD nodes 962 of a candidate process (and the corresponding SFMD nodes 972) may be configured to model operation of the candidate process within the facility 20. Accordingly, quantitative assessment metrics 190 of the candidate process, such as technical metrics 192, economic metrics 194, and risk metrics 196 may be determined through, inter alia, steady state analysis of the stochastic model 170, as disclosed herein.

As illustrated in FIG. 9, the quantitative assessment metrics 190 determined for the candidate process may comprise, inter alia, adoption metrics 198. As used herein, adoption metrics 198 may comprise and/or refer to quantitative data configured to assess the technical, economic, and/or risk implications of adoption of a candidate process within the facility 20. Adoption metrics 198 may be configured to assess any aspect pertaining to the design, procurement, and/or implementation of a candidate process within the facility 20 including, but not limited to: technical adoption metrics configured to assess the technical aspects associated with implementation of the candidate process (e.g., technical risk), economic adoption metrics configured to assess economic costs associated with implementation of the candidate process, risk adoption metrics configured to assess risks associated with implementation of the candidate process, and so on.

As disclosed herein, a candidate process may comprise and/or incorporate one or more candidate FMD. Accordingly, the adoption metrics 198 of a candidate process may comprise and/or be derived from implementation assessments determined for respective candidate FMD utilized therein. For example, the economic cost to implement a candidate process within the facility 20 may comprise a sum of economic costs determined for the FMD utilized by the candidate process. Assessing adoption metrics 198 of a candidate process may comprise determining FMD adoption metrics 1090 for respective FMD of the candidate process and combining the FMD adoption metrics 1090 into adoption metrics 198 covering implementation of the candidate process as a whole. As used herein, an FMD metrics 1090 may comprise and/or refer to data configured to describe technical, economic, and/or risk implications associated with the design, procurement, and/or implementation of candidate FMD within a facility 20, e.g., may be configured to assess the implications of respective FMD of a candidate process.

FIG. 10 illustrates an example of FMD adoption metrics 1090 determined for a candidate FMD. As disclosed herein, the FMD nodes 962 of a candidate process may comprise respective FMD adoption metrics 1090, e.g., the FMD adoption metrics 1090 may comprise assessments of respective technological solutions utilized within the candidate process. As illustrated in the FIG. 10 example, aspects of the FMDA adoption metrics 1090 determined for a candidate FMD may be recorded within the FMD node 962 thereof. The FMD adoption metrics 1090 determined for a candidate FMD may comprise, inter alia, an FMD technical adoption assessment (TAA) 1052, an FMD economic adoption assessment (EAA) 1094, an FMD risk adoption assessment (RAA) 1096, and so on. As disclosed in further detail herein, the FMD TAA 1052 may comprise information pertaining to the technical risks associated with implementation of the candidate FMD and may be based, at least in part, on FMD technical data 932 of the candidate FMD; the FMD EAA 1094 may be configured to quantify economic costs associated with implementation of the candidate FMD within the facility 20 and may be based, at least in part, on FMD economic data 934 of the candidate FMD; the FMD RAA 1096 may be configured to quantify risk associated with implementation of the candidate FMD within the facility 20 and may be based, at least in part, on FMD risk data 936 of the candidate FMD.

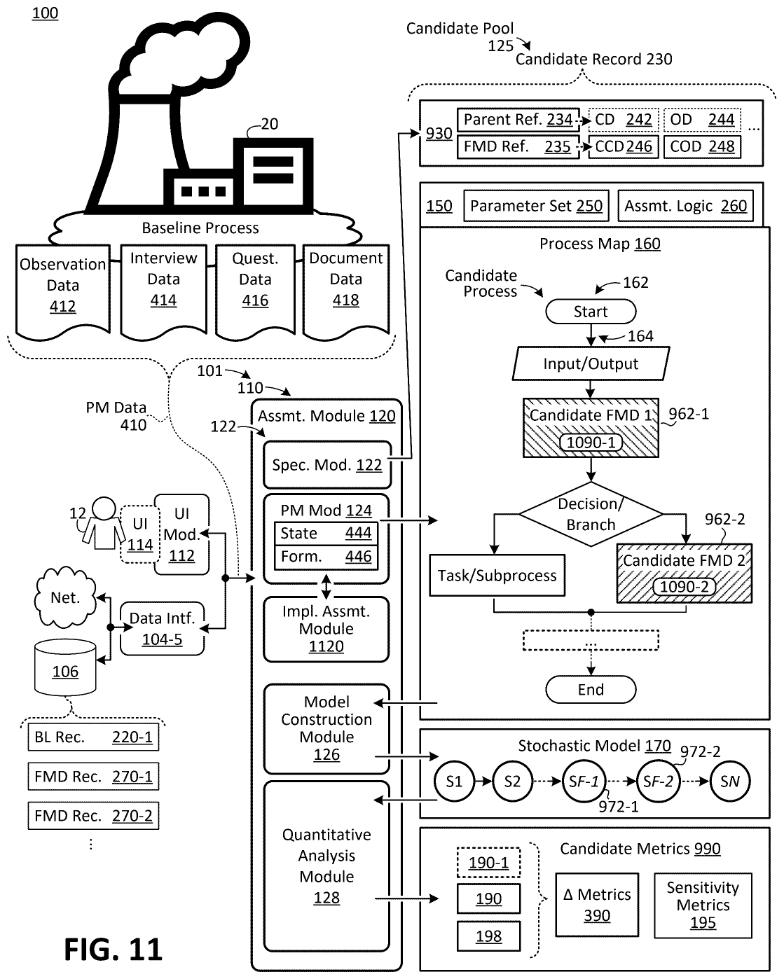

FIG. 11 is a schematic block diagram illustrating an example of an assessment module 120 configured to generate technical, economic, and/or risk assessments of candidate processes of a facility 20. In the FIG. 11 example, the assessment module 120 may be configured to assess a candidate process configured to modify and/or replace a parent, BL process of the facility 20.

As illustrated in FIG. 11, the assessment module 120 may comprise a specification module 122, which may be configured to generate aspects of the candidate metadata 232, as disclosed herein. In some implementations, aspects of the constraint data 242 and/or objective data 244 may be imported from a parent of the candidate process, e.g., may be accessed through and/or by use of the parent reference 234. As disclosed herein, the constraint data 242 may define requirements and/or constraints of the candidate process. Aspects of the constraint data 242 may be imported from the parent BL process. Alternatively, or in addition, the constraint data 242 may define additional requirements and/or constraints of the candidate process. For example, the constraint data 242 may require the candidate process to satisfy improved accuracy thresholds, provide additional technical functionality, and/or the like.

As disclosed herein, the objective data 244 may comprise information pertaining to objectives for modifications pertaining to the parent BL process and/or facility 20, e.g., information pertaining to potential improvement targets related to the facility 20, such as safety improvements, efficiency targets, modernization goals, and/or the like. Aspects of the objective data 244 may be imported from the facility DS 210, BL record 210 of the parent BL process, and/or the like.

The specification module 122 may be further determine a technical and/or objective assessment of the candidate process. The alignment module 422 may be configured to determine candidate constraint data 246 for the candidate process, which may indicate a degree to which the candidate process satisfies the requirements and/or constraints defined for the process, e.g., per the constraint data 242. As disclosed herein, effective problem-solving within the technical domain relies heavily on well-defined requirements and a thorough understanding of existing challenges. The FMM module 110 may utilize the constraint data 242 defined for respective BL processes to design candidate processes that satisfy the technical requirements and/or constraints thereof, e.g., satisfy constraint data 242 defined for respective processes, align with specified objective data 244, and so on. As disclosed herein, the constraint data 242 may define requirements and/or constraints developed through analysis of the functional requirements of respective facility processes. The specification module 122 may evaluate the technical characteristics of candidate processes to ensure that the candidate processes meet the functional capabilities, performance standards, requirements, governance, and constraints of corresponding BL processes. In the FIG. 11 example, the candidate constraint data 246 determined by the specification module 122 may indicate a degree to which the technological functionality of the candidate process satisfies the technological requirements and/or constraints of the constraint data 242. The specification module 122 may generate the candidate constraint data 246 by, inter alia, comparing requirements and/or constraints of the constraint data 242 to technical characteristics of the candidate process (and/or candidate FMD thereof).

The specification module 122 may be further configured to assess the degree to which candidate processes align with objective data 244. As disclosed herein, objective data 244 may define goals pertaining to the facility 20 and/or specified BL processes related to, inter alia, safety, efficiency, reliability, reduced downtime, or the like. The candidate objective data 248 may indicate a degree to which technical characteristics of the candidate process (and/or candidate FMD thereof) align with and/or promote goals defined by the objective data 244. For example, the objective data 244 may define goals related to the automation of error-prone manual tasks and the candidate objective data 248 may indicate a degree to which the candidate process replaces and/or automates such manual tasks.

The PM module 124 may be configured to construct a process map 160 of the candidate process. The process map 160 of the candidate process illustrated in the FIG. 11 example may comprise FMD nodes 962-1 and 962-2 configured to represent respective candidate FMD, e.g., candidate FMD 1 and candidate FMD 2. The PM module 124 may be configured to assign state data 540 and state metrics 290 to nodes 162 of the process map 160, including FMD nodes 962-1 and 962-2, as disclosed herein. The state data 540 and state metrics 290 may be configured to model operation of the candidate process following successful implementation and/or deployment within the facility 20.

The assessment module 120 may further comprise an implementation assessment (IA) module 1120, which may be configured to assess the technical, economic, and/or risk implications associated with implementation of respective candidate FMD within the facility 20. Referring back to FIG. 10, the FMD nodes 962 generated by the PM module 124 may comprise respective FMD adoption metrics 1090. The FMD adoption metrics 1090 of an FMD node 962 may comprise an objective, quantitative assessment of the technical, economic, and/or risk implications associated with implementation of the candidate FMD represented by the FMD node 962. As illustrated in FIG. 10, the FMD adoption metrics 1090 determined for a candidate FMD may comprise, inter alia, an FMD TAA 1052, FMD EAA 1094, FMD RAA 1096, and so on.

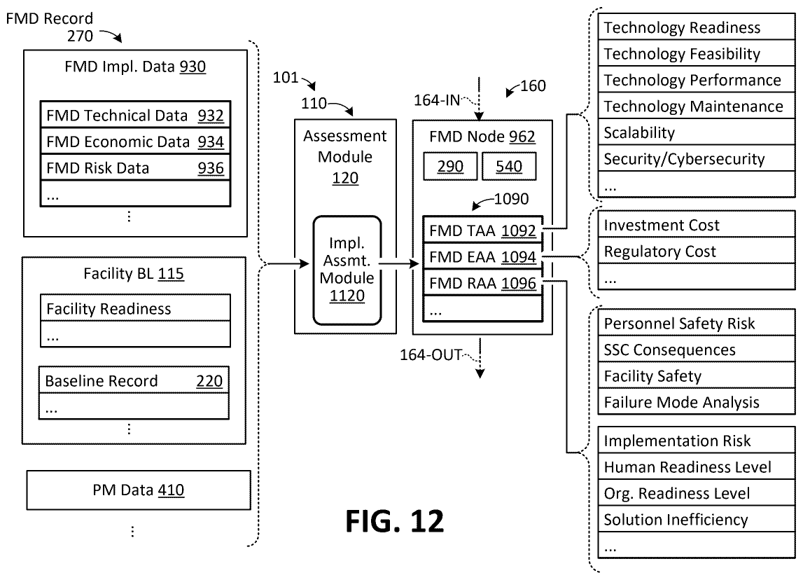

FIG. 12 is a schematic block diagram illustrating an example of an IA module 1120 configured to determine an FMD adoption metrics 1090 for a candidate FMD of a candidate processes. As illustrated in FIG. 12, the FMD adoption metrics 1090 may be based on and/or derived from technical, economic, and/or risk characteristics of the candidate FMD, facility 20, PM data 410 pertaining to the process and/or the like. Information pertaining to the technical, economic, and/or risk characteristics of the FMD may be retrieved from non-transitory storage, such as a datastore, FMD record 270 of an FMD DS 190, and/or the like. As disclosed herein, the FMD record 270 associated with a candidate FMD may comprise generalized information pertaining to the FMD such as FMD technical data 932, FMD economic data 934, FMD risk data 936, and so on.

The IA module 1120 may be configured to determine a technical assessment of candidate FMD, e.g., determine an FMD TAA 1052. The FMD TAA 1052 may be configured to assess any suitable aspect of the technological functionality and/or technology-related risk associated with implementation of the candidate FMD within the facility 20 including, but not limited to: technology readiness, technology feasibility, technology performance and maintenance, scalability, security, cybersecurity, and/or the like.

The technology readiness of a candidate FMD may be configured to indicate a degree to which the technology and/or technological solution of the FMD is suitable for deployment within the facility 20, e.g., technology readiness for use within a particular industry such as an NPP. Although emerging technologies are becoming increasingly available for use in industrial settings, not all technologies have been rigorously tested in all operating conditions. However, promising technologies should not be ignored solely because they are new. The IA module 1120 may be configured to determine a Technology Readiness Level (TRL) of candidate FMD, which may be utilized to evaluate potential risks associated with implementing newer technologies into existing processes of the facility 20. The TRL may be based on and/or derived from an industry standard, testing organization, regulatory agency, and/or the like. Using the TRL of candidate FMD, the risk of successfully implementing a candidate process can be quantified as an inverse correlation with the TRL. Also, there may be less risk associated with the implementation of lower TRL technologies into existing systems compared to higher TRL technologies. For example, developing a custom software solution for a small problem with low complexity can be easier and cheaper than trying to customize a large enterprise software to solve a small problem. The TRL of a candidate FMD may be based on the TRL of technological solution(s) comprising the candidate FMD, technology readiness level of the facility 20, and/or the like.

The FMD TAA 1052 may be further configured to assess the technical feasibility of the candidate FMD. The technical feasibility of a candidate FMD may indicate the degree to which the technological solution(s) of the candidate FMD are capable of interfacing with existing systems and/or processes of the facility 20. As disclosed herein, replacing existing processes may result in difficult and complex requirements. The degree of difficulty when implementing a new technology can be a result of incompatibility with existing infrastructure, incoming data, and so on. It may not be possible to integrate some technologies into legacy systems using existing methods. Technical uncertainties can arise due to the interaction between candidate FMD and dependent or connected systems. As a result, candidate FMD can cause unpredictable interactions, unintended consequences, and failures between interconnected systems. The FMD TAA 1052 determined by the IA module 1120 may be configured to indicate the degree of difficulty involved in incorporating technologies of the candidate FMD into the facility 20 and/or identify potential incompatibilities between candidate FMD and existing systems.

The FMD TAA 1052 determined by the IA module 1120 may be further configured to evaluate candidate FMD within a regulatory framework of the facility 20. The IA module 1120 may screen candidate FMD comprising technologies that may interfere with regulatory restrictions and/or may require approval under regulatory guidance, e.g., the FMD TAA 1052 may enumerate potential regulatory risks of respective candidate FMD.

The FMD TAA 1052 determined by the IA module 1120 may be further configured to evaluate performance and maintenance characteristics of respective candidate FMD. Beyond initial implementation, the ongoing performance and maintenance of a technology are critical aspects of risk assessment. The attainment of sufficient performance, particularly for complex technologies, can pose challenges, and success is not guaranteed. Furthermore, the performance of a technological solution may degrade over time, especially if the input data source thereof diverges from the initial training distribution. The IA module 1120 may identify the need for ongoing maintenance and upkeep to adapt to changing demands, ensuring sustained performance and minimizing the risk of obsolescence and record such information within the FMD TAA 1052 of the candidate FMD.

The FMD TAA 1052 determined by the IA module 1120 may be further configured to evaluate the scalability of candidate FMD. Scaling a technology for implementation within the intricate framework of a facility 20 such as a NPP may introduce multiple challenges. Candidate FMD may be required to address safety concerns under critical conditions, improve operational efficiency, successfully manage modular implementation, consider resource requirements, ensure adaptability to future needs, and seamlessly integrate with interconnected systems to prevent disruptions and conflicts. Additionally, a particular technology may perform well in some implementations but may not scale to larger deployments spanning multiple integrated systems. The FMD TAA 1052 may indicate a degree to which candidate FMD can be scaled to cover larger deployments and/or resources required to maintain performance in such deployments.

The FMD TAA 1052 determined by the IA module 1120 may be further configured to evaluate security aspects of candidate FMD, including cybersecurity. The technological solutions of a candidate FMD may be configured to integrate systems and/or form new information pathways, which may expose cybersecurity vulnerabilities of the facility 20, create potential data breaches, result in non-compliance with cybersecurity regulations, and so on. Non-compliance with stringent cybersecurity regulations can result in legal consequences and reputational damage. The IA module 1120 may perform an assessment of the cybersecurity implications of candidate FMD (and record such information in the FMD TAA 1052), ensuring that modifications to the facility 20 align with robust security measures.

Although examples FMD TAA 1052 are described herein, the disclosure is not limited in this regard and could be adapted to evaluate any suitable risk and/or uncertainty arising for implementation of a new technology (e.g., candidate FMD) within a facility 20.

The IA module 1120 may be further configured to determine an economic assessment of respective candidate FMD, e.g., determine an FMD EAA 1094. The FMD EAA 1094 of a candidate FMD may be configured to assess any suitable aspect of the economic impact involved in implementation and/or deployment of the FMD within the facility 20. The FMD EAA 1094 may be configured to quantify associated with candidate FMD, which may include technology investment costs, regulatory costs, and so on. Technology investment cost of a candidate FMD may be configured to quantify the economic investment required to implement the candidate FMD within the facility 20. The technology investment cost of a candidate FMD may enumerate costs involved in implementing technological solutions of the candidate FMD within the facility 20 including but not limited to: costs associated with the design, development, deployment, and management of the technological solutions. The IA module 1120 may break down these costs into categories or deployment phases such as capital expenditures (e.g., hardware acquisition, infrastructure modifications, installation costs, and so on), training, labor, and so on.

The FMD EAA 1094 determined by the IA module 1120 may be further configured to quantify regulatory costs associated with candidate FMD. In heavily regulated industries, such as the nuclear industry, the costs associated with regulatory requirements, documentation, and/or design change requests can be significant. While regulatory costs may not have an impact on every project, identifying any necessary regulatory costs that may be incurred during technology integration will ensure economic viability of the proposed solution.

The FMD EAA 1094 determined by the IA module 1120 may be further configured to model economic risk associated with the implementation of respective candidate FMD. The IA module 1120 may be configured to assess cost uncertainty, performance uncertainty, economic model uncertainty, and so on. The cost uncertainty determined by the IA module 1120 may be configured to indicate to a degree to which the economic costs associated with implementation of a candidate FMD may be unknown or subject to change. For example, the cost of a project may not be known in its entirety before the start. It is not uncommon to experience cost overruns, changes in expenses, or change orders that may arise during the implementation. However, the cost uncertainty of these projects can be quantified, and their effects estimated from historical costs of related projects.

The performance uncertainty determined by the IA module 1120 may be configured to indicate a confidence in the technical performance assessment of the candidate FMD. One of the major areas of uncertainty in a new project is the actual realized returns after implementation. The returns can be affected by several factors, but most notable is the as-deployed performance of the new technology. If there are scalability, deployment, or degradation issues with the technology, the initial return on investment estimates may not hold true. By adding uncertainty to the expected performance, the return on investment can be better understood with the impacts of model and performance uncertainty.

The IA module 1120 may be further configured to determine a risk assessment of respective candidate FMD, e.g., determine an FMD RAA 1096. The use of new technologies within a facility 20 may influence reliability and safety, e.g., may change the frequency and/or severity of consequential events. The risk assessments performed by the IA module 1120 may be configured to identify and evaluate potential consequences associated with the implementation of candidate FMD. Furthermore, candidate FMD may be evaluated for any impact to the risk and safety profile of the facility 20. For example, if a proposed solution impacts the reliability of a component, the impact to safety will be evaluated for an increase or decrease in related risk. The FMM module 120 may utilize FMD FAA 1096 determined by the IA module 1120 to, inter alia, evaluate candidate FMD and develop risk mitigation and contingency plans to address potential challenges. This may be accomplished through risk identification, risk analysis, and risk mitigation planning. The FMD RAA 1096 determined for the candidate FMD of a candidate process may comprise an analysis of any uncertainties in implementing the candidate process, due to technical, economic, and/or safety risk. The FMD RAA 1096 may be configured to assess any suitable risk associated with implementation of candidate FMD within the facility 20; the FMD RAA 1096 determined for a candidate FMD may include but is not limited to information pertaining to personal safety risk, SSC consequences, plant safety risk, failure mode analysis, implementation risk, and so on.

The FMD RAA 1096 determined by the FMA assessment module 1120 may be configured to evaluate personnel safety risk posed by candidate FMD. In some implementations, the personnel safety risk of a candidate FMD may preclude the candidate FMD from implementation within the facility 20. For example, a particular candidate FMD may impact the likelihood and/or frequency of Occupational Safety and Health Administration (OSHA) events at the facility 20. While such events may have a direct impact on economic costs, these events may also have larger regulatory or industry consequences. As such, it may be important to evaluate potential changes to personnel safety resulting from implementation of candidate FMD (either qualitatively or quantitatively).

The FMD RAA 1096 determined by the IA module 1120 may be further configured to evaluate potential SSC consequences of candidate FMD. Candidate FMD may aid operators and facility personnel with decision recommendations regarding the well-being and performance of the facility SSC. However, some candidate FMD may result in unintended system consequences, which may manifest itself through suboptimal recommendations, unintended consequences during technology integration, and so on. As such, the IA module 1120 may be configured to model the integration of new technologies within the facility 20 and to quantify the probability of SSC consequences resulting from such integration.

The FMD RAA 1096 determined by the IA module 1120 may be further configured to evaluate the impact of candidate FMD on facility safety. As candidate FMD expands into safety-related systems, there could be changes in overall facility safety parameters, such as core damage frequency (CDF), large early release frequency (LERF), or the like. The IA module 1120 may be configured to analyze the impact of technologies utilized in respective candidate CMD on such risk metrics (e.g., CDF, LERF and so on). For example, transitioning from analog instrumentation and control systems is generally understood as an improvement to facility safety. However, digital systems may introduce unique risks associated with potential software failures that necessitate a detailed analysis of facility safety.

The FMD RAA 1096 determined by the IA module 1120 may further comprise information pertaining to failure mode analysis determined for respective candidate FMD. Candidate FMD may introduce new failure modes to the facility 20, e.g., software failures in digital systems, novel operator action, and/or the like. The IA module 1120 may be configured to identify and evaluate potential failure modes. The IA module 1120 may utilize any suitable failure mode analysis technique including, for example, failure modes and effect analyses (FMEA).

The FMD RAA 1096 determined by the IA module 1120 may be further configured to evaluate the implementation risk associated with respective candidate FMD. The FMD RAA 1096 determined for a candidate FMD may be configured to evaluate, inter alia, human readiness level, organizational readiness level, solution inefficiencies, and so on. As used herein, a Human Readiness Level (HRL) may comprise and/or refer to an assessment configured to gauge the risk associated with human aspects of the implementation of a candidate FMD and/or effects from human-technology interaction. The HRL may provide an assessment of the preparedness of individuals involved in the implementation and/or use of the candidate FMD. The HRL determined for a candidate FMD may encompass factors such as training, skill acquisition, and adaptability to change. Assessing the impact of HRL on candidate FMD (and/or the overall candidate process) may enable evaluation from a human perspective, sources of risks and uncertainties, and devising methods to mitigate these risks. As used herein, Organizational Readiness Level (ORL) may comprise and/or refer to an assessment of the technological readiness from an organizational perspective, e.g., may align with the HRL but on a broader scale. An ORL may be configured to gauge the overall readiness of an organization to adopt new processes and technologies. The ORL assessment may be based on organizational perspectives such as management support, cultural alignment, resource availability for implementing change, and so on. An ORL assessment may define implementation success criteria such as KPIs, which may be used to objectively assess organizational preparedness for the implementation of novel practices. As part of this ORL evaluation, risks and uncertainties are defined and mitigating strategies can be developed. The result is an understanding of how organizational readiness can impact success. Information pertaining to the HRL and/or ORL for respective candidate FMD may be maintained within a facility DS 210, as disclosed herein. For example, the facility DS 210 may comprise information pertaining to the HRL of facility personnel, groups within the organization, the organization as a whole (e.g. an ORL determined for the organization), and so on.

The FMD RAA 1096 determined for candidate FMD by the IA module 1120 may further comprise information pertaining to solution inefficiencies. As used herein, a solution inefficiency may comprise and/or refer to an adoption rate of a new technology or process. For example, the benefits of new technological solutions may require additional user interaction, e.g., may require additional user input or the like. In some cases, the new technologies may require users to add more information or enter details about an already simple task in the promise of better tracking or resolution. However, this can lead to users ignoring the extra tasks, resulting in the failed implementation of new capabilities. The FMD RAA 1096 determined for a candidate FMD may be configured to identify and mitigate these types of solution inefficiencies.

Referring back to FIG. 11, the process map 160 generated by the PM module 124 may be configured to represent a candidate process comprising two candidate FMD including candidate FMD 1 represented by FMD node 962-1 and candidate FMD 2 represented by FMD node 962-2. Nodes 162 of the process map 160, including FMD nodes 962-1 and 962-2, may comprise respective state data 540 and state metrics 290. The SM module 126 may be configured to convert the process map 160 into a quantitative stochastic model 170, as disclosed herein. The stochastic model 170 may comprise a plurality of quantitative nodes 702, including quantitative nodes 702 configured to represent respective candidate FMD, e.g., SFMD node 972-1 configured to model candidate FMD 1 and SFMD node 972-2 configured to model candidate FMD 2.

The QA module 128 may be configured to determine quantitative assessment metrics 190 for candidate processes. The quantitative assessment metrics 190 determined for candidate processes may include but are not limited to: technical metrics 192 configured to assess technical characteristics of the candidate process, economic metrics 194 configured to assess economic characteristics of the candidate process, and risk metrics 196 configured to assess safety and/or security characteristics of the candidate process. The quantitative assessment metrics 190 of a candidate process may, therefore, comprise an objective technical, economic, and/or risk assessment of the candidate process following successful implementation and/or deployment of the candidate process within the facility 20. Aspects of the quantitative assessment metrics 190 may be determined through analysis of the stochastic model 170 constructed for the candidate process, e.g., through closed-form analysis, steady state analysis, Monte Carlo analysis, MCMC analysis, and/or the like.

As illustrated in FIGS. 9 and 11, the quantitative assessment metrics 190 (e.g., candidate metrics 990) determined for candidate processes may comprise technical metrics 192, economic metrics 194, and risk metrics 196, which may comprise a technical, economic, and/or risk assessment of the candidate process following successful implementation and/or deployment of the candidate process within the facility 20. The candidate metrics 990 may further comprise sensitivity metrics 195, adoption metrics 198, and delta metrics 390. The sensitivity metrics 195 may indicate degree to which changes to the parameter set 250 of the candidate process impact the resulting quantitative assessment metrics 190. As disclosed herein, the adoption metrics 198 of a candidate process may comprise and/or refer to a quantitative assessment of the technical, economic, and/or risk implications associated with the design, procurement, and/or implementation of the candidate process within a facility 20. The adoption metrics 198 may be based on and/or derived from FMD adoption metrics 1090 determined for respective FMD of the candidate process. In the example illustrated in FIG. 11, the candidate process may comprise two candidate FMD, e.g., candidate FMD 1 and candidate FMD 2, represented by FMD nodes 962-1 and 962-2, respectively. The FMD node 962-1 may comprise FMD adoption metrics 1090-1, which may comprise an assessment of the technical, economic, and/or risk implications associated with implementation of candidate FMD 1 within the facility 20 and FMD node 962-2, which may comprise an assessment of the technical, economic, and/or risk implications associated with implementation of candidate FMD 2 within the facility 20. The QA module 198 may be configured to generate adoption metrics 198 for the candidate process, the adoption metrics 198 based, at least in part, on the FMD adoption metrics 1090-1 and FMD adoption metrics 1090-2 determined for candidate FMD 1 and 2. For example, the adoption metrics 198 may comprise a sum, product, aggregation, and/or other suitable combination of FMD adoption metrics 1090.

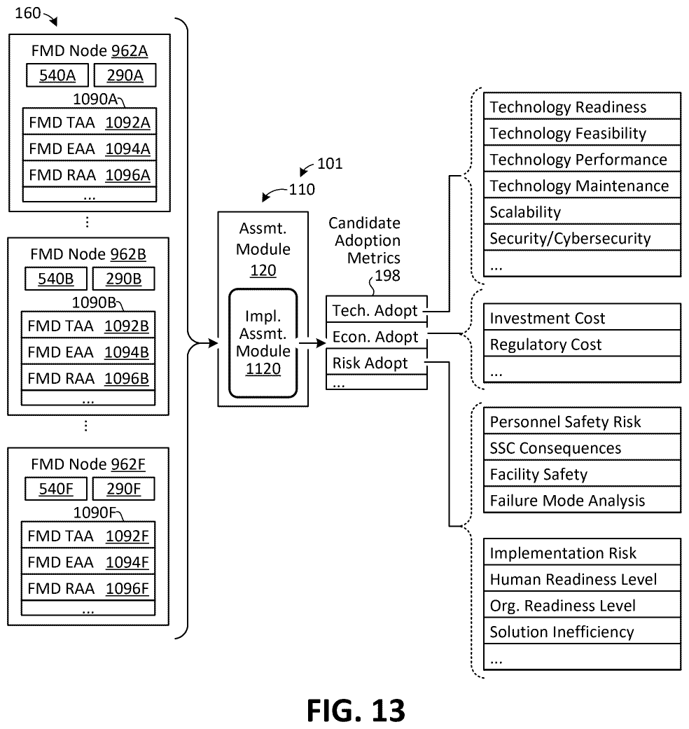

FIG. 13 is a schematic block diagram illustrating another example of an IA module 1120. In the FIG. 13 example, the IA module 1120 may be configured to determine adoption metrics 198 of a candidate process based on FMD adoption metrics 1090 determined for respective FMD of the candidate process. In the FIG. 13 example, the candidate process comprises F candidate FMD, which may be represented by FMD nodes 962A-F within the process map 160 generated for the candidate process. The FMD nodes 962A-F may comprise respective FMD adoption metrics 1090A-F, each comprising an assessment of the technical, economic, and/or risk implications associated with implementation of a respective candidate FMD within the facility 20. As illustrated in FIG. 13, generating adoption metrics 198 for the candidate process may comprise a) retrieving FMD adoption metrics 1090 determined for respective FMD of the candidate process, e.g., retrieving FMD adoption metrics 1090A-F from FMD nodes 962A-F of the process map 160 generated for the candidate process, and b) combining the retrieved FMD adoption metrics 1090 into adoption metrics 198 comprising an assessment of the technical, economic, and/or risk implications associated with the design, procurement, and/or implementation of the candidate process (e.g., candidate FMD A through F) within the facility 20.

The adoption metrics 198 may be configured to assess any suitable aspect associated with implementation of a candidate process (and/or one or more candidate FMD). As illustrated in FIG. 13, the adoption metrics 198 may comprise technical adoption metrics, economic adoption metrics, risk adoption metrics, and so on. The technical adoption metrics may comprise a combination of FMD TAA 1052A through 1052F. The technical adoption metrics may comprise information pertaining to the readiness (e.g., technology readiness such as TRL), feasibility, performance, maintenance, scalability, and/or security attributes of candidate FMD A through F. The economic adoption metrics may comprise a combination of economic costs associated with candidate FMD A through F, e.g., may comprise a combined or overall investment and/or regulatory costs associated with implementation of candidate FMD A through F within the facility 20. The risk adoption metrics may comprise information pertaining to safety and/or implementation risks associated with implementation of candidate FMD A through F, e.g., personnel safety risk, SSC consequences, facility safety, failure mode analysis for respective candidate FMD A through F, implementation risk, HRL, ORL, solution inefficiency, and/or the like.

Referring back to FIG. 11, the quantitative assessment metrics 190 determined for candidate processes may further comprise delta metrics 390. The delta metrics 390 may be configured to quantify differences between candidate processes and corresponding parent, BL process. Accordingly, the delta metrics 390 of a candidate process may comprise an objective, quantitative assessment of the technical, economic, and/or risk implications of modifying and/or replacing a BL process of the facility 20 with the candidate process.

The delta metrics may include technology delta (ΔT) metrics 392, economic delta (ΔE) metrics 394, risk delta (ΔR) metrics 396, and so on.

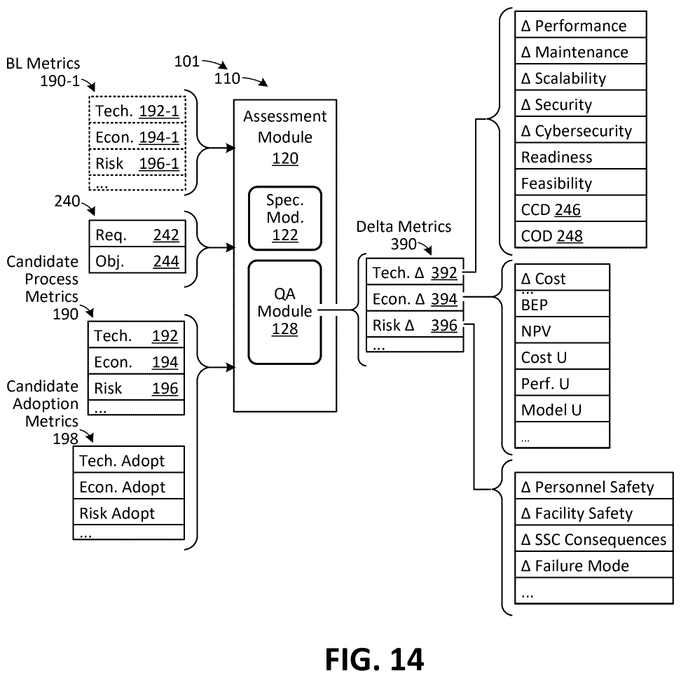

FIG. 14 is a schematic block diagram illustrating another example of an assessment module 120, as disclosed herein. In the FIG. 14 example, the assessment module 120 may be configured to generate delta metrics 390 for a candidate process based, at least in part, on quantitative assessment metrics 190 determined for the candidate process, adoption metrics 198 determined for the candidate process, and BL quantitative assessment metrics 190-1 of the parent of the candidate process, e.g., the BL process to be modified and/or replaced by the candidate process.

The ΔT metrics 392 may be configured to quantify differences in the technical characteristics of the candidate process relative to the BL process. The ΔT metrics 392 may pertain to any technical characteristic including, but not limited to: technical functionality, performance, maintenance, accuracy, reliability, completion time, scalability, security, cybersecurity, and/or the like. The ΔT metrics 392 may further comprise technology readiness metrics, which may be based on a TRL of the candidate process (e.g., TRL of respective candidate FMD) and the HRL and/or ORL determined for the facility. The ΔT metrics 392 may also include feasibility metrics, which may be configured to indicate a degree to which technological solution(s) of the candidate process are suitable for integration into existing systems of the facility 20, as disclosed herein.

In some implementations the ΔT metrics 392 may further comprise candidate evaluation data 240, including candidate constraint data 246 and candidate objective data 248. The candidate constraint data 246 may indicate a degree to which the candidate process satisfies requirements and/or constraints defined for the process (e.g., per constraint data 242 of the process) and the candidate objective data 246 may indicate a degree to which the candidate process aligns with the objective data 244 associated with the process.

As disclosed herein, the ΔE metrics 394 may be configured to quantify the economic impact of candidate processes. For example, the ΔE metrics 394 may be configured to assess the cost-benefit of respective candidate processes, e.g., may comprise a breakeven point, net present value, and/or other suitable economic metrics. The breakeven point (BEP) of a candidate process may be expressed as the cost of the initial investment required for implementation of the candidate process at the facility 20 divided by the projected cost savings yielded by the candidate process per time, per Eq. 9 below:

$$BEP = \frac{{C}_{0}}{C} \qquad Eq . 9$$

In Eq. 9, C₀ represents the investment cost of the candidate process, which may include all upfront technology investment costs associated with the candidate process, e.g., economic costs quantified by CA economic metrics 254 determined for the candidate process. As disclosed herein, the CA economic metrics 254 determined for a candidate process may be configured to quantify all economic costs associated with implementation of the candidate process at the facility 20 including, but not limited to costs associated with the design, development, deployment, management, and so on. The CA economic metrics 254 may break down such costs into training, labor, and capital expenditures such as hardware acquisition, infrastructure modifications, installation costs, and so on), regulatory costs, and so on. For example, the CA economic metrics 254 determined for a candidate process may express investment costs as a sum of a screening cost (C_{screen}), development cost (C_{dev}), and deployment cost (C_{deploy}) of the candidate process per Eq. 10 below:

$${C}_{0} = {C}_{screen} + {C}_{dev} + {C}_{deploy} \qquad Eq . 10$$

Referring back to Eq. 9, the C parameter may represent cost savings yielded by the candidate process relative to the corresponding BL process. The assessment module 120 may be configured to represent cost savings using any suitable measure, e.g., net yearly cash flow or the like. For example, the C quantity may represent the net annual economic benefit realized by the candidate process, which may be calculated per Eq. 11 below:

$$C = ( P - \hat{P} - OPEX ) U \qquad Eq . 11$$

In Eq. 11, P represents economic costs of the BL process (e.g., BL economic metrics 194-1), \hat{P} represents the economic costs of the candidate process (e.g., economic metrics 194 of the candidate process), the OPEX quantity represents operational expenditures associated with the candidate process (e.g., new ongoing costs associated with the candidate process, if any, such as maintenance, upkeep, subscriptions, electricity use, and/or the like), and U is a usage rate predicted for the candidate FMD within the facility 20. For example, the usage rate (U) may be determined by the percentage of employees using the candidate FMD versus the BL process. In other words, the usage rate (U) parameter may be configured to incorporate risks associated with a failed implementation and/or low adoption rate of the candidate process within the facility 20. Information pertaining to the predicted usage rate (U) of a candidate process may be based on and/or derived CA risk metrics 256 of the candidate process. For example, the usage rate (U) may be inversely proportional to the solution inefficiency of the CA risk metrics 256 determined for the candidate process.

Alternatively, or in addition, the ΔE metrics 394 may comprise a net present value (NPV) determined for the candidate process. The NPV may provide a secondary economic perspective that incorporates the time-value of money, which evaluates performance of an investment at a given discount rate, e.g., evaluate whether the candidate process is a good use of investment capital as compared to returns achievable through other investments. NPV metrics for candidate processes may be determined as follows:

$$NPV ( T ) = {\sum }_{t = 0}^{T} \frac{C}{{( 1 + r )}^{t}} - {C}_{0} \qquad Eq . 12$$

In Eq. 12, r represents the rate at which the value of future cash flows are discounted back to present value (e.g., may account for the time value of money, inflation, and investment risk, commonly expressed as a percentage), and T represents the total number of time periods in the NPV calculation (e.g., total duration over which cash flows are expected to occur, commonly expressed in years). NPV metrics may be used to determine if future expected cash flows (or cost savings) of candidate processes are worth the required initial economic investments. For example, a positive NPV may indicate that the candidate process is projected to be a good investment whereas a negative NPV may indicate that the candidate process is likely to be a poor investment.

The ΔE metrics 394 may be further configured to quantify economic risk associated with the candidate process (and/or other economic metrics). For example, the economic delta metrics may quantify cost uncertainty associated with the candidate process. The cost of a project may not be known in its entirety during evaluation. As such, cost overruns, changes in expenses, and/or change orders may occur during implementation. The ΔE metrics 394 may be configured to quantify such cost uncertainty so that the impact of such uncertainty can be included in the evaluation of respective candidate processes.

The ΔE metrics 394 may further comprise performance uncertainty metrics. Performance uncertainty may impact the technological (and economic) advantages realized by a candidate process. For example, scalability, deployment, and/or degradation issues with the technological solution(s) of a candidate process may impact the actual economic benefits realized by the facility 20. Performance uncertainty metrics may model the impact of performance shortfalls on the ΔE metrics 394 of the candidate process.

In some implementations, the ΔE metrics 394 may be further configured to model uncertainty pertaining to the economic model(s) used to develop economic metrics of the candidate process. Economic uncertainty metrics may be configured to model larger economic forces that can interact with expected return on investment. For example, the prices for resources utilized by the candidate process and/or outputs of the candidate process (e.g., power) may impact return on investment. Quantifying uncertainty pertaining to the economic models used to assess candidate processes may enable more accurate and thorough candidate evaluation.

The assessment module 120 may be further configured to determine ΔR metrics 396 for candidate processes. The ΔR metrics 396 may be configured to quantify differences in risk characteristics between the candidate process and corresponding BL process. The ΔR metrics 396 may pertain to any suitable risk characteristic including, but not limited to: Δ personnel safety, Δ facility safety, Δ SSC consequences, Δ failure mode, and so on. The Δ personnel safety metrics may be configured to quantify differences in personnel safety between the candidate process and BL process, the Δ facility safety metrics may be configured to quantify differences in facility safety, the Δ SSC consequences metrics may be configured to quantify differences between SSC consequences of the candidate process and BL process, the Δ failure mode metrics may quantify differences between failure modes of the candidate process (and/or corresponding mitigation actions) and failure modes of the BL process, and so on.

As illustrated in FIG. 9, the quantitative assessment metrics 190 determined for candidate processes may comprise technical, economic, and/or risk assessments of the candidate processes, e.g., may comprise technical metrics 192, economic metrics 194, and risk metrics 196, as disclosed herein. Candidate records 230 may further comprise delta metrics 390, which may be configured to quantify differences between quantitative assessment metrics 190 of the candidate process and quantitative assessment metrics 190 of the corresponding BL process. In other words, the delta metrics 390 may quantify improvements in the technical, economic, and/or risk characteristics of the process achieved through the proposed modifications to the BL process, e.g., may quantify differences between the technical metrics 192, economic metrics 194, and/or risk metrics 196 of the candidate process and corresponding BL process.

Referring back to FIG. 2A, as disclosed herein, managing FMD at a facility 20 may comprise a) determining a baseline of the facility 20, b) identifying facility improvement targets based, at least in part, on the determined baseline, c) formulating candidate processes to address the identified improvement targets, d) determining assessments of the candidate processes, the assessments comprising an objective, quantitative assessment of the candidate processes, and e) selecting one or more candidate process(es) for implementation at the facility 20 based, at least in part, on the candidate assessments.

Determining the baseline of the facility 20 may comprise generating TERA assessments of one or more BL processes, e.g., may comprise BL records 230 for respective BL processes, the BL records 230 comprising, inter alia, PMA data 145 and quantitative assessment metrics 190 comprising quantitative assessments of technical, economic, and/or risk characteristics of the BL processes. The BL records 220 may be maintained in non-transitory storage, such as a facility BL 215 stored within a facility DS 210 or the like. Improvement targets pertaining to the facility 20 may be identified based on one or more of a) PM data 410 used to assess the BL processes, b) quantitative assessment metrics 190 determined for the BL processes, c) objective data 244 pertaining to the facility 20 (e.g., modernization goals), and/or the like.

The FMM module 110 may be further configured to formulate candidate processes to address the identified improvement targets. The candidate processes may be configured to modify and/or replace designated BL processes of the facility 20, e.g., may comprise candidate FMD configured to modify and/or replace aspects of the BL processes. The FMM module 110 may be further configured to determine TERA assessments of the candidate processes, which may comprise constructing PMA data 145 configured to model the candidate processes (and/or FMD thereof) and deriving candidate metrics 990 from, inter alia, the PMA data 145. The candidate metrics 990 may comprise quantitative assessment metrics 190 comprising quantitative assessments of the technical, economic, and/or risk characteristics of respective candidate processes following successful implementation within the facility 20. The candidate metrics 990 may further comprise adoption metrics 198, which may comprise quantitative assessments of the technical, economic, and/or risk implications associated with implementation of the candidate processes within the facility 20. The candidate metrics 990 may also include delta metrics 390, which may quantify differences between the technical, economic, and/or risk characteristics of the candidate processes and corresponding BL processes.

The evaluation module 280 may be configured to select one or more candidate processes for implementation at the facility 20. The candidate processes may be selected from a plurality of candidate processes within the candidate pool 125 developed for the facility 20. The selection may be based on any suitable criteria. For example, the selection may be based on candidate metrics 990 determined for respective candidate processes. In some implementations, the evaluation module 280 may select candidate processes predicted to provide maximal benefits relative to the facility BL 215 such as maximum technical benefits (e.g., maximum ΔT metrics 392), maximum economic benefits (e.g., maximum ΔE metrics 394), maximum risk benefits (e.g., maximum ΔR metrics 396), and/or the like. Alternatively, or in addition, the selection may be based on a combination of candidate metrics 990, weighted candidate metrics 990, and/or the like. In some implementations, the evaluation module 280 may be configured to select candidate processes in accordance with optimization criteria. For example, the evaluation module 280 may formulate selection of candidate processes as an optimization problem having defined constraints and objective function. The objective function and/or constraints may be based on any suitable characteristics of the candidate processes, e.g., candidate metrics 990, constraint data 242, objective data 244, and/or the like.

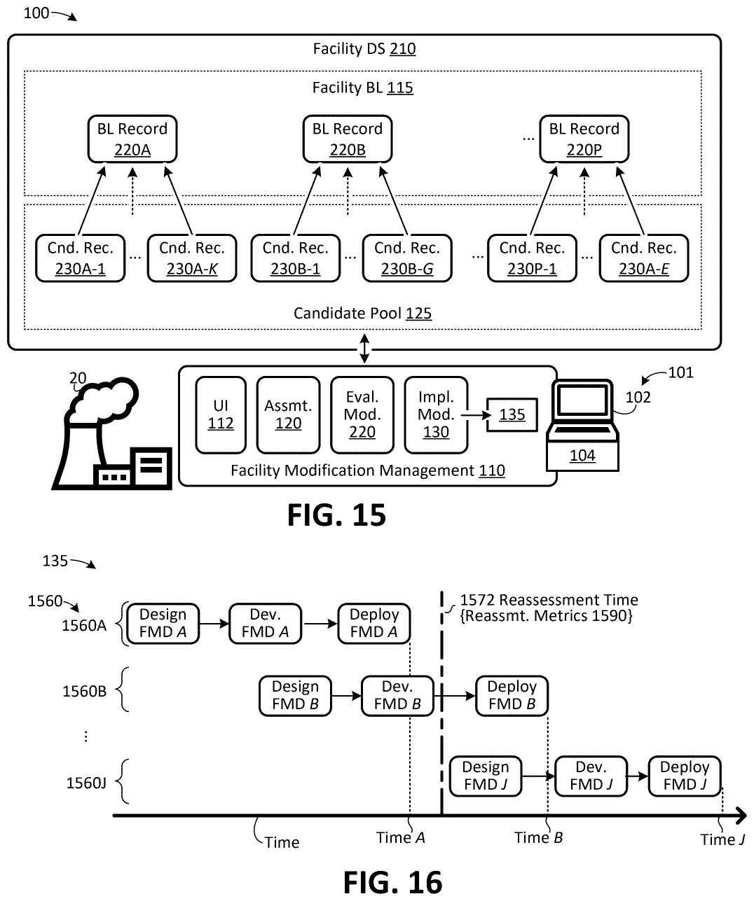

FIG. 15 is a schematic block diagram illustrating another example of a system 100 for managing facility modifications. The system 100 may comprise a FMM module 110 configured for operation on computing resources 104 of an apparatus 101. The assessment module 120 may be configured to determine a facility BL 215 comprising assessments of one or more BL processes of the facility 20. The BL assessments may be maintained within BL records 220 of a facility DS 210. In the FIG. 15 example, the facility BL 215 comprises BL assessments of P BL processes of the facility 20, e.g., maintained within BL records 220A-P within the facility DS 210.

The FMM module 110 may be further configured to identify improvement targets pertaining to the facility 20 based, at least in part, on the determined BL assessments and formulate candidate processes configured to address the identified improvement targets. Information pertaining to the candidate processes may be maintained within candidate records 230 of a candidate pool 125. The candidate processes may be configured to modify and/or replace designated BL processes of the facility 20. In the FIG. 15 example, the candidate pool 125 may comprise K candidate processes, each of the K candidate process defining a respective set of modifications to the BL process of BL record 210A (e.g., candidate records 230A-1 through 230A-K, each comprising a respective set of candidate FMD). The candidate pool 125 may further comprise G candidate processes configured to modify aspects of the BL process of BL record 210B (e.g., candidate records 230B-1 through 230B-G), E candidate processes configured to modify aspects of the BL process of BL record 210P (e.g., candidate records 230P-1 through 230P-E), and so on. The assessment module 120 may be configured to determine TERA assessments of the candidate processes, which may comprise determining candidate metrics 990 for the candidate processes, as disclosed herein.

The candidate metrics 990 determined for the candidate processes may comprise, inter alia, delta metrics 390. The delta metrics 390 of the candidate processes of candidate records 230A-1 through 230A-K may comprise assessments quantifying differences between technical, economic, and/or risk characteristics of the candidate processes and the corresponding BL process of BL record 210A. Similarly, the delta metrics 390 of the candidate processes of candidate records 230B-1 through 230A-G may comprise assessments quantifying differences between technical, economic, and/or risk characteristics of the candidate processes and the corresponding BL process of BL record 210B, the delta metrics 390 of the candidate processes of candidate records 230P-1 through 230P-E may comprise assessments quantifying differences between technical, economic, and/or risk characteristics of the candidate processes and the corresponding BL process of BL record 210P, and so on.

The evaluation module 280 may select one or more candidate processes for implementation at the facility 20 based, at least in part, on the TERA assessments determined for the candidate processes. As disclosed herein, in some implementations, the evaluation module 280 may select one or more candidate processes from the candidate pool 125 based on, inter alia, candidate metrics 990 of the candidate processes, e.g., quantitative assessment metrics 190, adoption metrics 198, delta metrics 390, and/or the like. For example, the evaluation module 280 may select candidate processes determined to provide maximum benefits relative to the facility BL 215, e.g., select candidate processes predicted to result in maximum improvements to technical, economic, and/or risk characteristics relative to the corresponding BL processes. The selection may be based on a combination of different metrics, weighted metrics, and/or the like. Alternatively, or in addition, the selection may be based on user-defined criteria, an optimization model, or the like.

In some implementations, the FMM module 110 may further comprise an implementation module 130. As disclosed herein, the implementation module 130 may be configured to determine adoption schemes 135 for selected candidate processes. As used herein, an adoption scheme 135 may comprise and/or refer to data configured to manage the design, development, deployment, and/or operation of selected candidate FMD within the facility 20.

FIG. 16 is a schematic block diagram illustrating an example of an adoption scheme. The adoption scheme illustrated in the FIG. 16 example may be configured to manage implementation of a candidate process comprising J FMD. In other words, the illustrated adoption scheme 135 may be configured to manage the design, development, and/or deployment of each of J FMD and/or technical solutions comprising the candidate processes. As illustrated in FIG. 16, the adoption scheme 135 may comprise J FMD adoption schemes 135, each configured to manage adoption of a respective FMD of the candidate process.

The adoption scheme 135 may be configured to manage implementation of respective FMD of the candidate process during a designated time and/or timeframe. The adoption scheme 135 may manage implementation of FMD based on, inter alia, resource availability, dependencies between FMD, technical considerations, economic considerations, risk considerations, and/or the like. In the FIG. 16 example, the adoption scheme 135 is configured to schedule FMD A to be completed at time A, schedule FMD B to be completed at time B (e.g., due to, inter alia, dependencies on FMD A), schedule FMD J to be completed at time J (e.g., due to, inter alia, dependencies on FMD A and/or B), and so on.

In some embodiments, the FMM module 110 may be configured to update the candidate metrics 990 determined for respective candidate processes and/or the FMD utilized therein. The FMM module 110 may be configured to update candidate metrics 990 after selection of a candidate process for implementation at the facility 20 and/or after beginning implementation of the candidate process.

The assessment module 120 may update the candidate metrics 990 of one or more candidate processes of the candidate pool 125 in response to changes to the technical, economic, and/or risk characteristics of FMD utilized by one or more of the candidate processes, which may include, but are not limited to: changing technical characteristics (e.g., technical functionality, performance, readiness, feasibility, and/or the like), economic characteristics (e.g., investment costs, regulatory costs, and/or the like), risk characteristics (e.g., personnel safety risk, SSC consequences, and/or the like), and so on. For example, the candidate metrics 990 of a candidate process comprising a particular technological solution may be updated to reflect improvements to the technological solution, such as maturity, increased reliability, lower cost, and/or the like.

The evaluation module 280 may be configured to evaluate candidate processes of the candidate pool 125 in response to a candidate update. For example, the updates to the candidate pool 125 may result in selection of an alternative candidate process, e.g., may result in selection of a different candidate process than the originally selected candidate process. In response, the implementation module 130 may determine an alternative adoption scheme 135 configured to implement the alternative candidate process. The alternative adoption scheme 135 may be configured to leverage FMD implemented for the originally selected candidate process. Alternatively, the alternative adoption scheme 135 may replace and/or obviate one or more FMD. In these examples, the alternative candidate process may be selected in response to determining that benefits of the alternative candidate process warrant discarding resources used to implement the originally selected candidate process (e.g., additional benefits exceed costs associated with unneeded FMD of the originally selected candidate process that have already been implemented at the facility 20).

The candidate process illustrated in the FIG. 16 example may be reassessed at a time 1572 (at reassessment time 1572). The reassessment may be performed in response to changes to the technical, economic, and/or risk characteristics of one or more FMD utilized within one or more candidate processes of the candidate pool 125. As illustrated in FIG. 16, the reassessment may occur after adoption of FMD A and before adoption of FMD B and/or FMD J. Reassessing the candidate process may comprise determining updated metrics 990 for respective candidate processes of the candidate pool 125. Reassessing the candidate process may further comprise determining reassessment metrics 1590. The reassessment metrics 1590 may comprise a quantitative assessment of the technical, economic, and/or risk implications of abandoning the selected candidate process. For example, the reassessment metrics 1590 may track investments made into the selected candidate process, identify investments (e.g., FMD) that can be utilized in other candidate processes, and so on. In the FIG. 16 example, the reassessment metrics 1590 may quantify technical, economic, and/or risk implications of abandoning adoption of the candidate process (and/or switching to adoption of another candidate process) at the reassessment time 1572, e.g., after adoption of FMD A, partial adoption of FMD B (e.g., completion of the design and/or aspects of the development of FMD B), partial adoption of FMD J (e.g., completion of the design of FMD J), and so on. The FMM module 110 may be configured to select an alternative candidate process, different to the selected candidate process in response to determining that benefits of such adoption outweigh costs quantified by the reassessment metrics 1590. The selection may be based, at least in part, on whether the alternative candidate process can leverage one or more FMD of the originally selected candidate process, e.g., whether the alternative candidate process can leverage one or more of FMD A or FMD B in the FIG. 16 example.

The FMM module 110 may transition from adoption of an initially selected candidate process (CNDₛₑₗ) to an alternative candidate process (CNDₐₗₜ) in response to determining that a difference between the metrics 990 (and/or delta metrics 390) of an alternative candidate process (CMₐₗₜ) and the originally selected candidate process (CMₛₑₗ) exceed the reassessment metrics 1590 at the reassessment time 1572, e.g., per Eq. 13 below:

$$Transition ← ( {CM}_{alt} - {CM}_{sel} ) > {M}_{reassmt} \qquad Eq . 13$$

In Eq. 13, the FMM module 110 may transition from adoption of the initially selected candidate process (CMₛₑₗ) to the alternative candidate process (CMₐₗₜ) in response to determining that benefits of such transition outweigh the reassessment metrics 1590 determined for the reassessment time 1572.

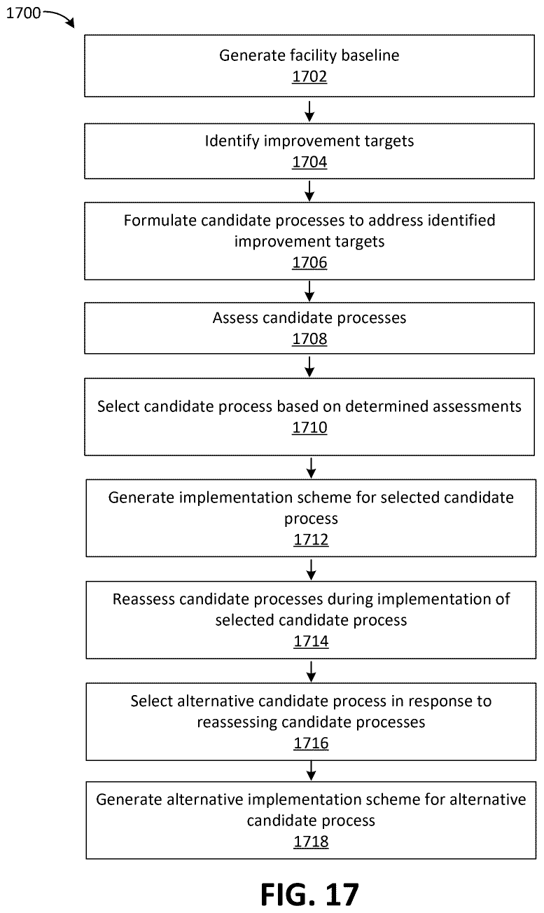

FIG. 17 is a flow diagram illustrating an example of a method 1700 for managing facility modifications in response to candidate updates. Steps 1702 through 1710 may comprise generating a facility baseline, identifying improvement targets, formulating candidate processes to address the identified improvement targets, assessing the candidate processes, and selecting a candidate process based on the determined assessments, as disclosed herein.

Step 1712 may comprise generating an adoption scheme 135 for the selected candidate process and/or implementing FMD of the selected candidate process at the facility 20 in accordance with the adoption scheme 135.

Step 1714 may comprise reassessing one or more candidate processes of the candidate pool 125 during implementation of the selected candidate process. The candidate processes may be reassessed in response to changes to technical, economic, and/or risk characteristics of one or more candidate FMD utilized by the candidate processes.

Step 1716 may comprise selecting an alternative candidate process in response to reassessing the candidate processes. The alternative candidate process may be selected based on updated candidate metrics 990 determined for the candidate processes at 1714. The alternative candidate process may be selected in response to determining that benefits of the alternative candidate process outweigh losses to be incurred due to obviating the originally selected candidate process, e.g., losses due to implementation of FMD not utilized within the alternative candidate process, e.g., may comprise determining reassessment metrics 1590 corresponding to a reassessment time 1572 of steps 1714-1716 per Eq. 13 above.

Step 1718 may comprise generating an alternative adoption scheme 135 for the alternative candidate process selected at 1716. The alternative adoption scheme 135 may be configured in accordance with the adoption scheme generated for the originally selected candidate process at 1712. For example, the alternative adoption scheme 135 may be configured to leverage FMD of the originally selected candidate process utilized within the alternative candidate process (if any). Alternatively, the alternative adoption scheme may obviate and/or discard work on FMD not utilized by the alternative candidate process.

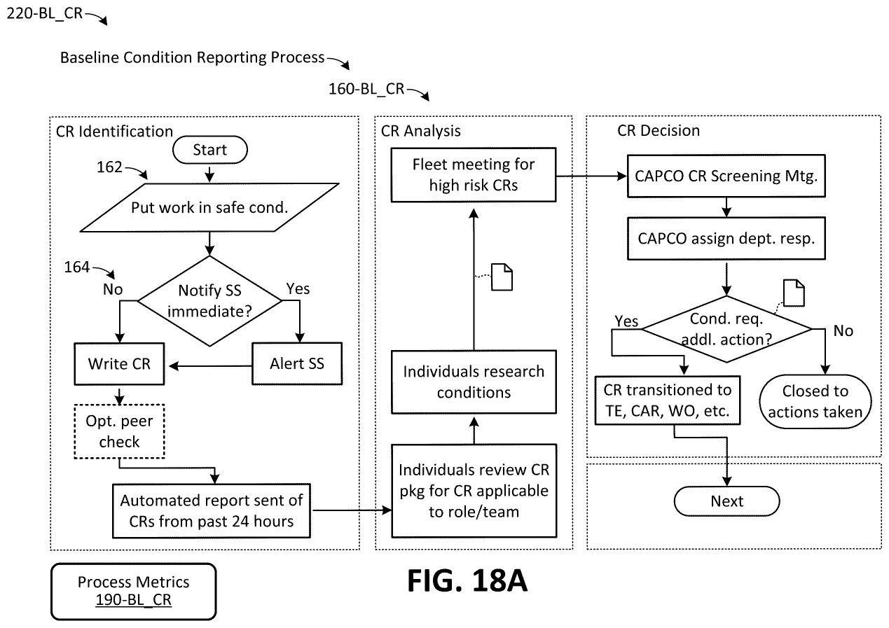

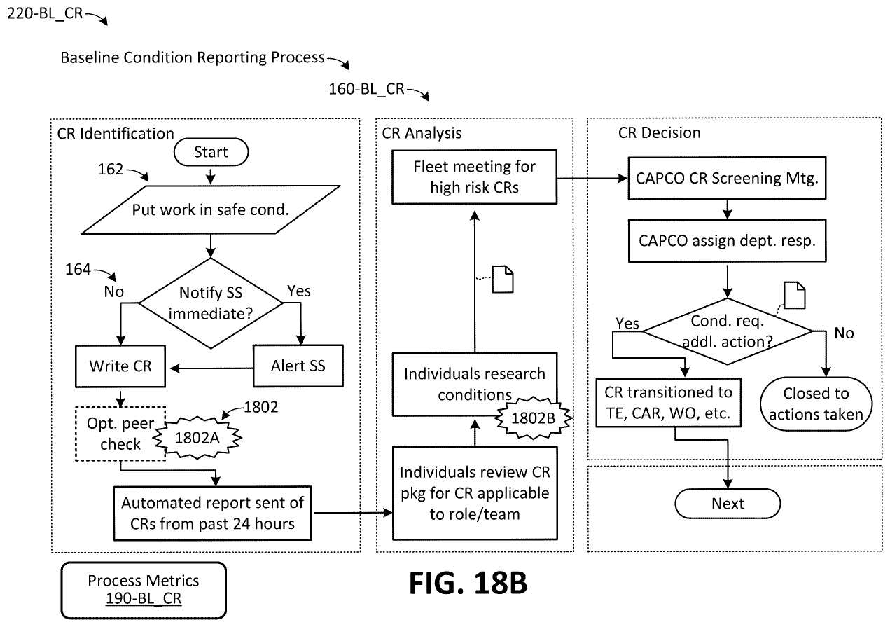

FIG. 18A is a schematic block diagram illustrating an example of a process map 160-BL_CR configured to represent a BL facility process. The BL process illustrated in FIG. 18A may represent a BL condition reporting process of a NPP facility 20. Information pertaining to the BL CR process may be maintained within a BL record 210-BL_CR, as disclosed herein.

The FMM module 110 may be configured to perform an assessment of the BL CR process illustrated in FIG. 18A, as disclosed herein. Performing the assessment may comprise acquiring PM data 410 pertaining to the BL CR process, using the PM data 410 to generate PMA data 145 (e.g., assessment schema 150, process map 160-BL_CR, stochastic model 170, and so on), and deriving quantitative assessment metrics 190-BL_CR from the generated PMA data 145. Assessing the BL CR process may further comprise identifying improvement targets. For example, the FMM module 110 may identify improvement targets including, but not limited to: reduce time spent searching databases, reduce redundant efforts in research, streamline information sharing, and so on.

FIG. 18B is a schematic block diagram illustrating an example of a process map 160-BL_CR comprising one or more improvement targets. In the FIG. 18B example, the improvement targets are marked with labels 1802. Label 1802-1 identifies an improvement target related to the “optional peer check” task of the BL CR process and label 1802-2 identifies an improvement target related to the “individuals research conditions” task.

The “optional peer check” improvement target 1802-1 may relate to a “pain point” identified during assessment of the BL CR process. For example, the PM data 410 may indicate that, when investigating a CR, a common pain point is incomplete or overly generalized CR. For example, the originator of the CR may have omitted information in the body of the CR or left blank spaces in non-required fields. Such omissions may cause investigators to spend more time and effort discovering why the CR was written. Missing information may include multiple location IDs involved, but not linked in the form, missing condition information (e.g., leak rate in a CR pertaining to a leak detected within the facility 20), time of discovery, activity being performed when the condition was discovered (e.g., work order), information pertaining to similar, previously detected CR, and so on. Answering these questions can be difficult for the reviewer if the condition was observed on a different shift or if the originator is not available when the condition is being recorded. Many of these issues could be resolved during the optional peer check illustrated in FIG. 18B.

The improvement target 1802-2 may correspond to a “pain point” related to inefficiencies involved in the “individuals research conditions” task of the BL CR process. As illustrated in FIG. 18A, once a CR is initiated, the first step of the BL CR process comprises collecting relevant information about the condition, which may comprise performing internal OE searches (e.g., searches within internal databases) to address one or more of the following questions:
Has this condition previously occurred on this component or system?
Has the condition occurred on similar components?
Has the condition occurred elsewhere in the fleet?
What are the most recent work orders performed on or near this component?

The BL CR process may further comprise performing one or more external OE searches to determine whether this or a similar condition occurred elsewhere in the industry. As illustrated in FIG. 18A, the BL CR process may further include performing searches within other data sources (e.g., Plant conditions in Nahar OSU Radiative (NORAD), Oil Systems Incorporated Plant Information (OSI PI), Power Business Intelligence (Power BI), Enterprise Data System, and/or other databases) to address one or more of the following questions:
Were there any trending indications leading up to the observed condition?
What states were the plant and relevant systems in at the time of the observed condition?
Did any other systems or components react to the observed condition?

Compilation and analysis of this research may be crucial to fully address the condition in the next phase of the BL CR process. For CRs with higher risk levels, some of these questions are expected to be answered in advance of morning fleet calls. For lower risk CRs, the information may be relevant to the Corrective Action Program Coordinator (CAPCO) screening meeting later in the day. While all this information may not be needed immediately for every CR, such information may be eventually required. The improvement target 1802-2 may relate to the time required (and inefficiencies) involved in the “individuals research conditions” task. Curating a full research stack for each CR may be time consuming. Information related to any single CR may be relevant to multiple individuals, leading to duplicated efforts if there is no coordinated research plan. This research gathering effort can equate to more than 40 hours spent on a single CR.

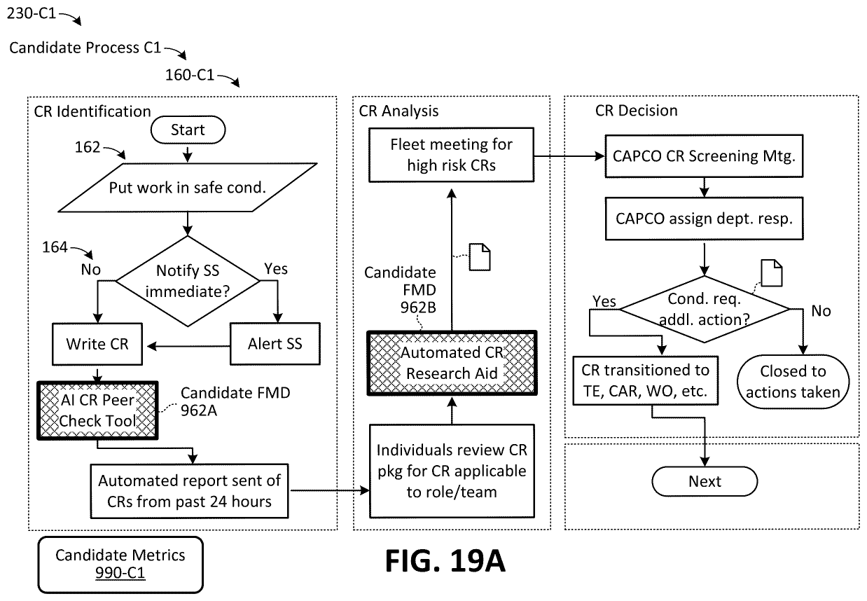

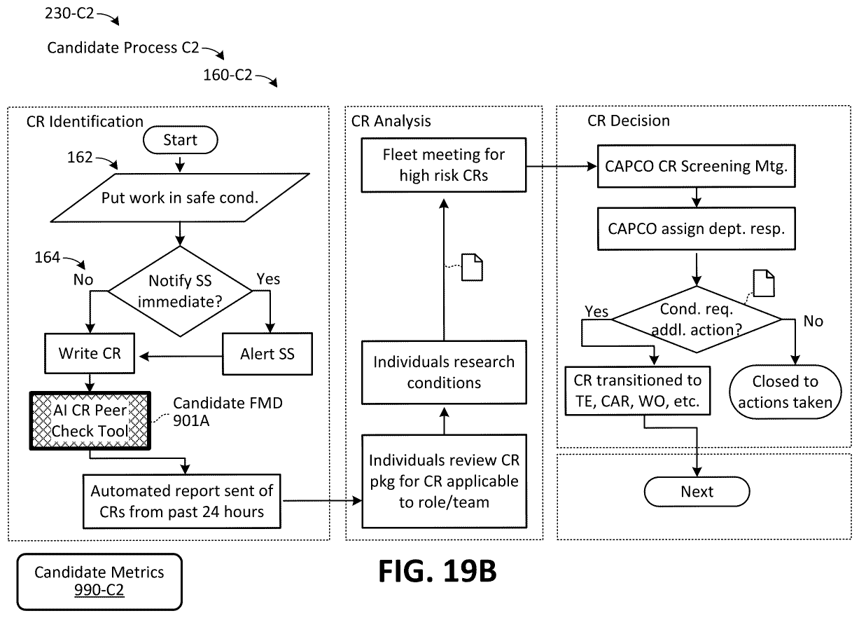

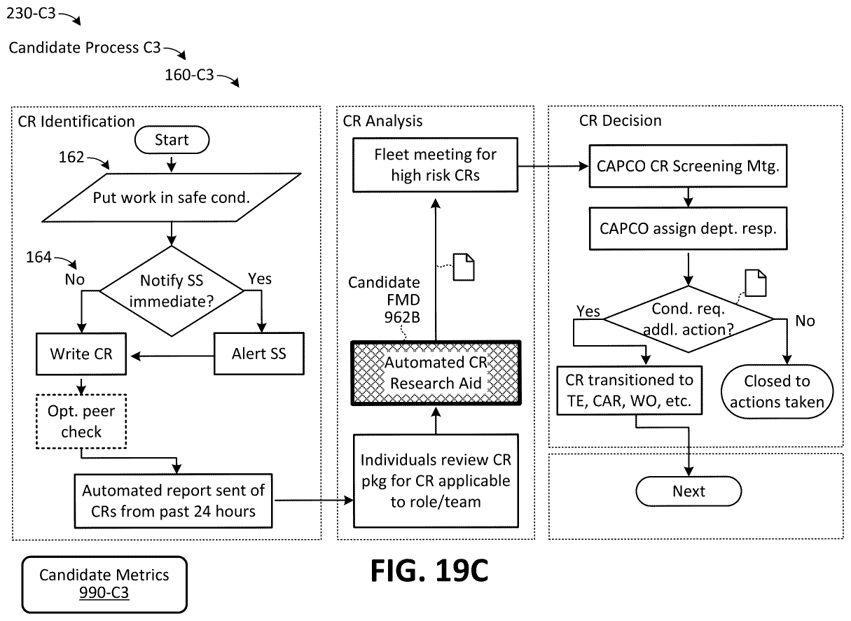

FIG. 19A illustrates an example of first candidate process C1 configured to address the improvement targets identified in FIG. 18B. The candidate process C1 may be represented by a process map 160-C1, which may be maintained within a candidate record 230-C1. In the FIG. 19A example, the candidate process C1 comprises FMD configured to replace the “optional peer check” and “individuals research conditions” tasks of the BL CR process. The candidate FMD may be represented by FMD nodes 962A and 962B within the process map 160-C1 of the candidate process C1.

As illustrated in FIG. 19A, the AI CR peer check tool may comprise a technological solution configured to modify and/or replace the “optional peer check” of the BL CR process. The AI CR peer check tool may be represented by FMD node 962A of the process map 160-C1. The AI CR peer check tool may be configured to examine CR and make suggestions based on missing or conflicting information. For instance, if the CR initiator mentions a valve leak, the AI CR peer check tool will ask if the initiator would like to include the leak rate, or if the user mentions a valve at the 117-foot elevation is leaking on a component at a higher elevation, then the tool will highlight the inconsistency and ask if the initiator would like to resolve the inconsistency. The AI CR peer check tool may, therefore, address the improvement target related to incomplete or overly generalized CR.

As further illustrated in FIG. 19A, the automated CR research aid may comprise a technological solution to modify and/or replace the “individuals research condition” task of the BL CR process. The automated CR research aid FMD may be represented by FMD node 962B within the process map 160-C1. The automated CR research aid may comprise a technological solution configured to read condition reports and determine if such reports are related to equipment reliability. If so, the automated CR research aid may be configured to search for relevant information from a variety of sources. Some of the information included in the results could be recent work orders on related equipment, plant/system status, external OE, internal OE about how similar issues have been handled previously, and so on. The automated CR research aid may compile and deliver this information to the end user with a summary of the findings. The summary may comprise a high-level look at what documents are included, what information might still be missing, and answers to common questions, such as “when was work last performed on this component?” or “Is this a repeat issue that should be tracked?” The Automated CR Research Aid may, therefore, address the “individuals research condition” improvement target, e.g., improve efficiency and reduce effort duplication.

FIG. 19B is a schematic block diagram illustrating another example of a candidate process C2 configured to modify and/or replace the BL CR process of FIGS. 18A-18B. The candidate process C2 may be represented by a process map 160-C2, which may be maintained within a candidate record 230-C2. As illustrated in FIG. 19B, the candidate process C2 includes the AI CR peer check tool (FMD node 962A) but retains the “individual research condition” task of the BL CR process, e.g., does not include the automated CR research aid. The candidate process C2 may, therefore, result in lower initial investment than candidate process C1, but may result in less technical, economic, and/or risk benefits.

FIG. 19C is a schematic block diagram illustrating another example of a candidate process C3 configured to modify and/or replace the BL CR process of FIGS. 18A-18B. The candidate process C3 may be represented by a process map 160-C3, which may be maintained within a candidate record 230-C3. As illustrated in FIG. 19C, the candidate process C3 includes the automated CR research aid (FMD node 962B) but retains the “optional peer check” task of the BL CR process, e.g., does not include the AI peer check tool. Like candidate process C2, the candidate process C3 may result in lower initial investment than candidate process C1, but may result in less technical, economic, and/or risk benefits.

The assessment module 120 may determine quantitative assessment metrics 990-C1 through 990-C3, which may be configured to objective assess the technical, economic, risk, and/or adoption characteristics of candidate processes C1 through C3, respectively. The evaluation module 280 may select one of the candidate processes C1 through C3 for implementation within the facility 20 based, at least in part, on the determined assessment metrics 990-C1 through 990-C3.

This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general-purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

1. A method for managing modifications to a facility, comprising:
developing a candidate pool comprising a plurality of candidate processes suitable for implementation at the facility;
determining quantitative assessment metrics for each candidate process of the candidate pool, wherein generating quantitative assessment metrics for a candidate processes comprises:
constructing a map of the candidate process within a computer-readable memory, the map configured to represent a plurality of interconnected states comprising the candidate process, each state of the candidate process represented by a respective map node,
transforming the map into a stochastic model of the candidate process, the stochastic model comprising probabilistic links configured to model a probability of transitions between respective states of the candidate process, and
deriving the quantitative assessment metrics for the candidate process from the stochastic model of the candidate process; and
selecting a candidate process for implementation at the facility based, at least in part, on the quantitative assessment metrics determined for the candidate processes.

2. The method of claim 1, wherein the determining the quantitative assessment metrics for the candidate process further comprises:
formulating an assessment schema for the candidate process, the assessment schema defining a plurality of state parameters; and
assigning values corresponding to the state parameters to respective states of the candidate process.

3. The method of claim 2, further comprising formulating assessment logic for the candidate process, the assessment logic configured to determine quantitative state metrics for respective states of the candidate process based, at least in part, on the state parameter values assigned to the respective states;
wherein the quantitative assessment metrics for the candidate process are based, at least in part, on the quantitative state metrics determined for the respective states of the candidate process.

4. The method of claim 3, wherein determining the quantitative assessment metrics for the candidate process further comprises:
determining time estimates for respective states of the candidate process based, at least in part, on the stochastic model of the candidate process; and
aggregating the quantitative state metrics determined for the respective states of the candidate process based, at least in part, on the time estimates determined for the respective states.

5. The method of claim 4, wherein deriving the quantitative assessment metrics from the stochastic model of the candidate process comprises performing one or more of a closed-form analysis of the stochastic model, a steady-state analysis of the stochastic model, and Monte Carlo analysis of the stochastic model.

6. The method of claim 4, wherein the assessment logic determined for the candidate process comprises technical assessment logic configured to derive technical state metrics for respective states of the candidate process from state parameter values assigned to the respective states of the candidate process, economic assessment logic configured to derive economic state metrics for respective states of the candidate process from state parameter values assigned to the respective states of the candidate process, and risk assessment logic configured to derive risk state metrics for respective states of the candidate process from state parameter values assigned to the respective states of the candidate process;
and wherein determining the quantitative assessment metrics for the candidate process further comprises:
aggregating the technical state metrics determined for respective states of the candidate process based, at least in part, on the time estimates determined for the respective states,
aggregating the economic state metrics determined for the respective states of the candidate process based, at least in part, on the time estimates determined for the respective states, and
aggregating the risk state metrics determined for the respective states of the candidate process based, at least in part, on the time estimates determined for the respective states.

7. The method of claim 4, wherein determining the quantitative assessment metrics further comprises determining sensitivity metrics for the candidate process, the sensitivity metrics configured to quantify a sensitivity of the quantitative assessment metrics to changes to respective state parameters of the assessment schema determined for the candidate process.

8. The method of claim 1, wherein determining the quantitative assessment metrics for the candidate process further comprises determining adoption metrics configured to quantify risks associated with adoption of the candidate process at the facility.

9. The method of claim 1, further comprising identifying an improvement target for the facility, wherein one or more candidate processes of the candidate pool are configured to address the identified facility improvement target.

10. The method of claim 9, further comprising:
determining quantitative assessment metrics for one or more baseline processes of the facility; and
and identifying the improvement target for the facility based, at least in part, on the quantitative assessment metrics determined for the one or more baseline processes.

11. The method of claim 9, wherein the improvement target for the facility is based, at least in part, on a facility objective.

12. The method of claim 1, further comprising:
generating an adoption scheme for implementation of the selected candidate process at the facility;
reassessing the selected candidate process at a designated time during adoption of the selected candidate process at the facility, wherein reassessing the selected candidate process comprises determining quantitative assessment metrics for an alternative candidate process different to the selected candidate process; and
transitioning to adoption of the alternative candidate process at the facility based, at least in part, on the quantitative assessment metrics determined for the alternative candidate process.

13. An apparatus for managing modifications to a facility, comprising:
a processor coupled to a memory and non-transitory data store; and
an assessment module configured for operation on the processor the assessment module configured to:
determine a baseline assessment of the facility, wherein determining the baseline assessment comprises determining quantitative assessment metrics for one or more baseline processes of the facility;
identify a facility improvement target based, at least in part, on the baseline assessment of the facility;
develop a candidate pool comprising a plurality of candidate processes configured to address the identified facility improvement target;
determine quantitative assessment metrics for each candidate process of the candidate pool, wherein generating quantitative assessment metrics for a candidate process comprises:
formulating an assessment schema for the candidate process, the assessment schema defining a plurality of state parameters and assessment logic configured to derive quantitative assessment metrics from the defined state parameters,
constructing a map of the candidate process, the map comprising a plurality of states,
assigning values to state parameters of each of the plurality of states of the candidate process within the map,
transforming the map into a stochastic model configured to model transitions between the states of the candidate process, and
deriving the quantitative assessment metrics for the candidate process from the stochastic model of the candidate process; and
an evaluation module configured to select a candidate process for implementation at the facility based, at least in part, on the quantitative assessment metrics determined for the candidate processes.

14. The apparatus of claim 13, wherein determining the quantitative assessment metrics for the candidate process comprises performing one or more of a closed-form analysis of the stochastic model, a steady-state analysis of the stochastic model, and a Markov chain Monte Carlo analysis of the stochastic model.

15. The apparatus of claim 13, wherein, the assessment logic comprises:
technical assessment logic configured to derive technical state metrics for respective states of the candidate process from state parameter values assigned to the respective states of the candidate process;
economic assessment logic configured to derive economic state metrics for respective states of the candidate process from state parameter values assigned to the respective states of the candidate process; and
risk assessment logic configured to derive risk state metrics for respective states of the candidate process from state parameter values assigned to the respective states of the candidate process; and
wherein determining the quantitative assessment metrics for the candidate process further comprises:
determining time estimates for respective states of the candidate process based, at least in part, on the stochastic model of the candidate process;
aggregating the technical state metrics determined for respective states of the candidate process based, at least in part, on time estimates determined for the respective states;
aggregating the economic state metrics determined for respective states of the candidate process based, at least in part, on time estimates determined for the respective states; and
aggregating the risk state metrics determined for respective states of the candidate process based, at least in part, on time estimates determined for the respective states.

16. The apparatus of claim 13, wherein determining the quantitative assessment metrics for the candidate process further comprises one or more of:
determining adoption metrics configured to quantify risks associated with adoption of the candidate process at the facility; and
determining sensitivity metrics for the candidate process, the sensitivity metrics configured to quantify a sensitivity of the quantitative assessment metrics to changes to respective parameters of the assessment schema determined for the candidate process.

17. The apparatus of claim 13, further comprising an implementation module configured to:
generate an adoption scheme for the selected candidate process, the adoption scheme configured to manage implementation of the selected candidate process at the facility;
reassess the selected candidate process at a designated time during adoption of the selected candidate process at the facility, wherein reassessing the selected candidate process comprises determining quantitative assessment metrics for an alternative candidate process different to the selected candidate process; and
transition to adoption of the alternative candidate process at the facility based, at least in part, on the quantitative assessment metrics determined for the alternative candidate process.

18. A non-transitory computer-readable storage medium storing instructions that, when executed by a processor, cause the processor to perform operations for managing modifications to a facility, the operations comprising:
determining a baseline assessment of the facility, wherein determining the baseline assessment comprises determining quantitative assessment metrics for one or more baseline processes of the facility;
identifying a facility improvement target based, at least in part, on one or more of the baseline assessment of the facility;
developing a candidate pool comprising a plurality of candidate processes configured to address the identified facility improvement target;
determining quantitative assessment metrics for each candidate process of the candidate pool, wherein generating quantitative assessment metrics for a candidate processes comprises:
constructing an assessment schema for the candidate process, the assessment schema defining a plurality of state parameters and assessment logic configured to derive quantitative assessment metrics from the defined state parameters,
generating a map of the candidate process, the map comprising a plurality of states,
assigning values to state parameters of each of the plurality of states of the candidate process within the map,
transforming the map into a stochastic model configured to model transitions between the states of the candidate process, and
determining the quantitative assessment metrics for the candidate process by performing one or more of a closed-form analysis of the stochastic model, a steady-state analysis of the stochastic model, and a Markov chain Monte Carlo analysis of the stochastic model;
selecting a candidate process for implementation at the facility based, at least in part, on the quantitative assessment metrics determined for the candidate processes; and
generating an adoption scheme for implementation of the selected candidate process at the facility.

19. The non-transitory computer-readable storage medium of claim 18, wherein, the assessment logic comprises:
technical assessment logic configured to derive technical state metrics for respective states of the candidate process from state parameter values assigned to the respective states of the candidate process;
economic assessment logic configured to derive economic state metrics for respective states of the candidate process from state parameter values assigned to the respective states of the candidate process; and
risk assessment logic configured to derive risk state metrics for respective states of the candidate process from state parameter values assigned to the respective states of the candidate process; and
wherein determining the quantitative assessment metrics for the candidate process further comprises:
determining time estimates for respective states of the candidate process based, at least in part, on the stochastic model of the candidate process;
aggregating the technical state metrics determined for respective states of the candidate process based, at least in part, on time estimates determined for the respective states;
aggregating the economic state metrics determined for respective states of the candidate process based, at least in part, on time estimates determined for the respective states;
aggregating the risk state metrics determined for respective states of the candidate process based, at least in part, on time estimates determined for the respective states;
determining adoption metrics configured to quantify risks associated with adoption of the candidate process at the facility; and
determining sensitivity metrics for the candidate process, the sensitivity metrics configured to quantify a sensitivity of the quantitative assessment metrics to changes to respective parameters of the assessment schema determined for the candidate process.

20. The non-transitory computer-readable storage medium of claim 18, the operations further comprising:
reassessing the selected candidate process at a designated time during adoption of the selected candidate process at the facility, wherein reassessing the selected candidate process comprises determining quantitative assessment metrics for an alternative candidate process different to the selected candidate process; and
transitioning to adoption of the alternative candidate process at the facility based, at least in part, on the quantitative assessment metrics determined for the alternative candidate process.
